(19) United States
(12) Patent Application Publication
(10) Pub. No.: US 2020/0367455 A1
(43) Pub. Date: Nov. 26, 2020

(54) RECIRCULATING PLANT GROWING MECHANISM

(71) Applicant: Warren VESTY, Calgary (CA)

(72) Inventor: Warren VESTY, Calgary (CA)

(21) Appl. No.: 16/767,851

(22) PCT Filed: Nov. 28, 2018
(86) PCT No.: PCT/CA2018/051518

§ 371 Date: May 28, 2020

(30) Foreign Application Priority Data
Nov. 28, 2017 (CA) 2986879

(51) Int. Cl. A01G 31/04; A01G 9/24

(52) U.S. Cl. CPC A01G 31/042; A01G 9/249; A01G 9/246; A01G 9/247

(57) ABSTRACT

An automated recirculating plant growing mechanism, in one embodiment it is disclosed as having: a hermetically sealed frame; at least one conveying tray operable to constrain, maintain the temperature of, and vary the offset distance between rooting medias; a drive mechanism operable to recirculate at least one conveying tray or at least one light bar cleaning assembly around a prescribed conveying path; at least one air lock mechanism operable to seal and unseal the recirculating plant growing mechanism, and operable to remove from and install onto the conveying drive mechanism a conveying tray; at least one light emitting bar operable to emit light and be positioned around a crops canopy; and at least one watering station operable to sense root zone conditions and inject nutrients into rooting media.

### CROSS REFERENCE TO RELATED APPLICATIONS

This application claims the foreign priority benefit of Canadian Patent Application No. 2,894,331 filed on Jun. 12, 2015.

This application claims the foreign priority benefit of U.S. patent application Ser. No. 15/179,618 filed on Oct. 10, 2016.

This application claims the foreign priority benefit of Canadian Patent Application No. 2,986,879 filed on Nov. 28, 2017.

### FIELD OF THE INVENTION

Terms used in this application:
cartesian coordinate system:

In text body of this application from time to time and referenced in the bottom right hand corner of each Figure (FIG. xx, FIG. xx) in the drawings, vectors in three dimensional space are used for clarity and to help orient the reader. This is the standard Cartesian coordinate system; starting with any imagined point in space which is called the origin, three mutually perpendicular axes are constructed called x, y, and z. To picture this stand near the corner of a room and look down at the point where the walls meet the floor, the floor and the wall to your left intersect in a line which is the positive x-axis (x, x axis, . . . ), the floor and the wall to your right intersect in a line which is the positive y-axis (y, y axis, . . . ), the walls intersect in a vertical line which is the positive z-axis (z, z axis, . . . ). The negative part of each axis is on the opposite side of the origin, where the axes intersect. These three mutually perpendicular axes called x, y, and z and the three two dimensional planes that can be derived from them are shown in FIG. 48.
plant; any botanical organism.
canopy; the photosynthetic portion of a plant, a community of plants, or an aggregate crop of plants that requires daily irradiation from solar or artificial light and or ambient or artificially conditioned air (atmosphere).
canopy column:
horizontal cultivation layout, a single tier traditional indoor cultivation strategy, where indoor plants are grown on an essentially single layer on the x y-plane. The plant's root system is system is potted into a variety of rooting media, which may be contained in media holders (plant pots). The aggregate crop to be cultivated is placed on the floor, rolling benches, and automated systems that may automatically index the plants through a cultivation space. Sufficient access space must be provided around the aggregate crop to allow for employee plant interactions. Rooting medias a typically fertigated with ebb and flow, drip feed, nutrient film or aeroponic systems. The aggregate crop of plants must be expose to solar or artificial light at a prescribed PPFD and DLI level, and ambient or artificially conditioned air. Shortcomings associated with this cultivation strategy include: inefficient space utilization; poor workflow strategies; antiquated lighting technologies; and poorly automated facilities are poorly automated.
vertically tiered cultivation layout, a more modern multiple tier indoor cultivation strategy, where indoor plants are typically grown on multiple tiers x y-plane tiers one placed on top of the other filling the cultivation space from the floor to its vertical it's upper limit. Three dimensional space is therefore created between the floor and the top of the bottom tier, between each tier, and the top tier, and the ceiling space (which may be comprised of glass in a greenhouse environment), each three dimensional space thus created is refered to as a cultivation tier, or cultivation space. Within the cultivation tiers enough vertical space is provided to install fertigation systems, artificial lighting, HVAC ducts, fan systems, and allow (with room to spare) the aggregated crops contained within to grow, until their planned stage of development at which they will be removed. The plant's root system is potted into a variety of rooting media, which maybe contained in media holders (plant pots). The aggregate crop being cultivated is usually placed, on and inside, waterproof trays that are supported by the floor of each cultivation tier. The typical depth, z-axis of a cultivation space is usually prescribed by ergonomics principles, in most cultivation strategies employees must work inside or lean into the cultivation space. The typical length, x-axis of a cultivation space is usually defined by the building envelope into which it is installed. However, cultivation chamber bays are created along the length of x-axis, usually dictated by support infrastructure. The combined multi-tiered cultivation spaces are usually aligned as back to back pairs, with walkways, stairs, elevators, and lifting systems provided for employee plant interactions. Some automated vertical cultivation systems are installed that automatically index the plants on mobile trays through the cultivation space. Rooting medias are typically fertigated with ebb and flow, drip feed, nutrient film or aeroponic systems, in automated systems, the crop is typically removed from the viatical cultivation space to perform many of the cultivation inputs. The aggregate crop must be exposed to solar, and artificial light typically LED or Fluorescent systems, at prescribed PPFD and DLI levels, and ambient or artificially conditioned air with recirculation systems are typically employed. Most cultivation strategies employed in vertical tier cultivation strategies are static systems employee's move to the plants, in a greenhouse environment the topmost cultivations tiers and thereby the aggregate crops installed therein receive the considerably more solar contribution to their PPFD and DLI requirements than the shaded lower tiers.

Shortcomings associated with this cultivation strategy include: building envelope space utilization, although a significant improvement over traditional indoor horizontal cultivation strategies, considerable employee and equipment access must be provided; poor workflow strategies, and ergonomics employees must bend, lean, walk, and climb stairs, this increases labor input costs; in greenhouse facilities solar contribution to cumulative PPFD, and DLI, and spectrum is non uniform, vertical cultivation tiers shade the crop to varying degrees down the vertical canopy column; Non-uniform environmental conditions down the vertical canopy column contribute to micro-climates, vapor pressure deficit control is difficult; and most facilities are poorly automated facilities.
root zone; a plant's root biomass responsible for the physical support of a plant, and the uptake of nutrients, water, and dissolved O2 all being crucial for photosynthesis to take place.
rooting media; a growing medium into and through which plant roots grow and may extract water and or dissolved O2 and or nutrients. A growing medium may provide physical support for the plant. A growing medium may be a soil, an organic material, an inorganic material (which may or may not be inert), or a mechanical device. Any mixture of these mediums may be used together to produce a mixed growing medium. Examples of organic based mediums are compost, peat moss, and coconut coir. Examples of inorganic based mediums are rockwool, vermiculite, and perlite. An example of a mechanical medium is one used in aeroponics systems wherein the plants roots grow in a light deprived container said air space is misted from time to time with a nutrient water mixture, the plant's roots and or plant's stem are usually supported in some way by the mechanical media.
root zone temperature control; Differential temperature control of the root zone has been shown to significantly increase yields, optimal canopy chemistry is rarely achieved at the same temperature as optimal root zone chemistry. Independent control of root zone has been adopted commercially where horizontal cultivation layouts are utilized, in aquaponic systems, and nutrient film system. The media holders and conveying trays detailed in this application are designed to provide integrated root zone cooling and use in conjunction with commercially available heat extraction technologies they will see net gains in the energy balance.
media holder; essentially a plant pot configured to facilitate the insertion, extraction and physical constrain a rooting media. The media holder may be further configured to permit transportation through a radiated space when directly or indirectly coupled to a drive mechanism. The media holder may be further configured with penetrations to allow air to flow into and out of a constrained rooting media. The media holder may be further configured with penetrations to allow the temporary insertion and retraction of any combination of root zone injectors and sensors into a constrained rooting media that may be necessary for the control and implementation of root zone fertigation. The media holder may be further configured with penetrations to allow the permanent insertion of any combination of root zone injectors and sensors that may be necessary for the control and implementation of root zone fertigation, said combination of root zone injectors and sensors will penetrate a rooting media inserted into the media holder. The media holder may be further configured with a sealed double skin (a box within a box) with inlet and outlet ports creating a thermal reservoir within which a stored fluid acts as a thermal mass, said stored fluid may be flushed from time to time when an external heat exchanging system is coupled to said inlet and outlet ports to maintain the said thermal mass at an optimal temperature, said thermal mass maintains the temperature of a rooting media installed a media holder at an optimal temperature range through thermal conduction.
conveying tray: a support mechanism operable to directly constrain at least one media holder or at least one rooting media. The conveying tray may be further configured, when designed to constrain a plurality of media holders or directly a plurality of rooting medias, with an offset position adjustment mechanism operable to vary the offset distance between the said plurality of media holders or the said plurality of rooting medias. The conveying tray is also configured with a locking/unlocking mechanism to permit connection to or repositioning on or removal from a drive mechanism operable to transport at least one conveying tray through a radiated space. The conveying try may be further configured with a sealed double skin (a box within a box) with inlet and outlet ports creating a thermal reservoir within which a stored fluid acts as a thermal mass, said stored fluid may be flushed from time to time when an external heat exchanging system is coupled to said inlet and outlet ports to maintain the said thermal mass at an optimal temperature, said thermal mass maintains the temperature of a rooting media installed in a media holder or directly within a conveying tray at an optimal temperature range through thermal conduction.
watering station;
   a fertigation mechanism operable to move, from a first position where any combination of root zone injectors and sensors that may be necessary for the control and implementation of root zone fertigation are remote from a rooting media constrained within a media holder constrained within a conveying tray, to a second position where the said any combination of root zone injectors and sensors pass through said conveying tray and through said media holder, into said constrained rooting media where the said any combination of root zone injectors and sensors are surrounded by said constrained rooting media and are operable to perform any function that may be necessary for the control and implementation of root zone fertigation, and said fertigation mechanism is further operable to return said any combination of root zone injectors and sensors from said second position to said first position where said any combination of root zone injectors and sensors that may be necessary for the control and implementation of root zone fertigation are remote from said rooting media said media holder and said conveying tray.
   OR
   a fertigation mechanism operable to move, from a first position where any combination of root zone injector couplers and sensor couplers are remote from a corresponding combination of root zone injectors and sensors that may be necessary for the control and implementation of root zone fertigation, said corresponding combination of root zone injectors and sensors are permanently installed in a media holder that is constrained within a conveying tray, to a second position where the said any combination of root zone injector couplers and sensor couplers pass through said conveying tray and couple with said corresponding combination of root zone injectors and sensors that are permanently installed in said media holder, a rooting media is constrained within said media holder, and said corresponding combination of root zone injectors and sensors permanently installed in said media holder are surrounded by said rooting media constrained within said media holder and are now operable to perform any function that may be necessary for the control and implementation of root zone fertigation, and said fertigation mechanism is further operable to return said any combination of root zone injector couplers and sensor couplers from said second position to said first position where said corresponding combination of root zone injector couplers and sensor couplers are remote from said corresponding combination of root zone injectors and sensors and said media holder and said conveying tray.
   OR
   a fertigation mechanism operable to move, from a first position where any combination of root zone injector couplers and sensor couplers are remote from a corresponding combination of root zone injectors and sensors that may be necessary for the control and implementation of root zone fertigation, said corresponding combination of root zone injectors and sensors are permanently installed in a media holder that is constrained in fixed location above the fertigation mechanism, to a second position where the said any combination of root zone injector couplers and sensor couplers couple with saidcorresponding combination of root zone injectors and sensors that are permanently installed in said media holder, a rooting media is constrained within said media holder and said corresponding combination of root zone injectors and sensors permanently installed in said media holder and are surrounded by said rooting media constrained within said media holder are now operable to perform any function that may be necessary for the control and implementation of root zone fertigation, and said fertigation mechanism is further operable to return said any combination of root zone injector couplers and sensor couplers from said second position to the said first position where said corresponding combination of root zone injector couplers and sensor couplers are remote from said corresponding combination of root zone injectors and sensors and said media holder and said conveying tray.
glycol station;
   a glycol injection mechanism operable to move an inlet glycol coupler and an outlet glycol coupler from a first position where said inlet glycol coupler and said outlet glycol coupler are remote from a corresponding inlet glycol port and an outlet glycol port which are installed in a thermal reservoir of a conveying tray, to a second position where said inlet glycol coupler and said outlet glycol coupler are coupled to said corresponding inlet glycol port and said outlet glycol port which are installed in said thermal reservoir of said conveying tray, said glycol injection mechanism is now operable to inject any suitable fluid into the said thermal reservoir of said conveying tray, injection of said any suitable fluid into the said thermal reservoir of said conveying tray will flush any existing fluid from said thermal reservoir of said conveying tray, said glycol injection mechanism is further operable to return said inlet glycol coupler and said outlet glycol coupler from said second position to the said first position where said inlet glycol coupler and said outlet glycol coupler are remote from said corresponding inlet glycol port and said outlet glycol port.
   OR
   a glycol injection mechanism operable to move an inlet glycol coupler and an outlet glycol coupler from a first position where said inlet glycol coupler and said outlet glycol coupler are remote from a corresponding inlet glycol port and an outlet glycol port which are installed in a thermal reservoir of a media holder constrained in a conveying tray, to a second position where said inlet glycol coupler and said outlet glycol coupler are coupled to said corresponding inlet glycol port and said outlet glycol port which are installed in said thermal reservoir of said media holder constrained in said conveying tray, said glycol injection mechanism is now operable to inject any suitable fluid into the said thermal reservoir of said media holder, injection of said any suitable fluid into the said thermal reservoir of said media holder will flush any existing fluid from said thermal reservoir of said media holder, said glycol injection mechanism is further operable to return said inlet glycol coupler and said outlet glycol coupler from said second position to the said first position where said inlet glycol coupler and said outlet glycol coupler are remote from said corresponding inlet glycol port and said outlet glycol port.
   OR
   a glycol injection mechanism operable to move an inlet glycol coupler and an outlet glycol coupler from a first position where said inlet glycol coupler and said outlet glycol coupler are remote from a corresponding inlet glycol port and an outlet glycol port which are installed in a thermal reservoir of a media holder that is constrained in fixed location above the said glycol injection mechanism, to a second position where said inlet glycol coupler and said outlet glycol coupler are coupled to said corresponding inlet glycol port and said outlet glycol port which are installed in said thermal reservoir of said media holder that is constrained in fixed location above the said glycol injection mechanism, said glycol injection mechanism is now operable to inject any suitable fluid into the said thermal reservoir of said media holder, injection of said any suitable fluid into the said thermal reservoir of said media holder will flush any existing fluid from said thermal reservoir of said media holder, said glycol injection mechanism is further operable to return said inlet glycol coupler and said outlet glycol coupler from said second position to the said first position where said inlet glycol coupler and said outlet glycol coupler are remote from said corresponding inlet glycol port and said outlet glycol port.
cultivation; the act of caring for or raising plants or crops or plant husbandry.
daily light integral (DLI); the number of photosynthetically active photons that are delivered to a specific surface area over a 24-hour period, usually expressed as moles of light (mol) per square meter (m⁻²) per day (d⁻¹) or mol m⁻² d⁻¹.
photosynthetic photon flux density (PPFD); the number of photons in the 400-nm range of the visible light spectrum that provides photosynthetically active radiation (PAR) necessary for plant photosynthesis, or near visible light photon flux density (PFD) that affords other health benefits to plants, in both cases the photon flux density is a measure of the number of photons that fall on a square meter of target area per second usually expressed as unit of an instantaneous PPFD reading micromoles (μmol) per square meter (m⁻²) per second (s⁻¹) or μmol m⁻² s⁻¹.
input; any process input that must be provided by automatic or manual means to a plant during its life cycle to ensure healthy abundant yields.
infrequent cultivation inputs (IFCI); typically labor intensive inputs that must be provided occasionally and for indeterminate periods throughout a plant's life cycle such as: machine loading, seeding, potting, repotting, pruning, topping, harvesting, and hardware sterilization.
frequent cultivation inputs (FCI); inputs that must be provided at least once daily for indeterminate periods during a plant's life cycle such as: solar radiation or artificial radiation (DLI, PFD, PPFD), root zone nutrient application and measurement, root zone water application and measurement, root zone water dissolved O2 application and measurement, root zone temperature control and measurement, root zone ph control and measurement, canopy atmospheric temperature control and measurement, canopy atmospheric humidity control and measurement, canopy atmospheric CO2 ppm augmentation and measurement, canopy atmospheric O2 ppm augmentation and measurement, and or canopy atmospheric pressure vapor deficit control and measurement, root zone or canopy pesticide or pathogen applications, and general plant health automatic or manual inspection.
radiated space; any dedicated cultivation space operable to provide plants with indeterminate periods of daily solar radiation and or artificial radiation.
processing space; any dedicated non-radiated space where plants are provided inputs.
hermetic environment; any air conditioned and or radiation deprivation environment isolated from external influences.
crop canopy statistical analysis; using laser scanning and other techniques, real time aggregate crop canopy analysis algorithms, integrated into programmable logic controllers (PLC) or other computer systems, can in real time ascertain the three dimensional canopy profile of the aggregate crop and that of individual member plants canopies. From this raw data in combination with statistical based analysis, actions can be derived to drive volumetrically optimized plant spacing, whether by manual or by automatic means. The algorithms can compare individual plant profiles to highlight poor performers, and potential health issues. Growth rates can be compared to previous crops providing a host of benefits; strategic crop input changes can be assessed, feedforward modifications can be made to input control parameter, and recipes, and all can be reported to interested parties. If a fully automated cultivation system is installed, individual plants within the aggregate crop, can be can automatically repositioned relative to the radiated cultivation space, spacing between individual plants can be modified, and in vertically tiered cultivation layouts individual plant location in the vertical canopy column and or cultivation tier. If photons are derived from artificial lighting systems with intelligent/movable fixtures lights can be repositioned, lighting banks can be de-energized, PPFD output and spectrums can be modified. These capabilities as a whole or in part can drive significant reductions in horticultural light infrastructure and operating costs and improve crop yields quality and repeatability.
volumetrically optimized plant spacing; During a crop life cycle (CLC) any individual plants canopy increases in volume as it grows, from the thin short plant that was initially planted to the significantly bushier taller plant that is harvested. Therefore, with respect to any plurality of plants grown as an aggregate crop (see Note 4) from initial planting to harvest in a fixed volume radiated cultivation space (RCS) the aggregate crop canopy occupies:
   An ever increasing fraction (EIFsa) of the total available horizontal surface area (TAHSA) (see Note 1) of the RCS, therefore the fraction of the TAHSA that must be irradiated by artificial light sources (see note 3 and note 5) at any point in time during the CLC is equal to the contemporaneous value of the EIFsa.
   An ever increasing fraction (EIFvh) of the maximum available vertical height (MaxAVH) (see Note 2), therefore the PPFD output demanded from artificial light sources (see Note 6) at any point in time during the CLC is directly proportional to the ratio of contemporaneous crop canopy height to the MaxAVH.
Once per day if manual canopy sampling and spacing by personnel is performed or based upon scheduled frequency calls to canopy sampling routine if an automated canopy sampling and spacing capability is provided by a particular type of cultivation system and then only whilst a CLC is underway, control of the volumetric spacing around individual plant canopies performed will be performed in two ways:
   optimization of horizontal plant spacing, each individual plant is assigned a horizontal surface area that is slightly larger than its actual surface area this surrounds the plant with an empty boundary allowance (EBA) for it to grow into. Three beneficial outcomes can be derived from the practice of keeping individual plants in the aggregate crop as close together as possible [1] photons produced by artificial light sources in a RCS will have a high probability of interacting with the aggregate crop canopy and a low probability of interacting with infrastructure hardware, put another way this means that more of the photons produced by artificial light sources are captured by the aggregate crop canopy for photosynthesis and as a direct result horticultural lighting operating costs are reduced, [2] the period of the CLC when contemporaneous value of the EIFsa is less than TAHSA of the RCS is the artificial light sources deactivation window (ALSDW), during the ALSDW the percentage of the total artificial light sources active when contemporaneous value of the EIFsa is less than TAHSA of the RCS is equal to the contemporaneous value of the (100*((EIFsa*TAHSA)+cumulative EBA for the aggregate crop in the units of measure squared)), as a direct result of deactivating artificial light sources during the ALSDW horticultural lighting operating costs are reduced, [3] in vertically tiered greenhouse cultivation layouts when solar gains are high and contemporaneous EIFsa is less than the TAHSA plants can be moved from the lower tiers to the top tier reducing the overall demand for artificial light and as a direct result horticultural lighting operating costs are reduced.
   optimization of vertical light spacing, (see Note 6) the vertical spacing between the top of the media holder and the artificial light sources adjusted if the plants have grown taller, consequently when vertical y-axis spacing is employed in conjunction with x, z axis offset spacing the energy output of the artificial light sources
   are more likely to strike the crop's canopy and less likely to strike non photosynthetic regions e.g. crop support hardware, more of the available photons are therefore captured for photosynthesis, and or wherein the distance relative to the y-axis between an artificial light source and the top of the crop's canopy is actively controlled thereby reducing the energy requirements needed to provide optimal PPFD from artificial light sources at all stages of crops life cycle.
It should be considered that, although claims that volumetrically optimized plant spacing significantly reduces horticultural lighting operating expenses, if the volumetrically optimized plant spacing strategy adopted is to be performed manually the additional labor costs incurred may render any savings in horticultural lighting operating expenses null or worse.
   (Note 1) TAHSA=length of the RCS*width of the RCS.
   (Note 2) MaxAVH=maximum vertical offset distance between the artificial light sources and the top of media holders−minimum allowable vertical offset distance from the crop canopy to the artificial light sources.
   (Note 3) If the lit fraction of the TAHSA and the physical crop canopy are aligned with each other relative to the x-axis and z axis of the RCS.
   (Note 4) For the purposes of this discussion growth rates have been simplified, and the maximum height of the crop canopy at harvest is equal to the MaxAVH.
   (Note 5) To simplify this discussion the number of artificial light sources above RCS approaches infinity.
   (Note 6) optimization of vertical light spacing can only be practiced when the vertical offset distance between the artificial light sources and the top of media holders and the PPFD output of the artificial light sources are both adjustable. To simplify this discussion the following statements are stipulated to be real world parameters: the PPFD output of the artificial light sources is variable between 10% and 100%. At 100% output, the PPFD experienced at the canopy is optimal when the vertical offset distance between the artificial light sources and the top of the media holders is equal to the MaxAVH. At 10% output the PPFD experienced at the canopy is optimal for the planted height of the crop canopy when the vertical offset distance between the artificial light sources and the top of the media holders is equal to the minimum allowable vertical offset distance from the crop canopy to the artificial light sources (MinAVH). When the vertical offset distance between the artificial light sources and the top of the media holders is less than the MaxAVH and greater than the MinAVH a linear relationship exists between the demanded PPFD output of the artificial light sources and the contemporaneous average crop canopy height (CACCH) such that demanded PPFD output of the artificial light sources in percent is equal to ((CACCH−MinA VH)/(MaxA VH−MinA VH))*100.
fertigation; within a rooting media the introduction and maintenance of an undefined mix of; liquid nutrients and or powdered nutrients and or water and or other substances beneficial to plant health. Said undefined mix may be further controlled within a rooting media for temperature, and or pH, and or dissolved O2, and or water content (WC), and or electrical conductivity (EC).
central processing; a work flow management method where when identical elements, require a repetitive work sequence to be performed on each duplicate. Each element is moved in consecutive order, either by hand or automatically, to a unique workstation location. Wherein a dedicated automated machine or employee performs the repetitive work sequence on each duplicate, or on an element that is returned multiple times. Central processing speeds up work flows and reduces the number of dedicated machines or men that would be required to perform the same repetitive work task if the identical elements were distributed around a production facility. In indoor commercial horticulture for example an oft labor intensive repetitive work sequence, is the daily or more frequent rooting media fertigation process of each plant in a crop every day for the life cycle of the crop and every subsequent crop.

This invention relates generally to plant cultivation systems. And more particularly to an automated recirculating plant growing mechanism employing conveying trays operable to constrain plant rooting medias for transportation in a radiated space around a prescribed conveying path. The prescribed conveying path may be radiated by artificial lighting and or solar radiation. The prescribed conveying path does not require that dedicated processing space be provided to perform frequent cultivation inputs (FCI) and plants may be continually recirculated around the conveying path without removing the plants from the radiated space. The recirculating plant growing mechanism is controlled by a microprocessor-based system that provides via sensors and final elements optimized automation of all aspects of the plant cultivation process.

### BACKGROUND ART

If the following input variables are controlled and optimized:

Canopy zone
Temperature;
Humidity;
CO2;
O2;
Transpiration rate;
Vapor pressure deficit.
   Root zone
Independent temperature;
Electrical conductivity;
Water content;
pH;
Dissolved O2;
Transpiration rate;
   and photosynthetically active radiation (PAR), whether derived by solar capture or artificially means, received at any location within the aggregate crop canopy exhibits uniform photosynthetic photon flux densities (PPFD) and spectrum, is consistent throughout the daily light integral (DIA).

The resultant crop produced in such “a perfected radiated cultivation space” will be of the highest quality and yield from obtainable.

A traditional commercial greenhouse cultivation strategy is designed around a horizontal cultivation layout, the principle reasons for selecting this strategy are familiarity, solar capture, simple ventilation technologies, and plant shading.

Fertigation systems employed are either drip feed, ebb and flow, or flush to drain. Individual root zones must have a complex fertigation supply path and dedicated equipment, central processing is precluded. Root zone variables can only be economically measured for a fraction of the plants in any cultivation space, therefore only a limited data set is available for use by nutrient control systems, resulting in averaged fertigation volume and mixing ratio setpoints. Dosing based upon an individual plant's requirements is not possible, outcomes include reduced crop yield and quality, higher than optimal consumption of nutrients, and excessive evaporative water loss resulting in an increase in HVAC energy consumption and higher incidence of plant disease.

Single tier growing is very inefficient in terms of the volumetric use of the building envelope, and limits biomass that can be grown within the cultivation space, this therefore limits the projected ROI and therefore caps, during the design phase, a facilities initial infrastructure expenditure and monies that can be allocated to operating and maintenance budgets for; the building structure, HVAC system, CO2 augmentation system, and other cultivation necessities. In other words: less plants grown equals less yield equals less gross margin and therefore results in a less than optimal budget allocations for infrastructure design, technologies deployed, and operating and maintenance expenses.

Vegetables like bell peppers are grown in a soilless growing medium, such as rockwool, utilizing a drip feed irrigation system to provide nutrients and water. The plants are grown as vines supported by wires attached to the roof of the building structure, these vines can be more than thirteen feet high and create a lot of shading for their neighbors and vice versa. The need for personal access space (to train, prune, inspect, or harvest the crop) results in inefficient in terms of the building volume to crop biomass ratios, and requires costly personnel elevator infrastructure. Shading reduces product quality and yield, PPFD levels within the canopy column vary markedly, DLI augmentation with artificial lighting can be cost prohibitive and is very inefficient considerable light energy never reaches the biomass and is absorbed by surrounding infrastructure. LED inter canopy lighting is now being practiced, allowing substantial energy savings over traditional overhead lighting setups, however the lights cause shading when not in operation and require growers to pick around them. Labor expenses are also high, with this type of cultivation strategy.

Commercial automated flat grow cultivation strategies have been adopted particularly in Europe and Asia however the plant transportation mechanisms take up a lot of production space and suffer the same plant capacity limitations as their manual flat grow single tiered counterparts.

Commercial vertically tiered cultivation layouts, with varying levels of automation, are now being widely adopted for the cultivation of crops such as lettuce, hydroponic arugula, and herbs. Vertical strategies have not yet been commercially adopted commercially for taller crops such as peppers and tomatoes. Artificial lighting is provided by LED or fluorescent fixtures which are operable in close proximity to the crop. These fixtures are mounted at a fixed height and position above the cultivation platform, optimization of vertical light spacing is obviated, these fixtures must therefore be operated at full energy output. Inherent labor costs associated obviate manual optimization of horizontal plant spacing, plants are therefore spaced based upon their horizontal surface area requirements at maturity or harvest. Ebb and flow and drip feeding are typical rule of thumb methods of fertigation, dosing optimization is obviated resulting in higher production costs, and less than optimal yields and product quality. It is impractical to adopt individual root zone watering systems root zone variables cannot be economically monitored at that resolution. In vertical cultivation layouts lacking automated conveying systems, personnel access must be provided to every plant in every vertical tier, process workflows are poor with scant consideration ergonomics principles, resulting in significant infrastructure investment and production expenses.

In typical commercial cultivation, it is difficult to practice economic and footprint friendly CO2 augmentation to levels, equal to or higher than outdoor ambient conditions, where crop quality, yield and growth rate can be optimized. Typical HVAC systems employed in indoor growing space cultivation are venting, space heaters, radiant slab, fans, and misters. Precise optimization of the temperature/humidity/CO2 balance indoors is not economical for most crops, in terms of both infrastructure costs and operating expenses. Biomass volume when compared to building envelope volume is such that a large volume of conditioned air in the building envelope is not utilized by the biomass, this is further exacerbated when the crop is young and exhibits negligible biomass, HVAC systems must be sized for the building envelope not the biomass. On cold days, optimizing temperature and CO2 levels requires that energy be expended to maintain optimal relative humidity levels. In summer venting to control temperature requires that energy be expended to control relative humidity, venting also obviates economic CO2 augmentation above ambient levels. As CO2 levels are increased the ideal growing temperature increases, thus, in late spring, summer, and early fall when the solar DLI is highest, and outdoor temperatures are closer to the higher air/crop temperatures requirements necessitated by high levels of CO2 inside the greenhouse, the substantial benefits in terms of yield, quality and growth rate from CO2 optimization cannot be economically realized because air must be vented from the building envelope to control the temperature, obviating augmentation. Vented legacy indoor growing solutions cannot reliably control the growing environment through annual ambient DLI, temperature, and humidity variations, only the adoption of sealed environment agriculture (SEA) technologies can provide precision control of the growing environment. Building envelope volume to biomass utilization ratios realized utilizing the cultivation systems examined in this text thus far obviate, for most indoor crops, the use of “state of the art” SEA technologies.

SEA requires expensive building infrastructure including:
Hermetically sealed HVAC systems.
Humidity control with water recovery systems.
Combined heat and power (CHP) technology, exhausted CO2 is utilized for economic CO2 augmentation.
Hermetically sealed building envelopes.
Airlock infrastructure.

Fully automated commercial vertical growing systems, that utilize vertical warehousing technologies, can achieve, for certain crops like leafy greens, herbs and cut flowers, the critical building envelope volume to biomass utilization ratios necessary to be commercially viable when employing a SEA cultivation strategy.

Unfortunately, the commercial systems available to date employ complex and expensive infrastructure including varied configurations of equipment such as:
Elevators;
Turntables;
Shuttles;
Cumbersome plant pot pallets;
Unsupported individual plant pots containing one or more plants.

All this infrastructure takes up considerable growing space inside the cultivation facility, requires a complex control system, and is expensive to maintain. Plants must be moved out of the vertical growing system and sent, by a common conveying system to inspection stations frequent cultivation inputs (FCI) increasing electrical energy consumption, Plant pot pallets are heavy and cumbersome especially when loaded with plants vertical cultivation systems, and common conveying equipment, must be sized according infrastructure expenditures. The aggregate crop sequentially moves through common conveying space, on its way to inspection stations, this obviates any strategic isolation practiced in the cultivation space, pests and pathogens are easily spread.

When vertical growing solutions are employed in a greenhouse environment, irrespective of the level of automation, shading is problematic, plants on the lower tiers receiving less solar radiation than the top tier, obviating consistent PPFD, cumulative DLI, and spectrum control throughout aggregate crop canopy thus root zone inputs cannot be fully optimized, and precision vapor pressure deficit control is problematic. Manually moving plants from one tier to another is cost prohibitive, the greenhouse may need to be shaded to protect the upper tier of plants, reducing indirect solar PPFD contribution to the lower tier plants and therefore increasing dependence inter-canopy artificial lighting.

PPFD, DLI, and spectrum are important factors in plant growth, and for the development of fruits and flowers, growers must strive to balance augmented lighting electrical energy input with crop yield improvements. Artificial light sources pose a variety of potential problems forcing plants to adjust and adapt compromising maximum growth and productivity. A broad spectrum of the electromagnetic radiation may be relevant to growing plants, certain wavelengths of the ultra-violet and infra-red spectrums have been shown to be beneficial. Certain visible spectrum wavelengths in the range of about 380 nm to 700 nm are necessary for photosynthesis. Artificial light energy PPFD is attenuated by the inverse square law relative to distance from the light source to the plant canopy, put another way the PPFD a plant canopy receives at one meter from its light source is four times that which receives at 2 meters for any given light energy output. There is a distance from any fixed energy light source, which varies from plant species to plant species, after which if reduced, plants become saturated by the amount of light energy being received, and any reduction in distance between the plant and its light source ceases to have positive effects on the plant's growth. This point is referred to in the art as the point of light saturation. A slightly greater distance from the point of saturation is optimal for photosynthesis internodal spacing is minimized, and growth, flower and fruit production are maximized.

Greenhouse typically horizontal cultivation layouts to optimize solar capture, a DLI with artificial light sources is problematic, plants situated further from an artificial light source receive significantly less light than those closer, these disadvantaged plants will suffer from “shade avoidance syndrome” (SAS) and exhibit reduced growth, flower and fruit production.

Some known devices used for growing plants employ moving light mechanisms or recirculating mechanisms which continuously recirculate plants relative to their light sources. While these devices may serve to mitigate or “even out” the effects of SAS, such devices may also be power and or labor intensive. In horizontal or vertical layouts, maximizing photosynthesis over the entire group of plants can only be achieved using multiple lights to approximate a uniform intensity over the entire layout, further increasing power requirements and requiring increased cooling inputs to the cultivation system. Furthermore, conventional light sources in horizontal layouts typically fail to function at peak efficiency, releasing radiation in all directions due to the scattering.

A more efficient way of cultivating indoor crops is desired exhibiting:
Uniform distribution of solar PPFD, spectrum, and cumulative DLI to the aggregate canopy column in greenhouse cultivation space;
Uniform distribution of PPFD, spectrum, and cumulative DLI to the aggregate canopy column in indoor cultivation space;
reduced horticultural lighting energy consumption from the utilization of automated volumetrically optimized plant spacing and crop canopy statistical analysis;
Increased use of central processing for input delivery;
overall reduction in labor expenditures;
reduced HVAC energy consumption;
higher yields and quality;
reduced water and nutrient consumption;
reduction in fertigation system infrastructure costs through central processing;
consistent repeatable produce traits;
reduced infrastructure and building envelope expenditures;
Root zone temperature control;
Increased use of automated cultivation systems.

Canadian Patent Document 2,343,254 discloses a “cylindrical drum” (recirculating conveying mechanism) mounted on a drive assembly, a fixed light source orientated lengthways and centered on the axis of rotation of the recirculating conveying mechanism mounted to the drive assembly. The drive assembly operable to rotate the recirculating conveying mechanism around an orbital conveying path. A plurality of evenly distributed penetrations cut into the cylindrical surface of the recirculating conveying mechanism, each penetration operable to constrain a plant pot, each plant pot operable to constrain rooting media within it. A fertigation tray orientated lengthways and aligned so that evenly distributed rooting medias constrained to the recirculating conveying mechanism and in rotation around the orbital conveying path will enter the fertigation tray for an undefined arc length (duration).

In normal operation the recirculating conveying mechanism is continuously rotated at a speed of approximately one revolution per hour, causing the constrained plants to follow the prescribed orbital conveying path around the fixed light source. During daily scheduled periods, depending on the DLI requirements of the plants, the fixed light source is energized, at all other times it is deenergized. Plants planted in the plurality of rooting medias grow radially inwardly from the recirculating conveying mechanism's cylindrical surface toward the fixed light source. During daily scheduled periods a fertigation control system automatically fills the tray with a with a mixture of water and nutrients, at all other times the trough is kept empty. During periods when the tray is filled with a mixture of water and nutrients, the constrained plurality rooting medias are fertigated in sequential groups, the total being fertigated once per rotation.

The radial distribution of the plants and their continuous rotation ensures the uniform distribution of the fixed light source's PPFD to all the plants cultivated in the recirculating conveying mechanism, substantially alleviating SAS. Photons previously scattered in traditional lighting strategies are directed towards the plants increasing artificial lighting efficiencies. The plants are continuously recirculated and as a result exhibit positive “proven in use” gravitropic response which increases growth, yield and quality.

Fertigation central processing is provided by the watering trough and fertigation control system, reducing labor input and fertigation infrastructure expenditures.

However, the mechanism disclosed in Canadian Patent 2,343,254 has some disadvantages: The fixed offset distance between the aggregate plant canopy and the artificial light source, necessitates operation of the light source at 100% energy output for all stages of the CLC, and obviates vertical light spacing optimization; The fixed offset distribution of the aggregate plant canopy, obviates horizontally optimized plant spacing; The tray as a means of fertigation central processing, precision dosing of root zones is obviated with this technology, after fertigation the rooting medias become saturated and drip on the light source. In addition, saturation is problematic for EC control, salt build up, and exacerbates harmful molds and fungi; This technology also increases labor inputs, workflow and ergonomic considerations are not factored into the design strategy, plants are hard to reach when infrequent cultivation inputs are required.

To reduce horticultural lighting energy costs by implementing a manual means to volumetrically optimize plant spacing, and to rectify the issues with the fertigation tray, Canadian patent 2,460,465 discloses a recirculation mechanism employing a variable diameter ring instead of the static “cylindrical drum”, ring segments may be added or removed to cause variations in the diameter of said cylinder, and growing media retaining members operable to adjust the radial offset distance between plants according to the needs of the aggregate crop at any stage of the CLC. In this way a manual method to volumetrically optimize plant spacing can be achieved. Instead of the fertigation tray, Canadian patent 2,460,465 discloses a central processing drip fertigation system located exteriorly to the ring and medium retaining members, allowing for the timed release of water and nutrients to said members.

However, the mechanism disclosed in Canadian patent 2,460,465 has some disadvantages: The crop canopy statistical analysis calculations required to calculate volumetrically optimized plant spacing must be made manually by the grower; Adjustments made to the medium retaining members affect all the medium retaining members at the same time; Inconvenience and much labor, as the crop grows within the recirculation mechanism, will result from the manually addition and subtraction of ring segments which increases and decreases the ring diameter and therefore the offset distance between the aggregate plant canopy and the artificial light source, and the offset distance between medium retaining members and therefore horizontal plant spacing; The offset distances are changed in steps and therefore PPFD is not always optimal; Like other recirculatory devices in the prior art, multiple of devices of varying diameters will be required to volumetrically optimize plant spacing throughout the aggregate crop's CLC, this will increase infrastructure expenditure, labor interactions, and the likelihood of pest and pathogen cross contamination when the crop is transferred from one mechanism to another; The ring shape itself requires eight segments to be substantially circular. A decrease in the full complement of segments causes the cylindrical layout formed by the medium retaining members to become increasingly polygonal in shape, this will cause differences in light intensity experienced by plants further from the light source and reintroduce the symptoms of SAS previously described; The immobility of the watering system, a plurality of drip feeders extend from a main liquid distribution member, because each injector does not have its own unique liquid input port, each distribution member must have a predetermined and unchangeable number of injectors attached. A further problem arises from the immobility of the watering element. Because the element is unable to advance or retreat along a predetermined path to penetrate or exit the medium retaining member, the watering system designed to obviate dripping is less than optimal; Aggregate crops grow radially inward from the drum circumference and toward the central light source this obviates direct solar contribution to the total available PPFD if the recirculation mechanism is deployed in a greenhouse environment.

To outline a “central processing horticultural” method US patent US20160192594 discloses method claims, if a selection of those claims were engineered with an eye towards a more scalable interpretation and the resulting apparatus was then manufactured and installed in a greenhouse environment or outdoor facility the solar contribution would contribute to or provide the sum total levels of PPFD and DLI required for potentially profitable commercial cultivation of certain plant species and strains, similar method examples of which many are disclosed in similar applications and commercially installed apparatus US patent US20160192594 discloses a horticulture method wherein a plurality of containers (plant pots) are fixed to an unbroken orbital conveyor having an orbital conveying path defined by conveyor rails, said orbital conveying path is divide into two sections a discrete “radiation space” wherein the plants installed in the containers may be irradiated by artificial or solar radiation; and a discrete unirradiated “processing space” wherein all or any designed “repetitive plant process” functions and or designed “plant process” functions must be performed on the plants installed in the containers as they recirculate around the orbital conveying path. In this patent application method, it is specified that plants installed in the containers are for most of the time parked in at least one discrete “radiation space” where they may be irradiated by artificial lighting and or if in a greenhouse or outdoor environment solar radiation. The conveyor is only recirculated when either one or more designed “repetitive plant process”s functions and or when either one or more designed “plant process”s functions is to be performed on the plants installed in the containers, at all other times the conveyor is stopped (not recirculating) and the plants installed in the containers are parked in the at least one discrete “radiation space”.

In one embodiment (*1) (see Drawings FIG. 1, FIG. 3, FIG. 4, FIG. 7, FIG. 8, FIG. 9, FIG. 10, FIG. 13, and FIG. 14) of US patent application US20160192594) of the method the unbroken orbital conveying path is divided into two sections; a discrete “radiation space” wherein the plants installed in the containers may be irradiated by artificial or solar radiation; and a discrete unirradiated “processing space” wherein all or any designed “repetitive plant process” functions and or designed “plant process” functions must be performed on the plants installed in the containers.

In another proposed embodiment (*2) (see Drawing FIG. 2 of US patent application US20160192594) of the method the unbroken orbital conveying path is divided into plurality of discrete “radiation space”s wherein the plants installed in the containers may be irradiated by artificial or solar radiation, and a plurality of discrete unirradiated “processing space” which are situated between each of the discrete “radiation space”s located on the unbroken orbital conveying path wherein all or any of the designed “repetitive plant process” functions and or designed “plant process” functions may be performed on the plants installed in the containers, if some of the designed “repetitive plant process”s and “plant process”s are designated to be performed in one of the plurality of discrete unirradiated “processing space” the remainder of the designed “repetitive plant process”s and “plant process”s must be designated to be performed in any of the remaining “processing space”s. Any designed “repetitive plant process” s and or “plant process” s may be performed in any of the plurality of discrete unirradiated “processing space”s i.e. a designed watering function may be installed at each of the plurality of “processing space”s situated on the unbroken orbital conveying path.

In another proposed embodiment (*3) (see Drawing FIG. 5 of US patent application US20160192594) of the method the substantially orbital conveying path is broken and has plurality of discrete “blind end” “radiation space” conveying branches wherein the plants installed in the containers may be parked and may be irradiated by artificial or solar radiation. This embodiment of the method does not define how the plants installed in the containers are decoupled from the substantially orbital conveying path and coupled onto the plurality of discrete “blind end” “radiation space” conveying branches, or define how the plants installed in the containers are decoupled from the plurality of discreet “blind end” “radiation space” conveying branches and coupled onto the substantially orbital conveying path. In this proposed embodiment of the method when any or all of the designed “repetitive plant process”s and designed “plant process”s are to be performed on some or all of the plants installed in the containers that are parked in a discrete “blind end” “radiation space” conveying branch some or all of the containers that are parked in the discrete “blind end” “radiation space” must be decoupled from the discrete “blind end” “radiation space” conveying branch and coupled onto the substantially orbital conveying path for sequential transportation into the unirradiated “processing space” wherein any or all of the designed “repetitive plant process” and any or all of the designed “plant processes” may be performed on the plants installed in the containers.

In another proposed embodiment (*4) (see Drawings FIG. 11, and FIG. 12 of US patent application US20160192594) of the method a “generic vertical farming system” the unbroken orbital conveying path passes into a discrete “radiation space” wherein the unbroken orbital conveying path describes a meandering route relative to the vertical plane said meandering route relative to the vertical plane is then repeated relative to one of the horizontal planes. In this proposed embodiment of the method when any or all of the designed “repetitive plant process”s and designed “plant process”s are to be performed on the plants installed in the containers that are parked on a “blind end” “radiation space” conveying branch some or all of the containers that are parked on a “blind end” “radiation space” must be decoupled from that “blind end” “radiation space” conveying branch and coupled onto the substantially orbital conveying path for sequential transportation into the unirradiated “processing space” wherein any or all of the designed “repetitive plant process” and any or all of the designed “plant processes” may be performed on the plants installed in the containers.

However, the mechanism disclosed in US patent application US20160192594 has some disadvantages: No method is disclosed to volumetrically optimize plant spacing between the plants installed in the containers, and no method is disclosed to volumetrically optimize the offset distance between the proposed artificial lighting and the plants installed in the containers; In the proposed embodiments of the method, a single unbroken conveyor is disclosed as operable to, recirculate the plants from the at least one discrete “radiation space” or the at least one “blind end” “radiation space” conveying branch
wherein in both cases the plants installed in the containers may be irradiated by artificial or solar radiation to the at least one unirradiated “processing space” wherein any or all of the designed “repetitive plant process” and any or all of the designed “plant processes” may be performed on the plants installed in the containers. This will be problematic because in all methods proposed, plants that need fertigating will be parked in the at least one “radiation space” whilst other work on other designed “repetitive plant process”s and designed “plant process”s is being performed on the plants installed in the containers and parked in the at least one unirradiated “processing space”; Parking plants in the at least one “radiation space” is the disclose method of operation when works on designed “repetitive plant process”s and designed “plant process”s are not being performed on the plants installed in the containers, uniform distribution of solar PPFD, spectrum, and cumulative DLI to the aggregate canopy column in greenhouse cultivation space cannot be achieved whilst the plants are parked.

It is desirable to provide a crop cultivation method by which all cultivation inputs are automated throughout the entire crop life cycle, while at the same time obviating the problems associated with traditional indoor growing methods.

### DISCLOSURE OF THE INVENTION

According to one aspect of the invention there is provided a recirculating plant growing mechanism comprising: (a) a conveying frame operable to support the various components of the recirculating plant growing mechanism; (b) at least one conveying tray assembly operable to support and constrain at least one rooting media; (c) a conveyor drive assembly operable to support at least one conveying tray assembly wherein the conveyor drive assembly further comprises at least one conveying chain drive motor/gearbox mechanism which provides rotational motive power operable to recirculate the at least one conveying tray assembly around the conveyor drive assemblies prescribed conveying path;

According to one aspect of the invention there is provided a recirculating plant growing mechanism comprising: (a) a conveying frame operable to support the various components of the recirculating plant growing mechanism; (b) a plurality of conveying tray assemblies each operable to support and constrain a plurality of rooting medias; (c) a conveyor drive assembly operable to support the plurality of conveying tray assemblies wherein the conveyor drive assembly further comprises a conveying chain drive motor/gearbox mechanism which provides rotational motive power operable to recirculate the plurality of conveying tray assemblies and wherein each of the plurality of conveying tray assemblies further comprises media holders position adjustment assembly which is operable to when coupled with at least one media holder drive assembly adjust the offset distance the plurality of rooting medias.

According to one aspect of the invention there is provided a recirculating plant growing mechanism comprising: (a) a conveying frame operable to support the various components of the recirculating plant growing mechanism; (b) at least one conveying tray assembly operable to support and constrain at least one rooting media wherein the at least one conveying tray assembly comprises at least one conveying tray locking mechanism operable to lock the at least one conveying tray assembly to the conveyor drive assembly and operable to unlock the at least one conveying tray assembly from the conveyor drive assembly; (c) a conveyor drive assembly operable to support at least one conveying tray assembly wherein the conveyor drive assembly further comprises at least one conveying chain drive motor/gearbox mechanism which provides rotational motive power operable to recirculate the at least one conveying tray assembly locked onto the conveyor drive assembly around the conveyor drive assemblies prescribed conveying path; (d) at least one conveying tray de-coupler assembly wherein the at least one conveying tray de-coupler assembly further comprises an actuating mechanism operable to lock at least one conveying tray assembly to the conveyor drive assembly and operable to unlock at least one conveying tray assembly from the conveyor drive assembly allowing the at least one conveying tray assembly to be repositioned on the conveyor drive assembly relative to the prescribed conveying path;

According to one aspect of the invention there is provided a recirculating plant growing mechanism comprising: (a) a conveying frame operable to support the various components of the recirculating plant growing mechanism; (b) a plurality of conveying tray assemblies each operable to support and constrain a plurality of rooting medias wherein each of the plurality of conveying tray wherein each of the plurality of conveying tray assemblies further comprises a plurality of conveying tray locking mechanisms operable to lock each of the plurality of conveying tray assemblies to the conveyor drive assembly and operable to unlock each of the plurality of conveying tray assemblies from the conveyor drive assembly and wherein each of the plurality of conveying tray assemblies further comprises media holders position adjustment assembly which is operable to when coupled with at least one media holder drive assembly adjust the offset distance the plurality of rooting medias; (c) a conveyor drive assembly operable to support the plurality of conveying tray assemblies wherein the conveyor drive assembly further comprises a conveying chain drive motor/gearbox mechanism which provides rotational motive power operable to recirculate the plurality of conveying tray assemblies locked onto the conveyor drive assembly around the conveyor drive assemblies' prescribed conveying path; (d) at least one conveying tray de-coupler assembly wherein the at least one conveying tray de-coupler assembly further comprises an actuating mechanism operable to lock at least one conveying tray assembly to the conveyor drive assembly and operable to unlock at least one conveying tray assembly from the conveyor drive assembly allowing the at least one conveying tray assembly to be repositioned on the conveyor drive assembly relative to the prescribed conveying path;

According to one aspect of the invention there is provided a recirculating plant growing mechanism comprising: (a) a conveying frame operable to support the various components of the recirculating plant growing mechanism; (b) a plurality of conveying tray assemblies each operable to support and constrain a plurality of rooting medias wherein each of the plurality of conveying tray wherein each of the plurality of conveying tray assemblies further comprises a plurality of conveying tray locking mechanisms operable to lock each of the plurality of conveying tray assemblies to the conveyor drive assembly and operable to unlock each of the plurality of conveying tray assemblies from the conveyor drive assembly and wherein each of the plurality of conveying tray assemblies further comprises a media holders position adjustment assembly which is operable to when coupled with the at least one media holder drive assembly to adjust the offset distance between the plurality of rooting medias; (c) a conveyor drive assembly operable to support the plurality of conveying tray assemblies wherein the conveyor drive assembly further comprises a conveying chain drive motor/gearbox mechanism which provides rotational motive power operable to recirculate the plurality of conveying tray assemblies locked onto the conveyor drive assembly around the conveyor drive assemblies' prescribed conveying path; (d) at least one media holder drive assembly wherein the at least one media holder drive assembly further comprises an actuating mechanism operable when the at least one media holder drive assembly is aligned with one of the plurality of conveying tray assemblies' media holders position adjustment assembly to couple with and uncouple from the aligned conveying tray assemblies' media holders position adjustment assembly wherein the at least one media holder drive assembly further comprises an actuating mechanism operable when coupled to one of the plurality of conveying tray assemblies to vary the offset distance between each of the plurality of rooting medias constrained in the coupled conveying tray assembly;

According to one aspect of the invention there is provided a recirculating plant growing mechanism comprising: (a) a conveying frame operable to support the various components of the recirculating plant growing mechanism; (b) at least one conveying tray assembly operable to support and constrain at least one rooting media wherein the at least one conveying tray assembly comprises at least one conveying tray locking mechanism operable to lock the at least one conveying tray assembly to the conveyor drive assembly and operable to unlock the at least one conveying tray assembly from the conveyor drive assembly; (c) a conveyor drive assembly operable to support at least one conveying tray assembly wherein the conveyor drive assembly further comprises at least one conveying chain drive motor/gearbox mechanism which provides rotational motive power operable to recirculate the at least one conveying tray assembly locked onto the conveyor drive assembly around the conveyor drive assemblies prescribed conveying path; (d) at least one exit gate assembly wherein the at least one exit gate assembly further comprises an actuating mechanism operable to lock at least one conveying tray assembly to the conveyor drive assembly and operable to unlock at least one conveying tray assembly from the conveyor drive assembly and operable to open the conveyor drive, at least one exit gate assembly is operable to close said at least one conveyor drive;

According to one aspect of the invention there is provided a recirculating plant growing mechanism comprising: (a) a conveying frame operable to support the various components of the recirculating plant growing mechanism; (b) a plurality of conveying tray assemblies each operable to support and constrain a plurality of rooting medias wherein each of the plurality of conveying tray wherein each of the plurality of conveying tray assemblies further comprises a plurality of conveying tray locking mechanisms operable to lock each of the plurality of conveying tray assemblies to the conveyor drive assembly and operable to unlock each of the plurality of conveying tray assemblies from the conveyor drive assembly and wherein each of the plurality of conveying tray assemblies further comprises a media holders position adjustment assembly which is operable to when coupled with the at least one media holder drive assembly to adjust the offset distance between the plurality of rooting medias; (c) a conveyor drive assembly operable to support the plurality of conveying tray assemblies wherein the conveyor drive assembly further comprises a conveying chain drive motor/gearbox mechanism which provides rotational motive power operable to recirculate the plurality of conveying tray assemblies locked onto the conveyor drive assembly around the conveyor drive assemblies' prescribed conveying path; (d) at least one media holder drive assembly wherein the at least one media holder drive assembly further comprises an actuating mechanism operable when the at least one media holder drive assembly is aligned with one of the plurality of conveying tray assemblies' media holders position adjustment assembly to couple with and uncouple from the aligned conveying tray assemblies' media holders position adjustment assembly wherein the at least one media holder drive assembly further comprises an actuating mechanism operable when coupled to one ofthe plurality of conveying tray assemblies to vary the offset distance between each of the plurality of rooting medias constrained in the coupled conveying tray assembly; (e) a plurality of exit gate assemblies wherein each of the plurality of exit gate assemblies further comprises an actuating mechanism operable to lock at least one conveying tray assembly to the conveyor drive assembly and operable to unlock at least one conveying tray assembly from the conveyor drive assembly and operable to open the conveyor drive assemblies' at least one exit gate and operable to close the conveyor drive assemblies' at least one exit gate;

According to one aspect of the invention there is provided a recirculating plant growing mechanism comprising: (a) a conveying frame operable to support the various components of the recirculating plant growing mechanism; (b) at least one conveying tray assembly operable to support and constrain at least one rooting media wherein the at least one conveying tray assembly comprises at least one conveying tray locking mechanism operable to lock the at least one conveying tray assembly to the conveyor drive assembly and operable to unlock the at least one conveying tray assembly from the conveyor drive assembly; (c) a conveyor drive assembly operable to support at least one conveying tray assembly wherein the conveyor drive assembly further comprises at least one conveying chain drive motor/gearbox mechanism which provides rotational motive power operable to recirculate the at least one conveying tray assembly locked onto the conveyor drive assembly around the conveyor drive assemblies prescribed conveying path; (d) at least one exit gate assembly wherein the at least one exit gate assembly further comprises an actuating mechanism operable to lock at least one conveying tray assembly to the conveyor drive assembly and operable to unlock at least one conveying tray assembly from the conveyor drive assembly and operable to open the conveyor drive, at least one exit gate assembly is operable to close said at least one conveyor drive; (e) at least one an air lock transfer actuator assembly operable to clamp and to transport the at least one conveying tray assembly from the entrance of the recirculating plant conveying mechanism to the at least one exit gate assembly and operable to clamp and to transport the at least one conveying tray assembly from the entrance of the recirculating plant conveying mechanism to said at least one exit gate assembly;

According to one aspect of the invention there is provided a recirculating plant growing mechanism: (a) a conveying frame operable to support the various components of the recirculating plant growing mechanism; (b) a plurality of conveying tray assemblies each operable to support and constrain a plurality of rooting medias wherein each of the plurality of conveying tray wherein each of the plurality of conveying tray assemblies further comprises a plurality of conveying tray locking mechanisms operable to lock each of the plurality of conveying tray assemblies to the conveyor drive assembly and operable to unlock each of the plurality of conveying tray assemblies from the conveyor drive assembly and wherein each of the plurality of conveying tray assemblies further comprises a media holders position adjustment assembly which is operable to when coupled with the at least one media holder drive assembly to adjust the offset distance between the plurality of rooting medias; (c) a conveyor drive assembly operable to support the plurality of conveying tray assemblies wherein the conveyor drive assembly further comprises a conveying chain drive motor/gearbox mechanism which provides rotational motive power operable to recirculate the plurality of conveying tray assemblies locked onto the conveyor drive assembly around the conveyor drive assemblies' prescribed conveying path; (d) at least one media holder drive assembly wherein the at least one media holder drive assembly further comprises an actuating mechanism operable when the at least one media holder drive assembly is aligned with one of the plurality of conveying tray assemblies' media holders position adjustment assembly to couple with and uncouple from the aligned conveying tray assemblies' media holders position adjustment assembly wherein the at least one media holder drive assembly further comprises an actuating mechanism operable when coupled to one of the plurality of conveying tray assemblies to vary the offset distance between each of the plurality of rooting medias constrained in the coupled conveying tray assembly; (e) a plurality of exit gate assemblies wherein each of the plurality of exit gate assemblies further comprises an actuating mechanism operable to lock at least one conveying tray assembly to the conveyor drive assembly and operable to unlock at least one conveying tray assembly from the conveyor drive assembly and operable to open the conveyor drive assemblies' at least one exit gate and operable to close the conveyor drive assemblies' at least one exit gate; (g) a plurality of air lock transfer actuator assemblies operable to clamp and to transport the at least one conveying tray assembly from the entrance of the recirculating plant conveying mechanism to the at least one exit gate assembly and operable to clamp and to transport the at least one conveying tray assembly from the entrance of the recirculating plant conveying mechanism to said at least one exit gate assembly;

According to one aspect of the invention there is provided a recirculating plant growing mechanism comprising: (a) a conveying frame operable to support the various components of the recirculating plant growing mechanism; (b) at least one conveying tray assembly operable to support and constrain at least one rooting media wherein the at least one conveying tray assembly comprises at least one conveying tray locking mechanism operable to lock the at least one conveying tray assembly to the conveyor drive assembly and operable to unlock the at least one conveying tray assembly from the conveyor drive assembly; (c) a conveyor drive assembly operable to support at least one conveying tray assembly wherein the conveyor drive assembly further comprises at least one conveying chain drive motor/gearbox mechanism which provides rotational motive power operable to recirculate the at least one conveying tray assembly locked onto the conveyor drive assembly around the conveyor drive assemblies prescribed conveying path; (d) at least one exit gate assembly wherein the at least one exit gate assembly further comprises an actuating mechanism operable to lock at least one conveying tray assembly to the conveyor drive assembly and operable to unlock at least one conveying tray assembly from the conveyor drive assembly and operable to open the conveyor drive, at least one exit gate assembly is operable to close said at least one conveyor drive; (e) at least one an air lock transfer actuator assembly operable to clamp and to transport the at least one conveying tray assembly from the entrance of the recirculating plant conveying mechanism to the at least one exit gate assembly and operable to clamp and to transport the at least one conveying tray assembly from the entrance of the recirculating plant conveying mechanism to said at least one exit gate assembly; f) at least one an air lock transfer assembly operable in conjunction with the said at least one conveying frame clad in a hermetic material to isolate the said recirculating plant conveying mechanism from ambient outside air wherein the at least one an air lock transfer assembly further comprises an actuating mechanism operable to open and close the at least one air lock door;

According to one aspect of the invention there is provided a recirculating plant growing mechanism comprising: (a) a conveying frame operable to support the various components of the recirculating plant growing mechanism; (b) a plurality of conveying tray assemblies each operable to support and constrain a plurality of rooting medias wherein each of the plurality of conveying tray wherein each of the plurality of conveying tray assemblies further comprises a plurality of conveying tray locking mechanisms operable to lock each of the plurality of conveying tray assemblies to the conveyor drive assembly and operable to unlock each of the plurality of conveying tray assemblies from the conveyor drive assembly and wherein each of the plurality of conveying tray assemblies further comprises a media holders position adjustment assembly which is operable to when coupled with the at least one media holder drive assembly to adjust the offset distance between the plurality of rooting medias; (c) a conveyor drive assembly operable to support the plurality of conveying tray assemblies wherein the conveyor drive assembly further comprises a conveying chain drive motor/gearbox mechanism which provides rotational motive power operable to recirculate the plurality of conveying tray assemblies locked onto the conveyor drive assembly around the conveyor drive assemblies' prescribed conveying path; (d) at least one media holder drive assembly wherein the at least one media holder drive assembly further comprises an actuating mechanism operable when the at least one media holder drive assembly is aligned with one of the plurality of conveying tray assemblies' media holders position adjustment assembly to couple with and uncouple from the aligned conveying tray assemblies' media holders position adjustment assembly wherein the at least one media holder drive assembly further comprises an actuating mechanism operable when coupled to one of the plurality of conveying tray assemblies to vary the offset distance between each of the plurality of rooting medias constrained in the coupled conveying tray assembly; (e) a plurality of exit gate assemblies wherein each of the plurality of exit gate assemblies further comprises an actuating mechanism operable to lock at least one conveying tray assembly to the conveyor drive assembly and operable to unlock at least one conveying tray assembly from the conveyor drive assembly and operable to open the conveyor drive assemblies' at least one exit gate and operable to close the conveyor drive assemblies' at least one exit gate; (f) a plurality of air lock transfer actuator assemblies operable to clamp and to transport the at least one conveying tray assembly from the entrance of the recirculating plant conveying mechanism to the at least one exit gate assembly and operable to clamp and to transport the at least one conveying tray assembly from the entrance of the recirculating plant conveying mechanism to said at least one exit gate assembly; (g) a plurality of air lock transfer assemblies each operable in conjunction with the said at least one conveying frame clad in a hermetic material to isolate the recirculating plant conveying mechanism from ambient outside air a plurality of air lock transfer assemblies each operable in conjunction with the at least one conveying frame clad in a hermetic material to isolate the recirculating plant conveying mechanism from ambient outside air wherein each of the plurality of air lock transfer assemblies further comprises a plurality of actuating mechanisms each operable to open and close at least one air lock door;

According to one aspect of the invention there is provided a recirculating plant growing mechanism comprising: (a) a conveying frame operable to support the various components of the recirculating plant growing mechanism; (b) at least one conveying tray assembly operable to support and constrain at least one rooting media wherein the at least one conveying tray assembly comprises at least one conveying tray locking mechanism operable to lock the at least one conveying tray assembly to the conveyor drive assembly and operable to unlock the at least one conveying tray assembly from the conveyor drive assembly; (c) a conveyor drive assembly operable to support at least one conveying tray assembly wherein the conveyor drive assembly further comprises at least one conveying chain drive motor/gearbox mechanism which provides rotational motive power operable to recirculate the at least one conveying tray assembly locked onto the conveyor drive assembly around the conveyor drive assemblies prescribed conveying path; (d) at least one watering station assembly operable to fertigate and/or water at least one rooting media of at least one plant constrained in at least one conveying tray assembly wherein the at least one watering station assembly further comprises at least one fertigation injection probe wherein the at least one watering station assembly further comprises an actuating mechanism operable to move the at least one fertigation injection probe from a first position wherein the at least one fertigation injection probe is remote from the at least one conveying tray assembly to a second position wherein the at least one fertigation injection probe is within the at least one conveying tray assemblies' rooting media;

According to one aspect of the invention there is provided a recirculating plant growing mechanism comprising: (a) a conveying frame operable to support the various components of the recirculating plant growing mechanism; (b) a plurality of conveying tray assemblies each operable to support and constrain a plurality of rooting medias wherein each of the plurality of conveying tray wherein each of the plurality of conveying tray assemblies further comprises a plurality of conveying tray locking mechanisms operable to lock each of the plurality of conveying tray assemblies to the conveyor drive assembly and operable to unlock each of the plurality of conveying tray assemblies from the conveyor drive assembly and wherein each of the plurality of conveying tray assemblies further comprises a media holders position adjustment assembly which is operable to when coupled with the at least one media holder drive assembly to adjust the offset distance between the plurality of rooting medias; (c) a conveyor drive assembly operable to support the plurality of conveying tray assemblies wherein the conveyor drive assembly further comprises a conveying chain drive motor/gearbox mechanism which provides rotational motive power operable to recirculate the plurality of conveying tray assemblies locked onto the conveyor drive assembly around the conveyor drive assemblies' prescribed conveying path; (d) at least one media holder drive assembly wherein the at least one media holder drive assembly further comprises an actuating mechanism operable when the at least one media holder drive assembly is aligned with one of the plurality of conveying tray assemblies' media holders position adjustment assembly to couple with and uncouple from the aligned conveying tray assemblies' media holders position adjustment assembly wherein the at least one media holder drive assembly further comprises an actuating mechanism operable when coupled to one of the plurality of conveying tray assemblies to vary the offset distance between each of the plurality of rooting medias constrained in the coupled conveying tray assembly; (e) a plurality of watering station assemblies each operable to fertigate and/or water at least one rooting media of a plurality of plants constrained in at least one conveying tray assembly wherein each of the plurality of watering station assemblies further comprises a plurality of fertigation injection probes mounted on probe sliders wherein each of the plurality of watering station assemblies further comprises an actuating mechanism operable to move its plurality of fertigation injection probes from a first position wherein its plurality of fertigation injection probes are remote from the at least one conveying tray assembly to a second position wherein its plurality of fertigation injection probes are within a plurality of conveying tray assemblies' rooting medias wherein each of the plurality of watering station assemblies further comprises at least one probe slider position adjustment assembly operable to adjust the offset distance between the plurality of fertigation injection probes so that the offset distance matches the offset distance of each plurality of rooting medias in each of the conveying tray assemblies;

According to one aspect of the invention there is provided a recirculating plant growing mechanism comprising: (a) a conveying frame operable to support the various components of the recirculating plant growing mechanism; (b) at least one conveying tray assembly operable to support and constrain at least one rooting media wherein the at least one conveying tray assembly comprises at least one conveying tray locking mechanism operable to lock the at least one conveying tray assembly to the conveyor drive assembly and operable to unlock the at least one conveying tray assembly from the conveyor drive assembly; (c) a conveyor drive assembly operable to support at least one conveying tray assembly wherein the conveyor drive assembly further comprises at least one conveying chain drive motor/gearbox mechanism which provides rotational motive power operable to recirculate the at least one conveying tray assembly locked onto the conveyor drive assembly around the conveyor drive assemblies prescribed conveying path; (d) at least one glycol injection station mechanism operable to inject glycol or any other suitable fluid into at least one conveying tray assemblies' integrated thermal reservoir wherein the at least one glycol injection station mechanism further comprises at least one glycol coupler wherein the at least one glycol injection station mechanism further comprises an actuating mechanism operable to move the at least one glycol coupler from a first position wherein the at least one glycol coupler is remote from the at least one conveying tray assembly to a second position wherein the at least one glycol coupler is coupled with the at least one conveying tray assemblies' integrated thermal reservoir;

According to one aspect of the invention there is provided a recirculating plant growing mechanism comprising: (a) a conveying frame operable to support the various components of the recirculating plant growing mechanism; (b) a plurality of conveying tray assemblies each operable to support and constrain a plurality of rooting medias wherein each of the plurality of conveying tray wherein each of the plurality of conveying tray assemblies further comprises a plurality of conveying tray locking mechanisms operable to lock each of the plurality of conveying tray assemblies to the conveyor drive assembly and operable to unlock each of the plurality of conveying tray assemblies from the conveyor drive assembly and wherein each of the plurality of conveying tray assemblies further comprises a media holders position adjustment assembly which is operable to when coupled with the at least one media holder drive assembly to adjust the offset distance between the plurality of rooting medias; (c) a conveyor drive assembly operable to support the plurality of conveying tray assemblies wherein the conveyor drive assembly further comprises a conveying chain drive motor/gearbox mechanism which provides rotational motive power operable to recirculate the plurality of conveying tray assemblies locked onto the conveyor drive assembly around the conveyor drive assemblies' prescribed conveying path; (d) a plurality of glycol injection station mechanisms each operable to inject glycol or any other suitable fluid into the at least one conveying tray assemblies' integrated thermal reservoir wherein each of the plurality of glycol injection station mechanisms further comprises at least one glycol coupler wherein each of the plurality of glycol injection station mechanisms further comprises an actuating mechanism operable to move its at least one glycol coupler from a first position wherein it's at least one glycol coupler is remote from the at least one conveying tray assembly to a second position wherein it's at least one glycol coupler is coupled with the at least one conveying tray assemblies' integrated thermal reservoir;

According to one aspect of the invention there is provided a recirculating plant growing mechanism comprising: (a) a conveying frame operable to support the various components of the recirculating plant growing mechanism; (b) a conveyor drive assembly operable to support and recirculate at least one light bar cleaning assembly wherein the conveyor drive assembly further comprises at least one conveying chain drive motor/gearbox mechanism which provides rotational motive power operable to recirculate the at least one light bar cleaning assembly locked onto the conveyor drive assembly around the conveyor drive assemblies prescribed conveying path; (c) at least one cleaning solution injection station mechanism operable to inject cleaning solution into the at least one light bar cleaning assemblies' cleaning solution pressure bladder tank wherein the at least one cleaning solution injection station mechanism further comprises at least one cleaning solution coupler wherein the at least one cleaning solution injection station mechanism further comprises an actuating mechanism operable to move the at least one cleaning solution coupler from a first position wherein the at least one cleaning solution coupler is remote from the at least one light bar cleaning assembly to a second position wherein the at least one cleaning solution coupler is coupled with the at least one light bar cleaning assemblies' cleaning solution pressure bladder tank; (d) at least one LED light bar assembly the at least one LED light bar assembly further comprises at least one LED light bar track operable to support at least one light emitting source wherein the LED at least one light bar assembly further comprises at least one stepper motor operable to vary the offset distance relative to the Y-Axis of the prescribed conveying path of said at least one light emitting source from the at least one conveying tray assembly as it recirculates around the prescribed conveying path; (e) at least one light emitting source mounted on the at least one LED light bar assembly the at least one light emitting source operable to emit light wherein at least one LED light emitting source assembly further comprises at least one LED light bar stepper motor assembly operable to move the at least one light emitting source around the at least one LED light bar assembly's at least one LED light bar track's u-shape path relative to the Z-Axis and Y-Axis of the prescribed conveying path so to adjust at least one light emitting source's relative position around the plant canopy. (f) at least one light bar cleaning assembly operable to clean at least one light emitting source.

According to one aspect of the invention there is provided a recirculating plant growing mechanism comprising: (a) a conveying frame operable to support the various components of the recirculating plant growing mechanism; (b) a conveyor drive assembly operable to support and recirculate a plurality of light bar cleaning assemblies wherein the conveyor drive assembly further comprises at least one conveying chain drive motor/gearbox mechanism which provides rotational motive power operable to recirculate the plurality of light bar cleaning assemblies locked onto the conveyor drive assembly around the conveyor drive assemblies prescribed conveying path; (c) a plurality of cleaning solution injection station mechanisms each operable to inject cleaning solution into at least one light bar cleaning assemblies' cleaning solution pressure bladder tank wherein each of the plurality of cleaning solution injection station mechanisms further comprises at least one cleaning solution coupler wherein each of the plurality of cleaning solution injection station mechanisms further comprises an actuating mechanism operable to move the at least one cleaning solution coupler from a first position wherein it's at least one cleaning solution coupler is remote from the at least one light bar cleaning assembly to a second position wherein it's at least one cleaning solution coupler is coupled with the at least one light bar cleaning assemblies' cleaning solution pressure bladder tank; (d) a plurality of LED light bar assemblies wherein each of the plurality of LED light bar assemblies further comprises a plurality of LED light bar tracks each operable to support a plurality of light emitting sources wherein the LED at least one light bar assembly further comprises a plurality of stepper motors each operable to vary the offset distance relative to the Y-Axis of the prescribed conveying path of at least one light emitting source from the said at least one conveying tray assembly as it recirculates around the said prescribed conveying path; (e) a plurality of light emitting sources mounted on the at least one LED light bar assembly each of the plurality of light emitting source are operable to emit light wherein each of the plurality of light emitting sources further comprises a plurality LED light bar stepper motor assemblies operable to move at least one light emitting source around the at least one LED light bar assembly's at least one LED light bar track's u-shape path relative to the Z-Axis and Y-Axis of the prescribed conveying path so to adjust said at least one light emitting source's relative position around the plant canopy; (f) at least one light bar cleaning assembly operable to clean a plurality of light emitting sources.

According to one aspect of the invention there is provided a recirculating plant growing mechanism comprising: (a) a conveying frame operable to support the various components of the recirculating plant growing mechanism wherein the conveying frame further comprises a cladding of hermetic material operable to isolate the recirculating plant growing mechanism from ambient outside air; (b) at least one conveying tray assembly operable to support and constrain at least one rooting media wherein the at least one conveying tray assembly comprises an integrated thermal reservoir operable to contain any suitable liquid at optimal root zone temperature and wherein the at least one conveying tray assembly comprises at least one conveying tray locking mechanism operable to lock the at least one conveying tray assembly to the conveyor drive assembly and operable to unlock the at least one conveying tray assembly from the conveyor drive assembly; (c) a conveyor drive assembly operable to support at least one conveying tray assembly wherein the conveyor drive assembly further comprises at least one conveying chain drive motor/gearbox mechanism which provides rotational motive power operable to recirculate the at least one conveying tray assembly locked onto the conveyor drive assembly around the conveyor drive assemblies prescribed conveying path; (d) at least one conveying tray de-coupler assembly wherein the at least one conveying tray de-coupler assembly further comprises an actuating mechanism operable to lock at least one conveying tray assembly to the conveyor drive assembly and operable to unlock at least one conveying tray assembly from the conveyor drive assembly allowing the at least one conveying tray assembly to be repositioned on the conveyor drive assembly relative to the prescribed conveying path; (e) at least one exit gate assembly wherein the at least one exit gate assembly further comprises an actuating mechanism operable to lock at least one conveying tray assembly to the conveyor drive assembly and operable to unlock at least one conveying tray assembly from the conveyor drive assembly and operable to open the conveyor drive, at least one exit gate assembly is operable to close said at least one conveyor drive; (0 at least one an air lock transfer actuator assembly operable to clamp and to transport the at least one conveying tray assembly from the entrance of the recirculating plant conveying mechanism to the at least one exit gate assembly and operable to clamp and to transport the at least one conveying tray assembly from the entrance of the recirculating plant conveying mechanism to said at least one exit gate assembly; (g) at least one an air lock transfer assembly operable in conjunction with the said at least one conveying frame clad in a hermetic material to isolate the said recirculating plant conveying mechanism from ambient outside air wherein the at least one an air lock transfer assembly further comprises an actuating mechanism operable to open and close the at least one air lock door; (h) at least one watering station assembly operable to fertigate and/or water at least one rooting media of at least one plant constrained in at least one conveying tray assembly wherein the at least one watering station assembly further comprises at least one fertigation injection probe wherein the at least one watering station assembly further comprises an actuating mechanism operable to move the at least one fertigation injection probe from a first position wherein the at least one fertigation injection probe is remote from the at least one conveying tray assembly to a second position wherein the at least one fertigation injection probe is within the at least one conveying tray assemblies' rooting media; (i) at least one glycol injection station mechanism operable to inject glycol or any other suitable fluid into at least one conveying tray assemblies' integrated thermal reservoir wherein the at least one glycol injection station mechanism further comprises at least one glycol coupler wherein the at least one glycol injection station mechanism further comprises an actuating mechanism operable to move the at least one glycol coupler from a first position wherein the at least one glycol coupler is remote from the at least one conveying tray assembly to a second position wherein the at least one glycol coupler is coupled with the at least one conveying tray assemblies' integrated thermal reservoir; (j) at least one cleaning solution injection station mechanism operable to inject cleaning solution into at least one light bar cleaning assemblies' cleaning solution pressure bladder tank wherein the at least one cleaning solution injection station mechanism further comprises at least one cleaning solution coupler wherein the at least one cleaning solution injection station mechanism further comprises an actuating mechanism operable to move the at least one cleaning solution coupler from a first position wherein the at least one cleaning solution coupler is remote from the at least one light bar cleaning assembly to a second position wherein the at least one cleaning solution coupler is coupled with the at least one light bar cleaning assemblies' cleaning solution pressure bladder tank; (k) at least one LED light bar assembly the at least one LED light bar assembly further comprises at least one LED light bar track operable to support at least one light emitting source wherein the LED at least one light bar assembly further comprises at least one stepper motor operable to vary the offset distance relative to the Y-Axis of the prescribed conveying path of said at least one light emitting source from the at least one conveying tray assembly as it recirculates around the prescribed conveying path; (l) at least one light emitting source mounted on the at least one LED light bar assembly the at least one light emitting source operable to emit light wherein at least one LED light emitting source assembly further comprises at least one LED light bar stepper motor assembly operable to move the at least one light emitting source around the at least one LED light bar assembly's at least one LED light bar track's u-shape path relative to the Z-Axis and Y-Axis of the prescribed conveying path so to adjust at least one light emitting source's relative position around the plant canopy.

According to one aspect of the invention there is provided a recirculating plant growing mechanism comprising: (a) a conveying frame operable to support the various components of the recirculating plant conveying mechanism wherein the conveying frame further comprises a cladding of hermetic material operable to isolate the recirculating plant growing mechanism from ambient outside air; (b) a plurality of conveying tray assemblies each operable to support and constrain a plurality of rooting medias wherein each of the plurality of conveying tray assemblies comprises an integrated thermal reservoir operable to contain any suitable liquid at optimal root zone temperature and wherein each of the plurality of conveying tray assemblies further comprises a plurality of conveying tray locking mechanisms operable to lock each of the plurality of conveying tray assemblies to the conveyor drive assembly and operable to unlock each of the plurality of conveying tray assemblies from the conveyor drive assembly; (c) a conveyor drive assembly operable to support the plurality of conveying tray assemblies wherein the conveyor drive assembly further comprises a conveying chain drive motor/gearbox mechanism which provides rotational motive power operable to recirculate the plurality of conveying tray assemblies locked onto the conveyor drive assembly around the conveyor drive assemblies' prescribed conveying path; (d) at least one media holder drive assembly wherein the at least one media holder drive assembly further comprises an actuating mechanism operable when the at least one media holder drive assembly is aligned with one of the plurality of conveying tray assemblies' media holders position adjustment assembly to couple with and uncouple from the aligned conveying tray assemblies' media holders position adjustment assembly wherein the at least one media holder drive assembly further comprises an actuating mechanism operable when coupled to one of the plurality of conveying tray assemblies to vary the offset distance between each of the plurality of rooting medias constrained in the coupled conveying tray assembly; (e) a plurality of conveying tray de-coupler assemblies wherein each of the plurality of conveying tray de-coupler assemblies further comprises an actuating mechanism operable to lock at least one conveying tray assembly to the conveyor drive assembly and operable to unlock at least one conveying tray assembly from the conveyor drive assembly allowing the at least one conveying tray assembly to be repositioned on the conveyor drive assembly relative to the prescribed conveying path; (f) a plurality of exit gate assemblies wherein each of the plurality of exit gate assemblies further comprises an actuating mechanism operable to lock at least one conveying tray assembly to the conveyor drive assembly and operable to unlock at least one conveying tray assembly from the conveyor drive assembly and operable to open the conveyor drive assemblies' at least one exit gate and operable to close the conveyor drive assemblies' at least one exit gate; (g) a plurality of air lock transfer actuator assemblies operable to clamp and to clamp and to transport the at least one conveying tray assembly from the entrance of the recirculating plant conveying mechanism to the at least one exit gate assembly and operable to clamp and to clamp and to transport the at least one conveying tray assembly from the entrance of the recirculating plant conveying mechanism to said at least one exit gate assembly; (h) a plurality of air lock transfer assemblies each operable in conjunction with the said at least one conveying frame clad in a hermetic material to isolate the said recirculating plant conveying mechanism from ambient outside air wherein each of the plurality of air lock transfer assemblies further comprises an actuating mechanism operable to open and close at least one air lock door; (i) a plurality of watering station assemblies each operable to fertigate and/or water at least one rooting media of at least one plant constrained in at least one conveying tray assembly wherein each of the plurality of watering station assemblies further comprises at least one fertigation injection probe wherein each of the plurality of watering station assemblies further comprises an actuating mechanism operable to move its at least one fertigation injection probe from a first position wherein it's at least one fertigation injection probe is remote from the at least one conveying tray assembly to a second position wherein it's at least one fertigation injection probe is within the at least one conveying tray assemblies' rooting media; (j) a plurality of glycol injection station mechanisms each operable to inject glycol or any other suitable fluid into the at least one conveying tray assemblies' integrated thermal reservoir wherein each of the plurality of glycol injection station mechanisms further comprises at least one glycol coupler wherein each of the plurality of glycol injection station mechanisms further comprises an actuating mechanism operable to move its at least one glycol coupler from a first position wherein it's at least one glycol coupler is remote from the at least one conveying tray assembly to a second position wherein it's at least one glycol coupler is coupled with the at least one conveying tray assemblies' integrated thermal reservoir; (k) a plurality of cleaning solution injection station mechanisms each operable to inject cleaning solution into at least one light bar cleaning assemblies' cleaning solution pressure bladder tank wherein each of the plurality of cleaning solution injection station mechanisms further comprises at least one cleaning solution coupler wherein each of the plurality of cleaning solution injection station mechanisms further comprises an actuating mechanism operable to move the at least one cleaning solution coupler from a first position wherein it's at least one cleaning solution coupler is remote from the at least one light bar cleaning assembly to a second position wherein it's at least one cleaning solution coupler is coupled with the at least one light bar cleaning assemblies' cleaning solution pressure bladder tank; (l) a plurality of LED light bar assemblies wherein each of the plurality of LED light bar assemblies further comprises a plurality of LED light bar tracks each operable to support a plurality of light emitting sources wherein the LED at least one light bar assembly further comprises a plurality of stepper motors each operable to vary the offset distance relative to the Y-Axis of the prescribed conveying path of at least one light emitting source from the said at least one conveying tray assembly as it recirculates around the said prescribed conveying path; (m) a plurality of light emitting sources mounted on the at least one LED light bar assembly each of the plurality of light emitting source are operable to emit light wherein each of the plurality of light emitting sources further comprises a plurality LED light bar stepper motor assemblies operable to move at least one light emitting source around the at least one LED light bar assembly's at least one LED light bar track's u-shape path relative to the Z-Axis and Y-Axis of the prescribed conveying path so to adjust said at least one light emitting source's relative position around the plant canopy.

According to one aspect of the invention there is provided a recirculating plant growing mechanism comprising: (a) a conveying frame operable to support the various components of the recirculating plant conveying mechanism wherein the conveying frame is clad in a hermetic material operable to isolate the recirculating plant conveying mechanism from ambient outside air; (b) at least one conveying tray assembly operable to support and constrain at least one rooting media wherein the at least one conveying tray assembly comprises an integrated thermal reservoir operable to contain any suitable liquid at optimal root zone temperature and wherein the at least one conveying tray assembly comprises at least one conveying tray locking mechanism operable to lock the at least one conveying tray assembly to the conveyor drive assembly and operable to unlock the at least one conveying tray assembly from the conveyor drive assembly; (c) a conveyor drive assembly operable to support at least one conveying tray assembly wherein the conveyor drive assembly is further operable to support and recirculate at least one light bar cleaning assembly wherein the conveyor drive assembly further comprises at least one conveying chain drive motor/gearbox mechanism which provides rotational motive power operable to recirculate the at least one conveying tray assembly locked onto the conveyor drive assembly around the conveyor drive assemblies prescribed conveying path and operable to recirculate the at least one light bar cleaning assembly locked onto the conveyor drive assembly around the conveyor drive assemblies prescribed conveying path; (d) at least one conveying tray de-coupler assembly wherein the at least one conveying tray de-coupler assembly further comprises an actuating mechanism operable to lock at least one conveying tray assembly to the conveyor drive assembly and operable to unlock at least one conveying tray assembly from the conveyor drive assembly allowing the at least one conveying tray assembly to be repositioned on the conveyor drive assembly relative to the prescribed conveying path; (e) at least one exit gate assembly wherein the at least one exit gate assembly further comprises an actuating mechanism operable to lock at least one conveying tray assembly to the conveyor drive assembly and operable to unlock at least one conveying tray assembly from the conveyor drive assembly and operable to open the conveyor drive, at least one exit gate assembly is operable to close said at least one conveyor drive; (f) at least one an air lock transfer actuator assembly operable to clamp and to transport the at least one conveying tray assembly from the entrance of the recirculating plant conveying mechanism to the at least one exit gate assembly and operable to clamp and to transport the at least one conveying tray assembly from the entrance of the recirculating plant conveying mechanism to said at least one exit gate assembly; (g) at least one an air lock transfer assembly operable in conjunction with the said at least one conveying frame clad in a hermetic material to isolate the said recirculating plant conveying mechanism from ambient outside air wherein the at least one an air lock transfer assembly further comprises an actuating mechanism operable to open and close the at least one air lock door; (h) at least one watering station assembly operable to fertigate and/or water at least one rooting media of at least one plant constrained in at least one conveying tray assembly wherein the at least one watering station assembly further comprises at least one fertigation injection probe wherein the at least one watering station assembly further comprises an actuating mechanism operable to move the at least one fertigation injection probe from a first position wherein the at least one fertigation injection probe is remote from the at least one conveying tray assembly to a second position wherein the at least one fertigation injection probe is within the at least one conveying tray assemblies' rooting media; (i) at least one glycol injection station mechanism operable to inject glycol or any other suitable fluid into at least one conveying tray assemblies' integrated thermal reservoir wherein the at least one glycol injection station mechanism further comprises at least one glycol coupler wherein the at least one glycol injection station mechanism further comprises an actuating mechanism operable to move the at least one glycol coupler from a first position wherein the at least one glycol coupler is remote from the at least one conveying tray assembly to a second position wherein the at least one glycol coupler is coupled with the at least one conveying tray assemblies' integrated thermal reservoir; (j) at least one cleaning solution injection station mechanism operable to inject cleaning solution into at least one light bar cleaning assemblies' cleaning solution pressure bladder tank wherein the at least one cleaning solution injection station mechanism further comprises at least one cleaning solution coupler wherein the at least one cleaning solution injection station mechanism further comprises an actuating mechanism operable to move the at least one cleaning solution coupler from a first position wherein the at least one cleaning solution coupler is remote from the at least one light bar cleaning assembly to a second position wherein the at least one cleaning solution coupler is coupled with the at least one light bar cleaning assemblies' cleaning solution pressure bladder tank; (k) at least one LED light bar assembly the at least one LED light bar assembly further comprises at least one LED light bar track operable to support at least one light emitting source wherein the LED at least one light bar assembly further comprises at least one stepper motor operable to vary the offset distance relative to the Y-Axis of the prescribed conveying path of said at least one light emitting source from the at least one conveying tray assembly as it recirculates around the prescribed conveying path; (l) at least one light emitting source mounted on the at least one LED light bar assembly the at least one light emitting source operable to emit light wherein at least one LED light emitting source assembly further comprises at least one LED light bar stepper motor assembly operable to move the at least one light emitting source around the at least one LED light bar assembly's at least one LED light bar track's u-shape path relative to the Z-Axis and Y-Axis of the prescribed conveying path so to adjust at least one light emitting source's relative position around the plant canopy; (n) at least one light bar cleaning assembly operable to clean at least one light emitting source.

According to one aspect of the invention there is provided a recirculating plant growing mechanism comprising: (a) a conveying frame operable to support the various components of the recirculating plant conveying mechanism wherein the conveying frame is clad in a hermetic material operable to isolate the recirculating plant conveying mechanism from ambient outside air; (b) a plurality of conveying tray assemblies each operable to support and constrain a plurality of rooting medias wherein each of the plurality of conveying tray assemblies comprises an integrated thermal reservoir operable to contain any suitable liquid at optimal root zone temperature and wherein each of the plurality of conveying tray assemblies further comprises a plurality of conveying tray locking mechanisms operable to lock each of the plurality of conveying tray assemblies to the conveyor drive assembly and operable to unlock each of the plurality of conveying tray assemblies from the conveyor drive assembly and wherein each of the plurality of conveying tray assemblies further comprises a media holders position adjustment assembly which is operable to when coupled with the at least one media holder drive assembly to adjust the offset distance between the plurality of rooting medias; (c) a conveyor drive assembly operable to support at least one conveying tray assembly wherein the conveyor drive assembly is further operable to support and recirculate at least one light bar cleaning assembly wherein the conveyor drive assembly further comprises at least one conveying chain drive motor/gearbox mechanism which provides rotational motive power operable to recirculate the at least one conveying tray assembly locked onto the conveyor drive assembly around the conveyor drive assemblies prescribed conveying path and operable to recirculate the at least one light bar cleaning assembly locked onto the conveyor drive assembly around the conveyor drive assemblies prescribed conveying path; (d) at least one media holder drive assembly wherein the at least one media holder drive assembly further comprises an actuating mechanism operable when the at least one media holder drive assembly is aligned with one of the plurality of conveying tray assemblies' media holders position adjustment assembly to couple with and uncouple from the aligned conveying tray assemblies' media holders position adjustment assembly wherein the at least one media holder drive assembly further comprises an actuating mechanism operable when coupled to one of the plurality of conveying tray assemblies to vary the offset distance between each of the plurality of rooting medias constrained in the coupled conveying tray assembly; (e) a plurality of conveying tray de-coupler assemblies wherein each of the plurality of conveying tray dc-coupler assemblies further comprises an actuating mechanism operable to lock at least one conveying tray assembly to the conveyor drive assembly and operable to unlock at least one conveying tray assembly from the conveyor drive assembly allowing the at least one conveying tray assembly to be repositioned on the conveyor drive assembly relative to the prescribed conveying path; (f) a plurality of exit gate assemblies wherein each of the plurality of exit gate assemblies further comprises an actuating mechanism operable to lock at least one conveying tray assembly to the conveyor drive assembly and operable to unlock at least one conveying tray assembly from the conveyor drive assembly and operable to open the conveyor drive assemblies' at least one exit gate and operable to close the conveyor drive assemblies' at least one exit gate; (g) a plurality of air lock transfer actuator assemblies operable to clamp and to transport the at least one conveying tray assembly from the entrance of the recirculating plant conveying mechanism to the at least one exit gate assembly and operable to clamp and to transport the at least one conveying tray assembly from the entrance of the recirculating plant conveying mechanism to said at least one exit gate assembly; (h) a plurality of air lock transfer assemblies each operable in conjunction with the said at least one conveying frame clad in a hermetic material to isolate the said recirculating plant conveying mechanism from ambient outside air wherein each of the plurality of air lock transfer assemblies further comprises a plurality of actuating mechanisms each operable to open and close at least one air lock door; (i) a plurality of watering station assemblies each operable to fertigate and/or water at least one rooting media of a plurality of plants constrained in at least one conveying tray assembly wherein each of the plurality of watering station assemblies further comprises a plurality of fertigation injection probes mounted on probe sliders wherein each of the plurality of watering station assemblies further comprises an actuating mechanism operable to move its plurality of fertigation injection probes from a first position wherein its plurality of fertigation injection probes are remote from the at least one conveying tray assembly to a second position wherein its plurality of fertigation injection probes are within a plurality of conveying tray assemblies' rooting medias wherein each of the plurality of watering station assemblies further comprises at least one probe slider position adjustment assembly operable to adjust the offset distance between the plurality of fertigation injection probes so that the offset distance matches the offset distance of each plurality of rooting medias in each of the conveying tray assemblies; (j) a plurality of glycol injection station mechanisms each operable to inject glycol or any other suitable fluid into the at least one conveying tray assemblies' integrated thermal reservoir wherein each of the plurality of glycol injection station mechanisms further comprises at least one glycol coupler wherein each of the plurality of glycol injection station mechanisms further comprises an actuating mechanism operable to move its at least one glycol coupler from a first position wherein it's at least one glycol coupler is remote from the at least one conveying tray assembly to a second position wherein it's at least one glycol coupler is coupled with the at least one conveying tray assemblies' integrated thermal reservoir; (k) a plurality of cleaning solution injection station mechanisms each operable to inject cleaning solution into at least one light bar cleaning assemblies' cleaning solution pressure bladder tank wherein each of the plurality of cleaning solution injection station mechanisms further comprises at least one cleaning solution coupler wherein each of the plurality of cleaning solution injection station mechanisms further comprises an actuating mechanism operable to move the at least one cleaning solution coupler from a first position wherein it's at least one cleaning solution coupler is remote from the at least one light bar cleaning assembly to a second position wherein it's at least one cleaning solution coupler is coupled with the at least one light bar cleaning assemblies' cleaning solution pressure bladder tank; (l) a plurality of LED light bar assemblies wherein each of the plurality of LED light bar assemblies further comprises a plurality of LED light bar tracks each operable to support a plurality of light emitting sources wherein the LED at least one light bar assembly further comprises a plurality of stepper motors each operable to vary the offset distance relative to the Y-Axis of the prescribed conveying path of at least one light emitting source from the said at least one conveying tray assembly as it recirculates around the said prescribed conveying path; (m) a plurality of light emitting sources mounted on the at least one LED light bar assembly each of the plurality of light emitting source are operable to emit light wherein each of the plurality of light emitting sources further comprises a plurality LED light bar stepper motor assemblies operable to move at least one light emitting source around the at least one LED light bar assembly's at least one LED light bar track's u-shape path relative to the Z-Axis and Y-Axis of the prescribed conveying path so to adjust said at least one light emitting source's relative position around the plant canopy; (n) at least one light bar cleaning assembly operable to clean a plurality of light emitting sources.

According to one aspect of the invention there is provided a method of growing a plant comprising: (a) recirculating at least one conveying tray assembly containing at least one plant around a conveyor drive assemblies' prescribed conveying path; (b) adjusting the distance between the at least one conveying tray assembly and a light emitting source by moving the light emitting source to different positions around the plant's canopy as the plant grows; (c) fertigating the plant's rooting media, and sensing the conditions present in the plant's rooting media; (d) maintaining the optimal temperature of the plant's root zone;

According to one aspect of the invention there is provided a method of growing a plurality of plants comprising: (a) recirculating a plurality of conveying tray assemblies each containing a plurality of plants around a conveyor drive assemblies' prescribed conveying path; (b) adjusting the offset distance between the plurality of plants constrained in each conveying tray assembly in the plurality of conveying tray assemblies as the plants grow; (c) adjusting the offset distance between consecutive conveying trays in the recirculating plurality of conveying tray assemblies as the plants grow; (d) adjusting the distance between the plurality of conveying tray assemblies and a plurality of light emitting sources by moving independently of each other the light emitting sources to different positions around the plant's canopy as the plant grows; (e) individually fertigating each of the plurality of plants rooting medias, and sensing the conditions present in the each of the plurality of plants rooting medias; (d) maintaining the optimal temperature in each of the plurality of plants root zones;

### BRIEF DESCRIPTION OF THE DRAWINGS

In figures which illustrate by way of example only embodiments:

FIG. 1 is a top perspective view of a recirculating plant growing mechanism.

FIG. 2 is a side elevation view of the recirculating plant growing mechanism of FIG. 1 with the plurality of conveying tray assemblies are depicted at their maximum offset positions relative to the X-Axis of the recirculating plant growing mechanism, the media containment covers are not shown; the LED light bar assemblies are depicted at their maximum offset distance from the conveying tray assemblies relative to the Y-Axis of the recirculating plant growing mechanism; the cleaning tray assembly is shown locked onto the two of conveying chains which are a component part of the conveyor drive assembly; the watering station assembly is shown in its home position; and the air lock assembly is shown with a conveying tray assembly inside it locked to the tray clamps of the airlock transfer actuator assembly.

FIG. 3 is a rear elevation view of the recirculating plant growing mechanism of FIG. 1 with the LED light bar assemblies depicted at their maximum distance from the conveying tray assemblies relative to the X-Axis of the recirculating plant growing mechanism;

FIG. 4 is a top perspective view of the LED light bar cleaning tray assembly. The cleaning tray mount is shown in the fully retracted position.

FIG. 5 is a rear elevation view of the LED light bar cleaning tray assembly. The cleaning tray mount is shown in the fully retracted position.

FIG. 6 is a side elevation view of the LED light bar cleaning tray assembly.

FIG. 7 is a top perspective view of a conveying tray assembly the media holders are shown in their maximum offset positions relative to the Z-Axis of the recirculating plant growing mechanism.

FIG. 8 is a bottom perspective view of a conveying tray assembly the media holders are shown in their maximum offset positions relative to the Z-Axis of the recirculating plant growing mechanism.

FIG. 9 is a front elevation view of a conveying tray assembly. the media holders are shown in their maximum offset positions relative to the Z-Axis of the recirculating plant growing mechanism.

FIG. 10 is a bottom perspective view of the conveying chain drive assembly; the LED light bar cleaning tray assembly is also shown locked onto the chain conveyor.

FIG. 11 is a bottom perspective view of the conveying chain drive assembly; the watering station assembly is shown in its home position; a conveying tray assembly is also shown directly over the watering station assembly relative to the X-Axis of the recirculating plant growing mechanism and is positioned, if the watering station assembly is elevated to the engagement height, to measure root zone variables and dispense liquid nutrients and/or water into rooting media, a conveying tray assembly is also shown in the clamped in air lock transfer assemblies tray clamp slides ready to be removed from the conveyor drive assemblies' conveyor chains, the exit gate assembly is shown with the exit gate opened, the exit gate tray de-coupler unlocking plate is shown in the fully extended position pushing against the tray chain lock, the tray chain lock is shown in the unlocked position.

FIG. 12 is a top perspective view of the watering station assembly the watering station plinth is shown in its home position; the probe sliders are shown in their maximum offset positions relative to the Z-Axis of the recirculating plant growing mechanism; and the glycol couplers are shown in their home positions.

FIG. 13 is a front elevation view of the watering station assembly the watering station plinth is shown in its home position; the probe sliders are shown in their maximum offset positions relative to the Z-Axis of the recirculating plant growing mechanism; and the glycol couplers are shown in their home positions.

FIG. 14 is a side elevation view of the watering station assembly the watering station plinth is shown in its home position.

FIG. 15 is a top perspective view of a LED light bar assembly the LED light track assemblies are depicted at their maximum distance from the conveying tray assemblies relative to the Y-Axis of the recirculating plant growing mechanism; the LED light bars are depicted at random positions around the LED light tracks.

FIG. 16 is a front elevation view of a LED light bar height adjustment assembly the LED light track assemblies are depicted at their maximum distance from the conveying tray assemblies relative to the Y-Axis of the recirculating plant growing mechanism; the LED light bars are depicted at random positions around the LED light tracks.

FIG. 17 is a top perspective view of a LED light bar track assembly; the attached LED light bar stepper motor assemblies are depicted at random positions around the LED light track.

FIG. 18 is a cut out front bottom perspective section view depicting the inner components of the LED light bar track assembly the LED light bar stepper motor pinion gears are shown meshed with the LED light bar stepper motor rack; the attached LED light bar stepper motor assemblies are depicted at random positions around the LED light track.

FIG. 19 is a side elevation view of a LED light bar stepper motor assembly.

FIG. 20 is a top perspective view of a conveying tray assembly de-coupler, the conveying tray assembly de-coupler unlocking plate is shown in the unlock position relative to the Z-Axis of the recirculating plant growing mechanism.

FIG. 21 is a front perspective view of a conveying tray assembly media holder drive coupling mechanism; the conveying tray assembly media holder drive stepper motor and actuator assemblies are shown in the coupled position relative to the Z-Axis of the recirculating plant growing mechanism.

FIG. 22 is a side perspective view of an exit gate assembly and the modified 180 degree conveying chain guide rail, the exit gate and the exit gate tray de-coupler unlocking plate are shown in the unlock position relative to the Z-Axis of the recirculating plant growing mechanism.

FIG. 23 is a top perspective view of the air lock transfer assembly both the inner and outer doors are shown in their fully open positions.

FIG. 24 is a top perspective view of an air lock transfer actuator assembly with a tray clamp attached to the air lock transfer actuator's linear slider.

FIG. 25 is a front perspective view of a tray clamping mechanism the tray clamp actuator slide plate is depicted in the clamped position.

FIG. 26 is a top perspective view of the air lock transfer assembly both the inner and outer doors are shown in their fully open positions.

FIG. 27 is a bottom perspective view of the conveyor drive assembly.

FIG. 28 is a bottom perspective view of a media holders position adjustment assembly the media holders are shown in their maximum offset positions relative to the Z-Axis of the recirculating plant growing mechanism.

FIG. 29 is a bottom perspective view of a media holder assembly.

FIG. 30 is a front perspective view of the watering station assembly two conveying tray assemblies are shown locked to the conveyor chains above and below and aligned with the watering station relative to the Z-Axis of the recirculating plant growing mechanism. The watering station is shown in its home position relative to the Y-Axis of the recirculating plant growing mechanism.

FIG. 31 is a front elevation view of the watering station assembly two conveying tray assemblies are shown locked to the conveyor chains above and below and aligned with the watering station relative to the Z-Axis of the recirculating plant growing mechanism. The watering station is shown in its home position relative to the Y-Axis of the recirculating plant growing mechanism. The “Distance D” indicates the closest distance between the inner faces of the conveyor chains relative to the Z-Axis of the recirculating plant growing mechanism.

FIG. 32 is a bottom perspective view of the probe sliders position adjustment assembly the probe sliders are shown in their maximum offset positions relative to the Z-Axis of the recirculating plant growing

FIG. 33 is a bottom perspective view of a probe slider assembly.

FIG. 34 is a top perspective view of a watering station elevating actuator assembly the assembly is shown in its maximum extended position.

FIG. 35 is a top perspective view of a glycol coupling actuator assembly the assembly is shown in its maximum extended position.

FIG. 36 is a side perspective view of a conveying tray assembly and a LED light bar cleaning tray assembly locked onto one of the conveying chains. The cleaning tray mount is shown in the fully retracted position.

FIG. 37 is a top perspective view of a tray chain lock component.

FIG. 38 is a bottom perspective view of the LED light bar cleaning tray assembly. The cleaning tray mount is shown in the fully retracted position.

FIG. 39 is a front elevation view of a LED light bar height adjustment assembly.

FIG. 40 is perspective view of a LED light bar track slider.

FIG. 41 is a top perspective view of the conveying frame.

FIG. 42 is a top perspective view of an exit gate assembly, the exit gate and the exit gate tray de-coupler unlocking plate are shown in the exit gates unlock position.

FIG. 43 is a side perspective view of a modified 180 degree conveying chain guide rail.

FIG. 44 is a top perspective view of a recirculating plant growing mechanism.

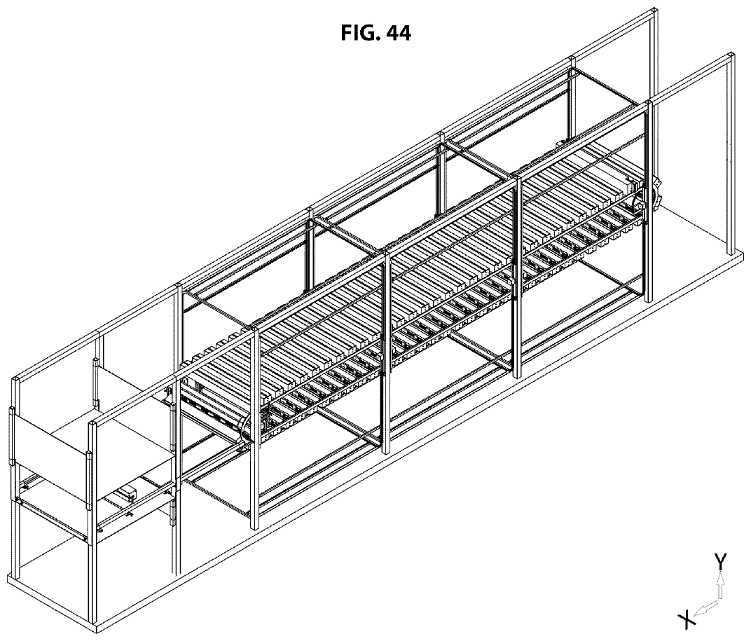

FIG. 45 is a front elevation of a conceptual multi-tiered prescribed conveying path.

FIG. 46 is a top perspective view of a clad recirculating plant growing mechanism.

FIG. 47 is a top elevation view of an example of a best mode overview of a cultivation facility, installed in the Cultivation Space is a plurality of recirculating plant growing mechanisms with air lock transfer assemblies operable to transfer conveying tray assemblies to and from a facility wide common conveying system operable to transfer conveying tray assemblies to and from a common work space for infrequent cultivation inputs IFCI, within which is shown a hardware sterilization area with a sterilization machine installed, and a potting, pruning, topping, and harvesting area with four workstations installed.

FIG. 48 is a side perspective view of a cartesian coordinate system referenced in this applications text body from time to time for clarity and to help orient the reader, it is also referenced in the bottom right hand corner of each Figure (FIG. xx, FIG. xx). The vectors shown here in three dimensional space are the three mutually perpendicular axes called x, y, and z, also shown are the three two dimensional planes the can be derived thereof, used for clarity and to help orient the reader

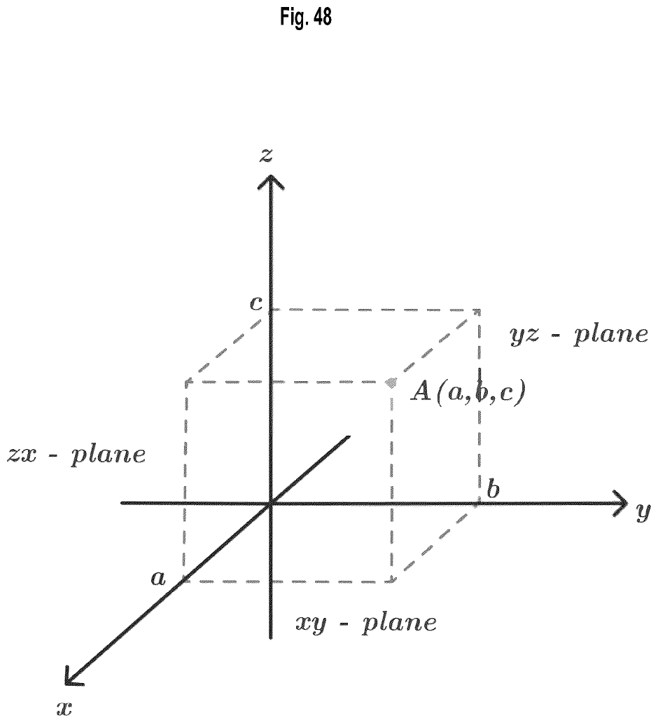

### DETAILED DESCRIPTION

TABLE A

| Reference | |
|---|---|
| Element No. | Reference Element Description |
| 1 | Conveyor Frame |
| 2 | Conveying Tray Assembly |
| 3 | Conveying Chain Drive Gear |
| 4 | Conveying Chain Drive Shaft |
| 5 | Conveying Chain Motor/Gearbox |
| 6 | LED Light Bar |
| 7 | LED Light Bar Track Assembly |
| 8 | LED Light Bar Track Stepper Motor |
| 9 | Conveying Tray De-Coupler Assembly |
| 10 | Conveying Tray Media Holders Drive Stepper |
| | Motor Assembly |
| 11 | Conveying Tray Media Holders Drive Stepper |
| | Motor Engagement Actuator Assembly |
| 12 | Watering Station Assembly |
| 13 | Tray Clamping Actuator Assembly |
| 14 | Air Lock Transfer Actuator |
| 15 | Media Holder |
| 16 | Inner Top Air Lock Door Actuator |
| 17 | Inner Top Air Lock Door |
| 18 | Inner Bottom Air Lock Door Actuator |
| 19 | Inner Bottom Air Lock Door |
| 20 | Tray Clamp Carriage |
| 21 | LED Light Bar Cleaning Tray Assembly |
| 22 | Outer Air Lock Door Actuator |
| 23 | Outer Air Lock Door |
| 24 | 180o Conveying Chain Guide Rail |
| 25 | Horizontal Conveying Chain Guide Rail |
| 26 | Conveying Chain |
| 27 | Conveying Tray Exit Gate Actuator |
| 28 | Conveying Tray Exit Gate |
| 29 | Spray Bar |
| 30 | Top Airlock Panel |
| 31 | Bottom Airlock Panel |
| 32 | Conveying Chain Idler Gear |
| 33 | Side Air Lock Panel |
| 34 | LED Light Bar Cleaning Sponge |
| 35 | LED Light Bar Cleaning Squeegee |
| 36 | LED Light Bar Track Slider |
| 37 | Inner Top Air Lock Door Slider |
| 38 | Inner Bottom Air Lock Door Slider |
| 39 | Outer Air Lock Door Slider |
| 40 | Watering Station Plinth |
| 41 | Probe Slider Assembly #1 |
| 42 | Probe Slider Assembly #2 |
| 43 | Probe Slider Assembly #3 |
| 44 | Probe Slider Assembly #4 |
| 45 | Probe Slider Assembly #5 |
| 46 | Probe Slider Assembly #6 |
| 47 | Probe Sliders Drive Stepper Motor |
| 48 | Probe Sliders Drive Shaft |
| 49 | Watering Station Elevating Actuator Assembly |
| 50 | Fertigation Injection Probe |
| 51 | Temperature Probe |
| 52 | Water Content/Electrical Conductivity Probes |
| 53 | Inlet Glycol Coupling Actuator Assembly |
| 54 | Outlet Glycol Coupling Actuator Assembly |
| 55 | Inlet Glycol Coupler |
| 56 | Outlet Glycol Coupler |
| 57 | Fertigation Injection Probe Water Inlet Port |
| 58 | Fertigation Injection Probe Nutrient Mix Inlet Port |
| 59 | Glycol Inlet Port |
| 60 | Glycol Outlet Port |
| 61 | Probe Slider Lead Screw gear |
| 62 | Probe Sliders Drive Shaft Gear |
| 63 | Probe Sliders Drive Stepper Motor Gear |
| 64 | Probe Slider Lead Screw |
| 65 | Double Skin Tray |
| 66 | Media Containment Cover |
| 67 | Guide Rail Bearing |
| 68 | Tray Clamp Pin |
| 69 | Media Containment Cover Locking Pin |
| 70 | Tray Chain Lock |
| 71 | Tray Chain Locking Spring |
| 72 | Tray Chain Lock Slider |
| 73 | Inlet Glycol Coupler with Non Return Valve |
| 74 | Outlet Glycol Coupler with Non Return Valve |
| 75 | Media Holders Splined Drive Shaft |
| 76 | Media Holders Splined Drive Coupling Gear |
| 77 | Media Holder Lead Screw |
| 78 | Media Holder Assembly #1 |
| 79 | Media Holder Assembly #2 |
| 80 | Media Holder Assembly #3 |
| 81 | Media Holder Assembly #4 |
| 82 | Media Holder Assembly #5 |
| 83 | Media Holder Assembly #6 |
| 84 | LED Light Bar Track Rack |
| 85 | LED Light Bar Track Stepper Motor Pinion Gear |
| 86 | LED Light Bar Stepper Motor Rack |
| 87 | LED Light Bar Mount |
| 88 | LED Light Bar Stepper Motor Pinion Gear |
| 89 | LED Light Bar Stepper Motor Support Track |
| 90 | LED Light Bar Stepper Motor Support Bearing |
| 91 | LED Light Bar Stepper Track Following Bearing |
| 92 | LED Light Bar Stepper Motor Mount |
| 93 | LED Light Bar Stepper Motor Drive Shaft Spacer |
| 94 | 2 Inch Actuator Body |
| 95 | 2 Inch Actuator Shaft |
| 96 | Tray De-Coupler Unlocking Plate |
| 97 | Tray De-Coupler Mount |
| 98 | Proximity Switch |
| 99 | Exit Gate Tray De-Coupler Unlocking Plate |
| 100 | Exit Gate Tray De-Coupler Mount |
| 101 | Exit Gate Lever Arm |
| 102 | Exit Gate Lever Arm Fulcrum Pin |
| 103 | Exit Gate Lever Arm Pin |
| 104 | Exit Gate Slider Plate |
| 105 | Conveying Tray Media Holder Drive and Coupler |
| | Slide Plate |
| 106 | 2″ Actuator Sliding Plate Bearing |
| 107 | Conveying Tray Media Holder Drive and Coupler |
| | Proximity Switch Bracket |
| 108 | Tray Clamping Actuator Slide Plate |
| 109 | Recirculating Plant Growing Mechanism |
| 110 | Cleaning Tray Mount |
| 111 | Cleaning Tray Mount Spring |
| 112 | Cleaning Tray Mount Slider |
| 113 | Cleaning Tray Mount Upright Dodger |
| 114 | Cleaning Tray Cleaning Solution Pressure Bladder Tank |
| 115 | Cleaning Tray Mount Cleaning Solution Delivery Tube |
| 116 | Media Holders Drive Gear |
| 117 | Media Holders Lead Screw Gear |
| 118 | Cleaning Solution Inlet Coupler |
| 119 | Cleaning Solution Inlet Port |
| 120 | Cleaning Solution Outlet Coupler |
| 121 | Cleaning Solution Outlet Port |
| 122 | LED Light Bar Stepper Motor |
| 123 | LED Light Bar Assembly |
| 124 | Media Holder Drive Assembly |
| 125 | Exit Gate Assembly |
| 126 | Air Lock Transfer Assembly |
| 127 | Air Lock Transfer Actuator Assembly |
| 128 | Conveyor Drive Assembly |
| 129 | Media Holders Position Adjustment Assembly |
| 130 | Media Holder Assembly |
| 131 | Media Holder Threaded Lead Screw Penetration |
| 132 | Media Holder Drive Shaft Penetration |
| 133 | Media Holder Fertigation Injection Probe or Sensor |
| | Penetration |
| 134 | Media Holder Drive Housing |
| 135 | Media Holder Drive Housing Gear Slot |
| 136 | Conveying Tray Media Holders Drive Stepper Motor |
| 137 | Conveying Tray Media Holders Drive Gear |
| 138 | Watering Station Assembly Connecting Member |
| 139 | Probe Sliders Position Adjustment Assembly |
| 140 | Probe Slider Assembly |
| 141 | Probe Slider |
| 142 | Watering Station Elevating Actuator Body |
| 143 | Watering Station Elevating Actuator Shaft |
| 144 | Watering Station Elevating Actuator Mounting Plate |
| 145 | Glycol Coupling Actuator Body |
| 146 | Glycol Coupling Actuator Shaft |
| 147 | Glycol Coupler |
| 148 | Glycol Coupling Actuator Assembly |
| 149 | Cleaning Solution Coupler |
| 150 | Probe Slider Threaded Lead Screw Penetration |
| 151 | Probe Slider Drive Shaft Penetration |
| 152 | Probe Slider Fertigation Injection Probe or Sensor |
| | Penetration |
| 153 | Probe Slider Drive Housing |
| 154 | Probe Slider Drive Housing Gear Slot |
| 155 | Conveying Chain Locking Spigot Pin |
| 156 | Tray Chain Lock Locking Spigot Pin Penetration |
| 157 | Tray Lock Slider Penetration |
| 158 | Inlet Cleaning Solution Coupler with Non Return Valve |
| 159 | Outlet Cleaning Solution Coupler with Non Return Valve |
| 160 | Cleaning Tray Mount Stop |
| 161 | Cleaning Tray Mechanically Operable Valve |
| 162 | LED Light Bar Stepper Motor Assembly |
| 163 | LED Light Bar Track Slider Light Bar Track Rack Slot |
| 164 | LED Light Bar Track Slider Light Bar Track Stepper Motor |
| | Threaded Penetration |
| 165 | LED Light Height Adjustment Assembly |
| 166 | LED Light Bar Track Slot |
| 167 | LED Light Bar Track |
| 168 | Exit Gate Opening for Conveying Tray Assembly Removal |
| 169 | Exit Gate Opening for Conveying Tray Exit Gate |
| 170 | Exit Gate Assembly Mounting Penetrations |
| 171 | Tray Clamp Pin Penetration |
| 172 | Air Lock Transfer Actuator Assembly Mounts 1 |
| 173 | Air Lock Transfer Actuator Assembly Mounts 2 |
| 174 | Hermetic Cladding |
| 175 | Cultivation Space |
| 176 | Common Work Space for Infrequent Cultivation Inputs |
| 177 | Potting, Pruning, Topping, and Harvesting Area |
| 178 | Hardware Sterilization Area |
| 179 | Common Conveying System |
| 180 | Work Station |
| 181 | Sterilization Machine |

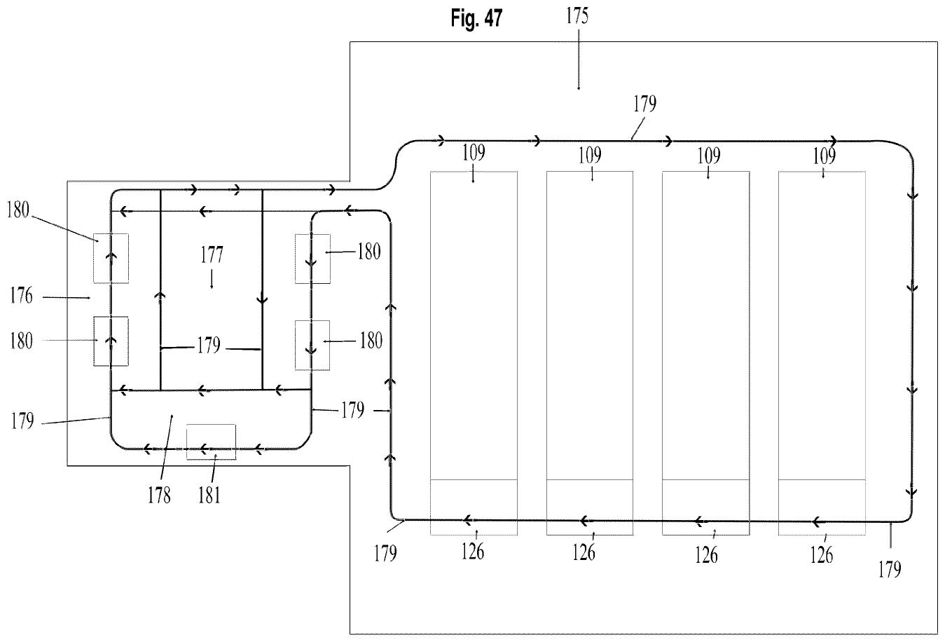

With reference to FIG. 47 this is an example of a best mode overview of a cultivation facility, installed in the Cultivation Space is a plurality of recirculating plant growing mechanisms 109 with air lock transfer assemblies 126 operable to transfer conveying tray assemblies to and from a facility wide common conveying system 179 operable to transfer conveying tray assemblies 2 to and from a common work space for infrequent cultivation inputs IFCI 176, within which is shown a hardware sterilization area 178 with a sterilization machine 181 installed, and a potting, pruning, topping, and harvesting area 177 with four workstations installed 180.

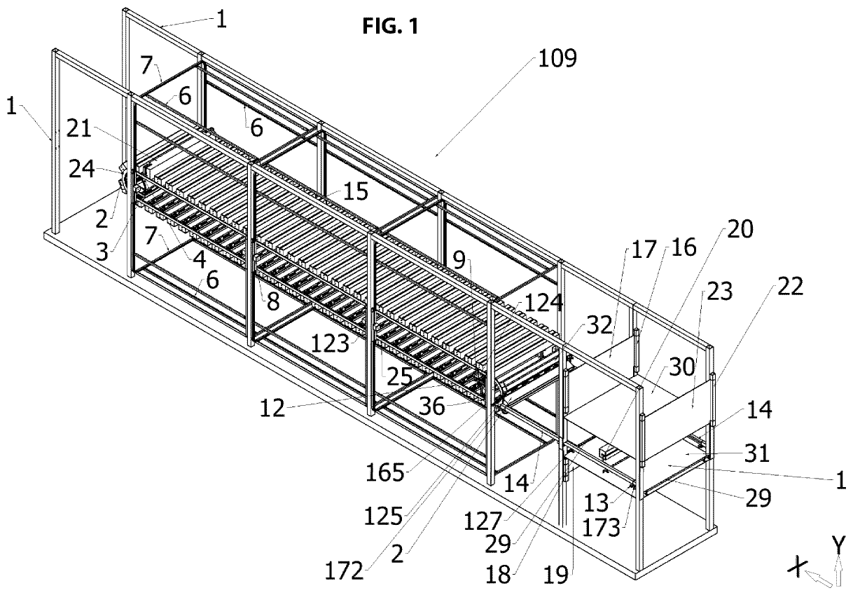

With reference initially to FIGS. 1, 2 and 3, a recirculating plant growing mechanism generally designated 109 which includes a conveyor frame generally designated 1 and may include the following parts and assemblies:
at least one conveying frame generally designated 1;
at least one conveying tray assembly generally designated 2;
at least one conveyor drive assembly generally designated 128;
at least one a media holder drive assembly generally designated 124;
at least one conveying tray de-coupler assembly generally designated 9;
at least one exit gate assembly generally designated 125;
at least one an air lock transfer actuator assembly generally designated 127;
at least one an air lock transfer assembly generally designated 126,
at least one a watering station assembly generally designated 12, which may further comprise at least one glycol injection mechanism and/or at least one cleaning solution injection station mechanism;
at least one light bar cleaning assembly generally designated 21;
at least one LED light bar assembly generally designated 123;
at least one LED light bar generally designated 6.

Various components of the plant growing mechanism 109, including all motors, drives and actuators described herein, may be controlled by any suitably programmable microprocessor-based device herein referred to as a Programmable Logic Controller (PLC) such as a Control Logix PLC made by Rockwell Automation. The PLC may also receive signals from various sensors of the recirculating plant growing mechanism 109, as referenced herein.

With reference to FIG. 47 this is an example of a best mode overview of a cultivation facility, installed in the Cultivation Space is a plurality of recirculating plant growing mechanisms 109 with air lock transfer assemblies 126 operable to transfer conveying tray assemblies to and from a facility wide common conveying system 179 operable to transfer conveying tray assemblies 2 to and from a common work space for infrequent cultivation inputs IFCI 176, within which is shown a hardware sterilization area 178 with a sterilization machine 181 installed, and a potting, pruning, topping, and harvesting area 177 with four workstations installed 180.

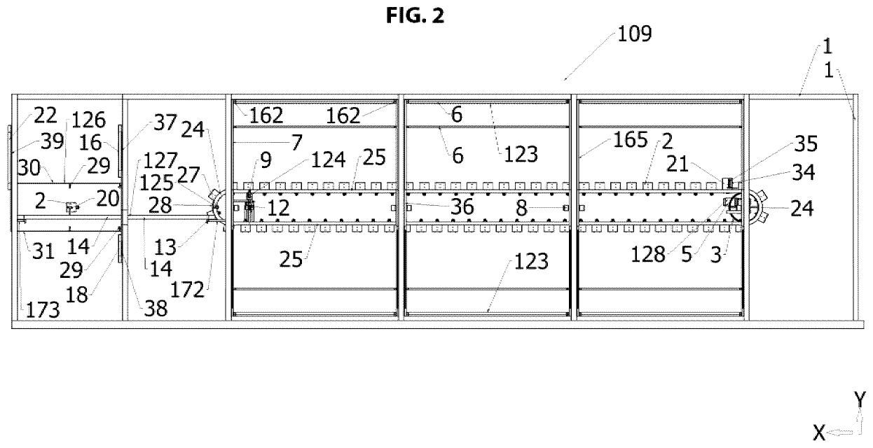

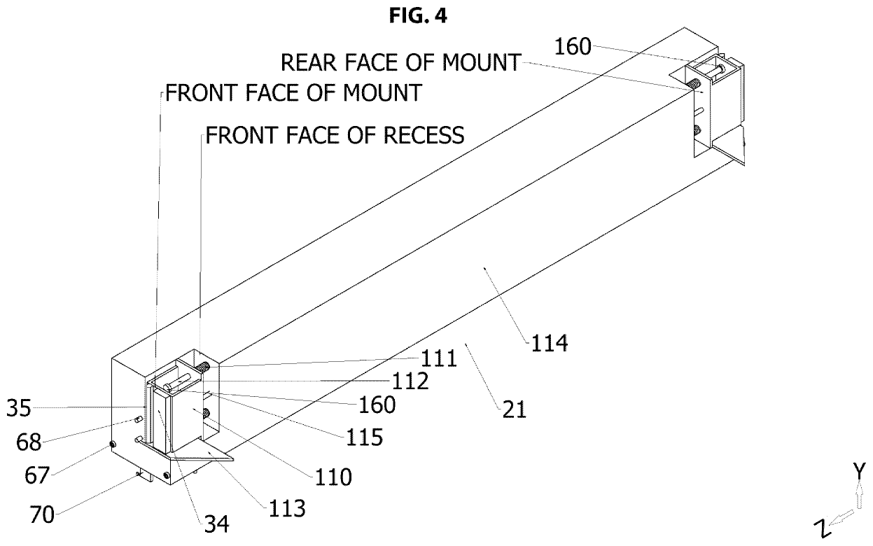

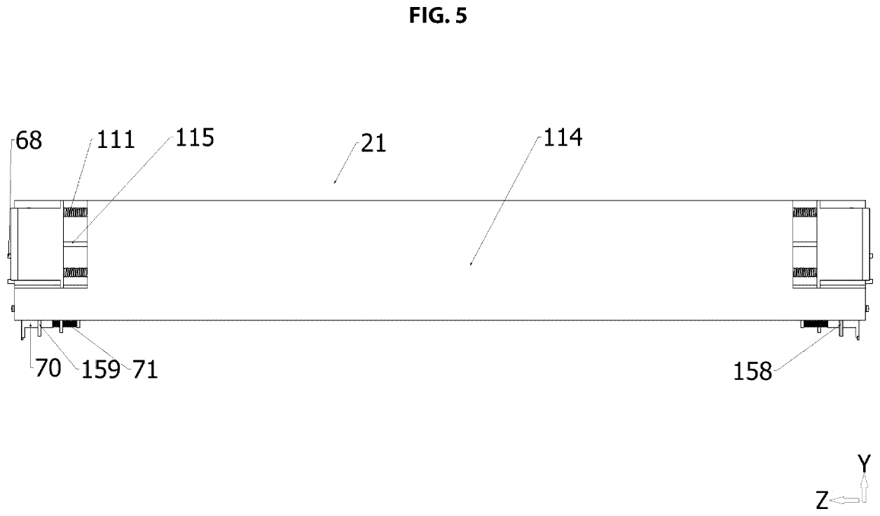

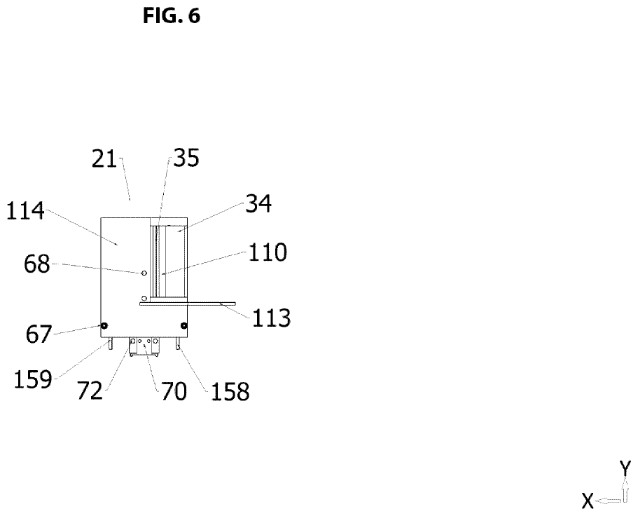

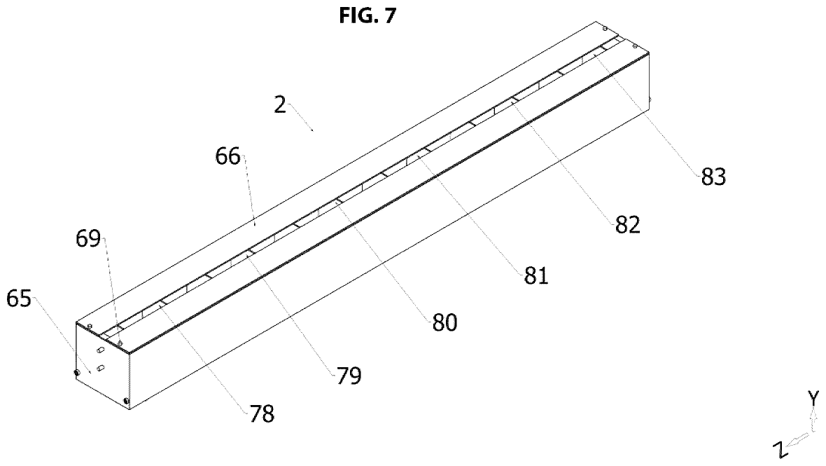

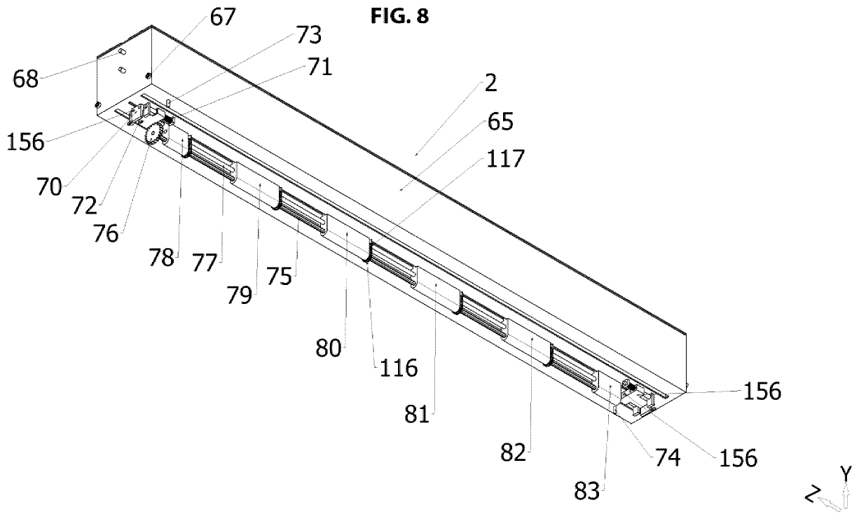

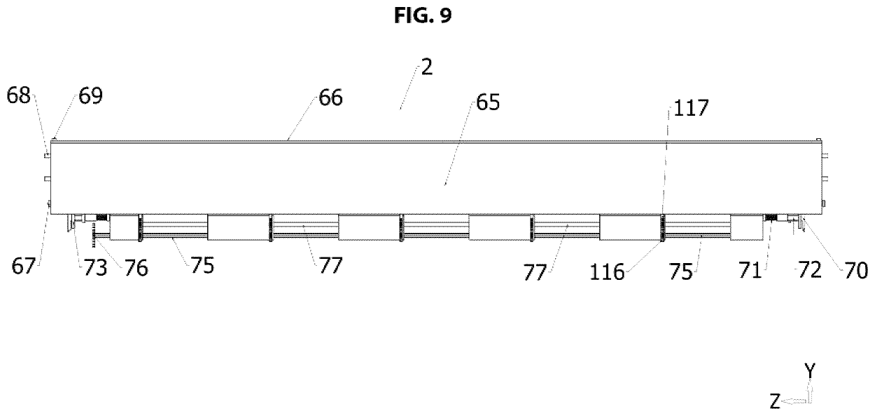

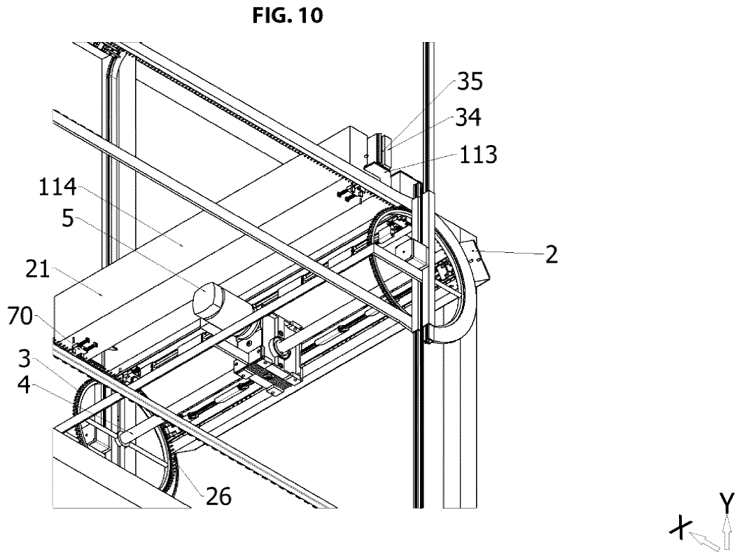

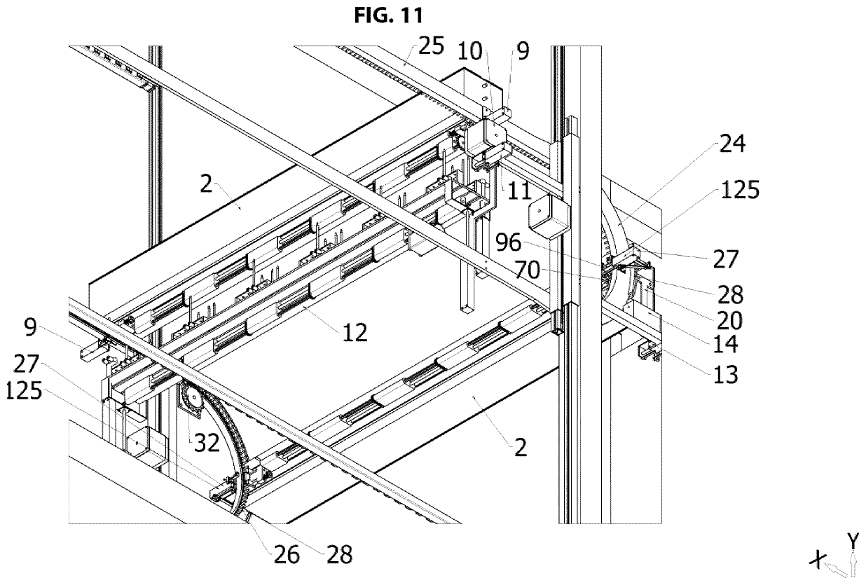

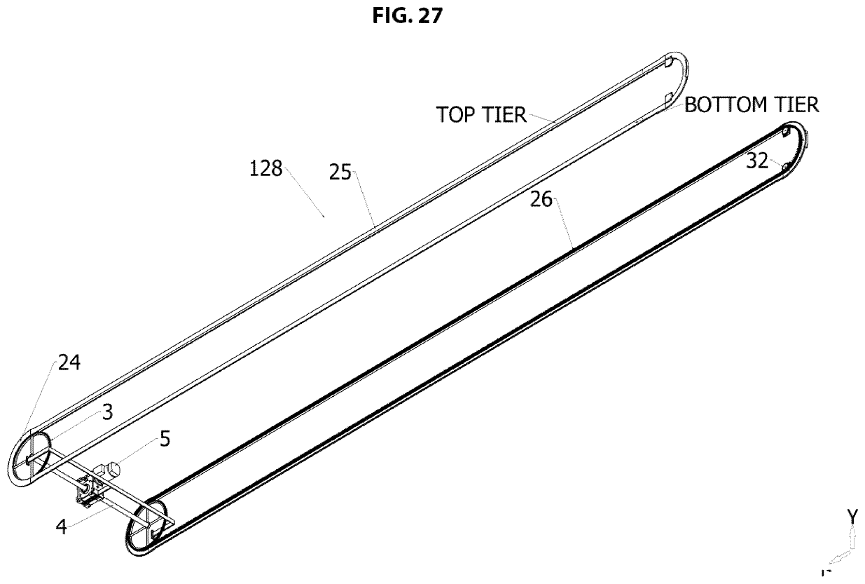

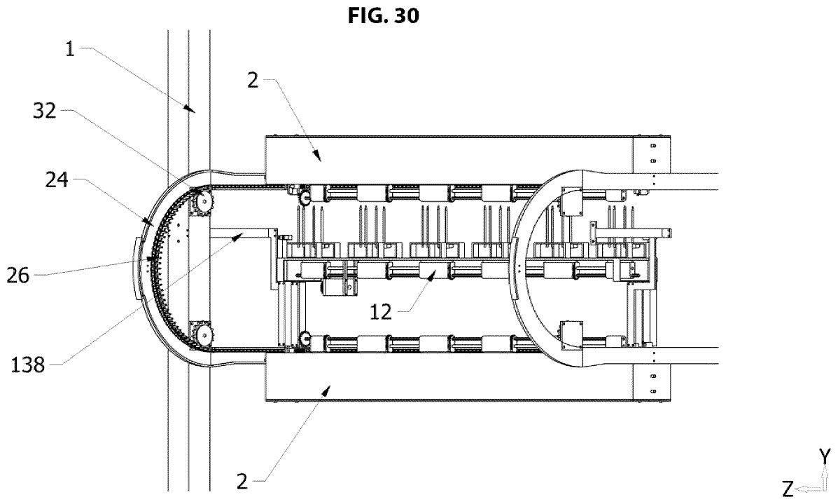

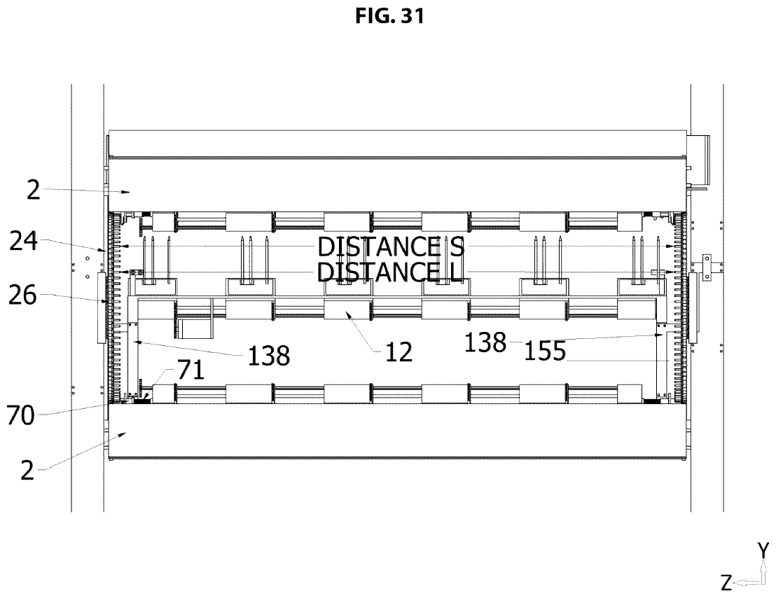

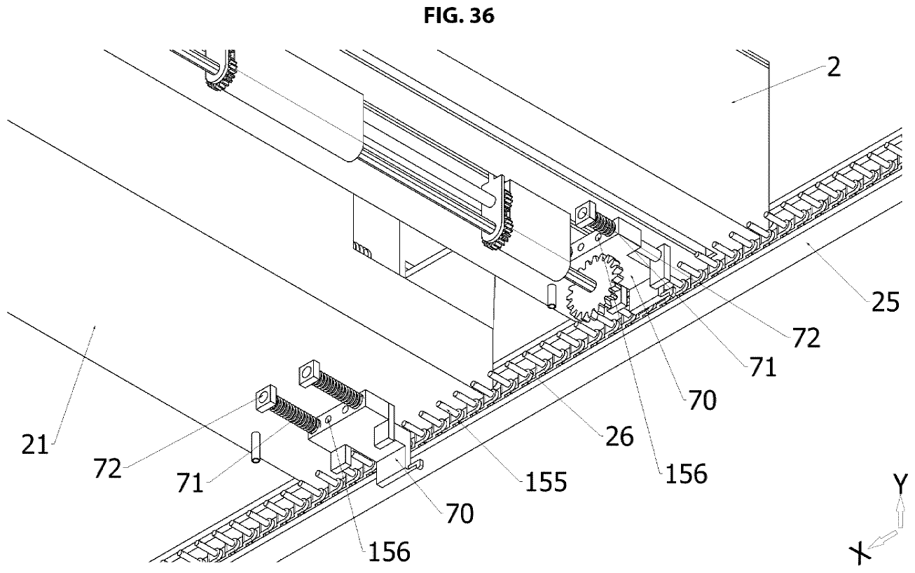

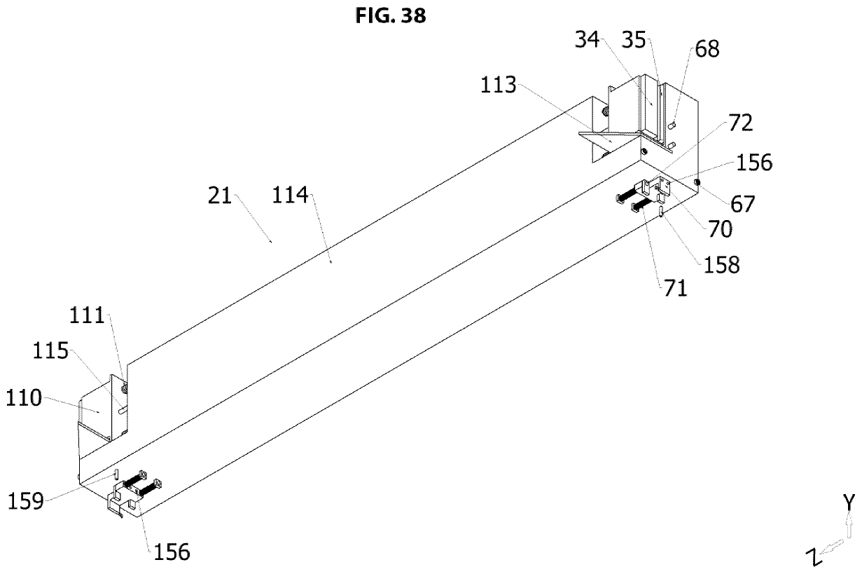

The conveyor drive assembly 128 see FIG. 2, and FIG. 27 is supported by and bolted to the conveying frame 1 see FIG. 1 and FIG. 2 on both sides of the recirculating plant growing mechanism 109 relative to the Z-Axis of the prescribed conveying path. The conveyor drive assembly 128 is a recirculating mechanism operable to recirculate at least one conveying tray assembly 2 see FIG. 1, FIG. 2, FIG. 7, FIG. 8, and FIG. 9 or at least one LED light bar cleaning tray assembly 21 see FIG. 4, FIG. 5, FIG. 6 and FIG. 38 around a prescribed conveying path relative to the X-Axis of the prescribed conveying path see FIG. 1, FIG. 2, such paths may be non-circular or in some embodiments circular, in this embodiment the prescribed conveying path is non-circular and is generally oriented along the X-Axis of the conveying frame. The prescribed conveying path is described by a plurality of conveying chain guide rails 24, 25 see FIG. 1, FIG. 2, FIG. 27, and FIG. 31 which are bolted to and supported by the conveying frame 1 on both sides of the recirculating plant growing mechanism 109 relative to the Z-Axis of the prescribed conveying path. The plurality of conveying chain guide rails 24, 25 which guide and support, in conjunction with a plurality of conveying chain drive sprockets 3 FIG. 1, FIG. 2, FIG. 10, and FIG. 27 on each side of the recirculating plant growing mechanism 109 relative to the Z-Axis of the prescribed conveying path which are driven by and mounted to and supported by a drive shaft 4 see FIG. 1, FIG. 10, and FIG. 27 which is driven by and mounted to and supported by to a conveying chain drive motor/gearbox 5 see FIG. 2, FIG. 10, and FIG. 27 which is supported by and bolted to a motor/gearbox 5 supporting mechanism which is supported by and bolted to the conveying frame 1 on both sides of the recirculating plant growing mechanism 109 relative to the Z-Axis of the prescribed conveying path see FIG. 1, FIG. 10, and FIG. 27, and in conjunction with a plurality of idler sprocket 32 mechanisms see FIG. 11, and FIG. 27 which are supported by and bolted to the conveying frame 1 on both sides of the recirculating plant growing mechanism 109 relative to the Z-Axis of the prescribed conveying path, the plurality of conveying chains 26 see FIG. 10, FIG. 11, FIG. 27, FIG. 30, and FIG. 31 as they are recirculated around the prescribed conveying path relative to the X-Axis of the prescribed conveying path. The plurality of conveying chains 26 are connected to absolute position encoders which provide absolute conveying chain 26 position feedback to the PLC, the plurality of conveying chain 26 links have bearings that make contact with the plurality of conveying chain guide rails 24, 25 guide surfaces to reduce friction when the plurality of conveying chains are 26 are recirculated around the prescribed conveying path, at least one take-up adjustment mechanism will be required for the plurality of conveying chains 26 it is not defined herein. All conveying chain 26 links are manufactured with spigot pins 155 see FIG. 31, and FIG. 36, The conveying chain motor/gearbox 5 is powered by a variable frequency drive controlled by the PLC which allows recirculation speed and direction changes to by affected on the conveying chain 26.

In another embodiment the conveyor drive assembly is supported by and bolted to the conveying frame 1 on one side of the recirculating plant growing mechanism 109 relative to the Z-Axis of the prescribed conveying path. The conveyor drive assembly 128 is a recirculating mechanism operable to recirculate at least one conveying tray assembly 2 around a prescribed conveying path relative to the X-Axis of the prescribed conveying path, such paths may be non-circular or in other embodiments circular, in this embodiment the prescribed conveying path is non-circular and is generally oriented along the X-Axis of the conveying frame. The prescribed conveying path is described by at least one conveying chain guide rail 24, 25 which is bolted to and supported by one side of the conveying frame 1 relative to the X-Axis of the prescribed conveying path, the at least one conveying chain guide rail 24, 25 guide and support, in conjunction with at least one conveying chain drive sprocket 3 which is driven by and mounted to and supported by a drive shaft 4 which is driven by and mounted to and supported by to a conveying chain drive motor/gearbox 5 see FIG. 1, FIG. 2, FIG. 10, and FIG. 27 which is supported by and bolted to a motor/gearbox 5 supporting mechanism which is bolted to and supported by one side of the conveying frame 1 relative to the X-Axis of the prescribed conveying path, and in conjunction with a plurality of idler sprocket 32 mechanisms see FIG. 11, and FIG. 27 which are supported by and bolted to the conveying frame 1, at least one conveying chain 26 as it is recirculated around the prescribed conveying path relative to the X-Axis of the prescribed conveying path. The at least one conveying chain 26 is connected to an absolute position encoder which provides absolute conveying chain 26 position feedback to the PLC. The conveying chain 26 links possess bearings that contact the at least one conveying chain guide rail 24, 25 guide surfaces to reduce friction when the at least one conveying chain 26 is recirculated around the prescribed conveying path, at least one take-up adjustment mechanism will be required for the conveying chain 26 it is not defined herein. The conveying chain 26 links are manufactured with spigot pins 155. The conveying chain motor 5 is powered by a variable frequency drive controlled by the PLC which allows recirculation speed and direction change to by affected on the conveying chain 26.

In another embodiment the conveying chain 26 is replaced by a conveying drive belt and the conveyor drive assembly and the conveying tray locking mechanism are modified accordingly.

In another embodiment the conveying chain 26 is replaced by a conveying cable and the conveyor drive assembly and the conveying tray locking mechanism are modified accordingly.

In another embodiment the prescribed conveying path is generally oriented along the Y-Axis of the conveying frame.

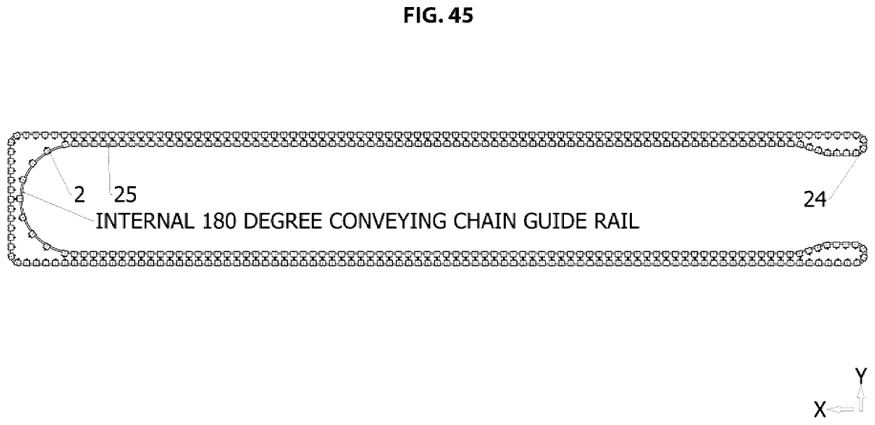

In another embodiment the prescribed conveying path form is a multiple tiered arrangement see FIG. 45 and requires internal 180 degree conveying chain guide rails see FIG. 45 to define the prescribed conveying path, the conveying chains for the internal 180 degree conveying chain guide rails must be disconnected from the conveying chains running around the remainder of the prescribed conveying path, the internal 180 degree conveying chains must run at a higher speed than the chains running around the rest of the prescribed conveying path to allow adequate spacing for the plants in the tightened radius.

In another embodiment the prescribed conveying path form is substantially altered to allow the at least one conveying tray assembly 2 to remain upright as it recirculates around the prescribed conveying path, the conveying tray assembly 2 is decoupled from its two tray chain locking mechanisms relative to the Z-Axis of the prescribed conveying path, the conveying tray assembly 2 has two swivel mechanisms one swivel mechanisms mounted on each side of the conveying tray assembly 2 relative to the Z-Axis of the prescribed conveying path, each swivel mechanisms has a chain locking mechanism mounted to it the tray chain locking mechanisms the conveying tray assembly 2 to rotate about its Z-Axis, a cam follower is attached to one side of the conveying tray assembly 2, the plurality of conveying chain guide rails 24, 25 are modified a have an alignment cam profile machined into them 2 relative to the X-Axis of the prescribed conveying path, the cam follower makes continuous contact with the alignment cam profile machined into the plurality of conveying chain guide rails 24, 25 as the conveying tray assembly 2 recirculates around the prescribed conveying path, the cam follower is pushed by the alignment cam profile machined into the plurality of conveying chain guide rails 24, 25 and this compels the at least one conveying tray assembly 2 Z-Axis to remain perpendicular to the conveying frames 1 X-Axis as it recirculates around the conveying pat, the plant stems constrained within the at least one conveying tray assembly 2 therefore remain perpendicular to the conveying frames 1 X-Axis as they recirculated around the prescribed conveying path in the natural orientation of all growing plants.

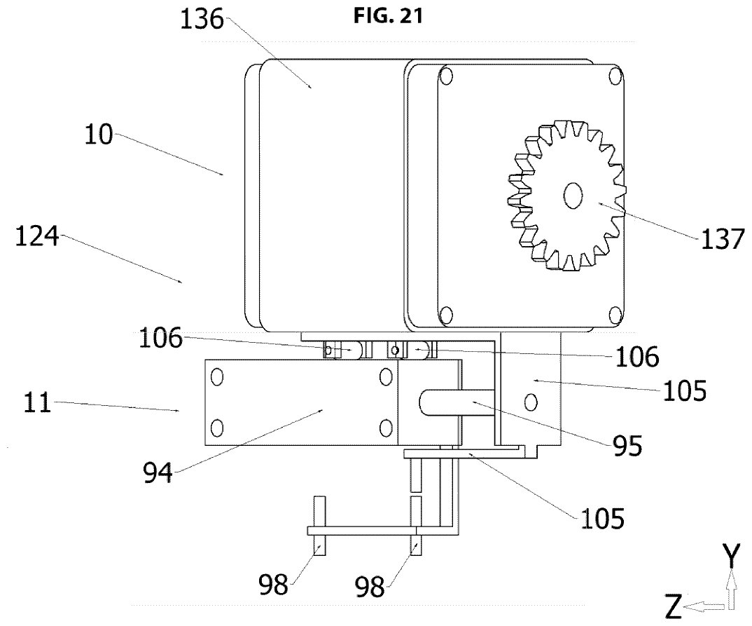

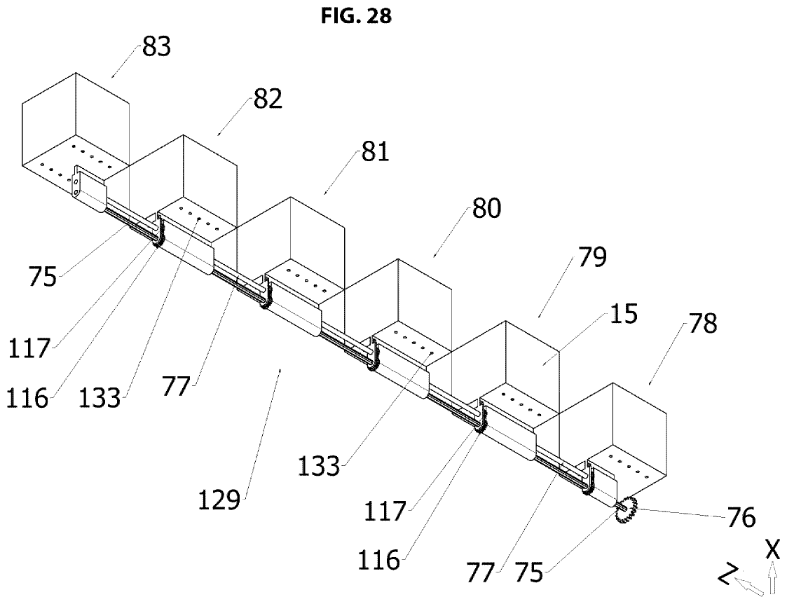

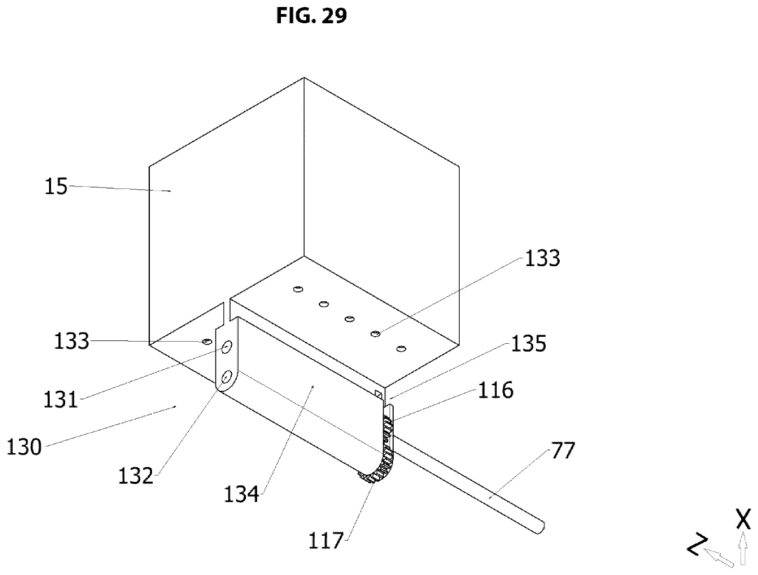

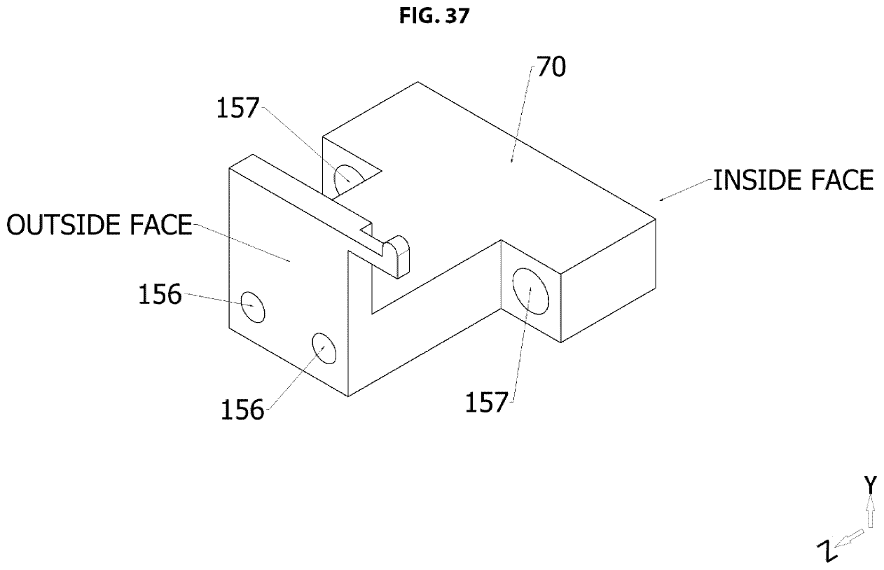

A plurality of conveying tray assemblies 2 maybe be locked onto the conveying chains 26 at variable offset distances relative to the X-Axis of the prescribed conveying path between the conveying tray assemblies 2 depending on the surface area requirements of the plants at all stages of their life cycle. FIG. 2 shows the conveying tray assemblies 2 offset six inches from each other thus twelve inches exists between plant stems relative to the X-Axis of the prescribed conveying path. If the conveying tray assemblies 2 are locked on the conveying chains 26 with no gap between the offset distance is zero inches and there exists 6 inches between the plants stems relative to the X-Axis of the prescribed conveying path Two conveying tray locking mechanisms 70,71 and 72 see FIG. 8, FIG. 9, FIG. 36, and FIG. 37 are mounted one on either side of the conveying tray assembly's 2 double skin tray 65 relative to the L-Axis of the prescribed conveying path to nodes on the underside of the conveying tray assembly's 2 double skin tray 65 see FIG. 8, FIG. 9 and FIG. 36. The two tray locking mechanisms are identical and are assembled as follows; the tray chain lock 70 see FIG. 8, FIG. 9, FIG. 36 and FIG. 37 is mounted on two tray chain lock sliders 72 see FIG. 8, FIG. 9, FIG. 36. The two tray chain lock sliders 72 are inserted through the two tray lock slider penetrations 157 see FIG. 37 machined into the tray chain lock 70 see FIG. 8, FIG. 9 and FIG. 36. A tray chain locking spring 71 is also mounted onto each tray chain lock slider 72 see FIG. 8, FIG. 9, FIG. 36. The two tray chain lock sliders 72 are inserted through the penetrations machined in the nodes on the underside of the conveying tray assembly's 2 double skin tray 65 see FIG. 8, FIG. 9 and FIG. 36. The two tray chain lock sliders 72 are locked to the nodes relative to the Z-Axis of the prescribed conveying path causing the tray chain lock 70 and the two tray chain locking springs 71 to also be locked in place. The two tray locking mechanisms are operable as follows; the two tray chain locking springs 71 push against the inside face see FIG. 37 of the tray chain lock 70 which is free to slide on the two tray chain lock sliders 72 relative to the Z-Axis of the prescribed conveying path causing the tray chain lock 70 to move to its locked position relative to the Z-Axis of the prescribed conveying path. An external force pushing against the outside face see FIG. 37 of the tray chain lock 70 relative to the Z-Axis of the prescribed conveying path in the opposite direction to the force applied by the two tray chain locking springs 71 is required to cause the tray chain lock 70 to move to its unlock position, the tray chain lock 70 has a push latch mechanism similar to that of a retractable pen not shown herein that keeps the tray chain lock 70 in the unlocked position until it is pushed on again at which point the push latch mechanism is released and when the pushing force is removed the tray chain lock 70 is then moved to the locked position by the two tray chain locking springs 71. Two tray chain locking spigot pin penetrations 156 see FIG. 37 are also machined into the tray chain lock 70 see FIG. 8, FIG. 9, FIG. 36 and FIG. 37. When the two conveying tray locking mechanisms mounted at either side of a conveying tray assembly's 2 double skin tray 65 are in the locked position, the distance between the outside faces see FIG. 37 of the tray chain locks 70 relative to the Z-Axis of the prescribed conveying path is equal to “Distance L” see FIG. 31 which is the distance between the conveyor chains 26 inner link faces across the conveyor drive assembly Distance L″ see FIG. 31 relative to the Z-Axis of the prescribed conveying path. When the two conveying tray locking mechanisms mounted at either side of a conveying tray assembly's 2 double skin tray 65 are in the unlocked position, the distance between the outside faces see FIG. 37 of the tray chain locks 70 relative to the Z-Axis of the prescribed conveying path is less than “Distance S” see FIG. 31 which is the distance between the conveyor chains 26 inner conveyor chain locking spigot pin faces across the conveyor drive assembly Distance L″ see FIG. 31 relative to the Z-Axis of the prescribed conveying path. The two conveying tray locking mechanisms mounted at either side of a conveying tray assembly's 2 double skin tray 65 in conjunction with the conveying chains locking spigot pins are operable as follows an external force pushing against the tray chain lock's 70 outer face in the opposite direction to the force applied by the two tray chain locking springs 71 is applied to both tray chain locks causing both the tray chain locks 70 to move to their unlocked positions the conveying tray assembly 2 now be inserted into the conveyor drive assembly 128 relative to the Z-Axis of the prescribed conveying path, if the two tray chain lock's 70 two tray chain locking spigot pin penetrations 156 mounted at either side of the conveying tray assembly's 2 double skin tray 65 are aligned with the same relative conveying chain 26 link's two conveying chain locking spigot pins on the two conveying chains 26 the external force can be removed from the outside faces of the two chain locks 70 mounted at either side of a conveying tray assembly's 2 double skin tray 65 and the two tray chain locking springs 71 mounted at either side of the conveying tray assembly's 2 double skin tray 65 will move the two tray chain locks 70 mounted at either side of a conveying tray assembly's 2 double skin tray 65 to their locked positions capturing the same relative conveying chain 26 link's two conveying chain locking spigot pins on the two conveying chains with the two tray chain locking spigot pin penetrations 156 machined into the tray two chain locks 70. The conveying tray assembly 2 is now locked onto the conveyor drive assembly. The conveying tray assembly's 2 double skin tray 65 constrains the media holders position adjustment assembly 129, see FIG. 28. The conveying tray assemblies 2 contains the plurality of media holder assemblies #1 to #6 78 to 83 each constraining one rooting media in conjunction with the plurality of media containment covers 66 see FIG. 7. The plurality of media containment covers 66 must be locked in place manually by the plurality of media containment cover locking pins 69 prior to loading a conveying tray assembly 2 into the recirculating plant growing mechanism 109. The plurality of media holder assemblies #1 to #6 78 to 83 are component parts of the media holders position adjustment assembly 129 see FIG. 28. The plurality of media holder assemblies #1 to #6 78 to 83 are constrained in the slot machined into the conveying tray assembly's 2 double skin tray 65 relative to the Z-Axis of the prescribed conveying path. The offset distance between the plurality of media holder assemblies #1 to #6 78 to 83 can be adjusted relative to the Z-Axis of the prescribed conveying path if the conveying tray assembly 2 is aligned with media holders drive assembly 124 see FIG. 1, FIG. 2, and FIG. 21 relative to the X-Axis of the prescribed conveying path and if the conveying tray media holders drive stepper motor assembly 10 is in the couple position, the offset distance between media holder assemblies #1 to #6 78 to 83 can be adjusted from zero to six inches thus the distance between plant stems can be adjusted between six inches to 12 inches relative to the Z-Axis of the prescribed conveying path. Media holder assembly #1 78 is locked to the double skin tray 65 and the media holder assemblies #2 to #6 79 to 83 are free to move relative to media holder assembly #1 78 linearly relative to the Z-Axis of the prescribed conveying path. The media holder component 15 has a media holder drive housing 134 machined into its base see FIG. 29 a media holder drive housing gear slot 135 is machined into media holder component's 15 drive housing 134, a right lead screw threaded penetration 131 is machined into the media holder component's drive housing 134, the portion of the lead screw threaded penetration 131 through which the media holder lead screw 77 is fitted and locked into the media holders lead screw gear 116 is drilled out to provide a smooth bore within which the media holder lead screw 77 can rotate freely, and a smooth bore penetration 132 is machined into the media holder component's 15 drive housing 134 through which the media holders splined drive shaft 75 is passed and in which the media holders splined drive shaft 75 is free to rotate, the media holders splined drive shaft 75 also passes through, but is not locked to the media holders splined drive gear 117 which is located in the media holder drive housing gear slot 135, the media holders lead screw gear 116 and the media holders splined drive gear 117 are now meshed and rotate together. The media holder lead screw 77 of media holder assembly #1 78 is threaded into the lead screw threaded penetration 131 of media holder #2 79. The media holder lead screw 77 of media holder assembly #2 79 is threaded into the lead screw threaded penetration 131 of media holder #3 80. The media holder lead screw 77 of media holder assembly #3 80 is threaded into the lead screw threaded penetration 131 of media holder assembly #4 81. The media holder lead screw 77 of media holder assembly #4 81 is threaded into the lead screw threaded penetration 131 of media holder assembly #5 82. The media holder lead screw 77 of media holder assembly #5 82 is threaded into the lead screw threaded penetration 131 of media holder assembly #6 82, the plurality of media holder assemblies 130 are now connected 78 to 83 see FIG. 28. Media holder #6 82 does not require a media holder lead screw. 77 nor a media holder splined drive gear 117 nor a media holder lead screw gear 116. The media holders splined drive shaft 75 is inserted through the media holder drive shaft smooth bore penetration 132 of each media holder assembly #1 to #6 78 to 83 and through the media holders splined drive gears 117 which are housed in the media holder drive housing gear slot 135 of each media holder assembly #1 to #6 78 to 83. The media holders splined drive shaft 75 is locked relative to the Z-Axis of the prescribed conveying path but free to rotate in the smooth bore penetration 132 machined into the media holder component's 15 drive housing 134. A media holders splined drive coupling gear 76 is fixed to the end of the media holders splined drive shaft 75 protruding from the smooth bore penetration 132 of media holder assembly #1 78. Rotating the media holders splined drive coupling gear 76 causes the media holders splined drive shaft 75 to rotate within the smooth bore penetrations 132 machined into the media holder component's 15 drive housing 134 which causes the plurality media holder assemblies splined drive gears 117 to rotate which causes their meshed counterpart plurality of media holders lead screw gears 116 to rotate which causes the plurality of media holder lead screws 77 to rotate. The media holders position adjustment assembly 129 is operable as follows see FIG. 8, FIG. 21, FIG. 28, and FIG. 29, if the conveying tray assembly 2 is aligned with media holders drive assembly 124 see FIG. 2, relative to the X-Axis of the prescribed conveying path and if the conveying tray media holders drive stepper motor assembly 10 is moved to the couple position by the conveying tray media holder drive stepper motor engagement actuator assembly 11 so that the conveying tray media holders drive gear 137 is meshed with the media holders drive coupling gear 76, the conveying tray media holders drive stepper motor 136 can be rotated under PLC control. When the conveying tray media holders drive stepper motor 136 shaft is rotated clockwise, relative to the non-driving end of conveying tray media holders drive stepper motor 136, the right hand threaded lead screw 77 of fixed media holder assembly #1 78 rotates clockwise pulling media holder assembly #2 79 towards fixed media holder assembly #1 78 linearly relative to the Z-Axis of the prescribed conveying path. When the conveying tray media holders drive stepper motor 136 shaft is rotated clockwise, relative to the non-driving end of conveying tray media holders drive stepper motor 136, the right hand threaded lead screw 77 of media holder assembly #2 79 rotates clockwise pulling media holder assembly #3 80 towards media holder assembly #2 79 linearly relative to the Z-Axis of the prescribed conveying path. When the conveying tray media holders drive stepper motor 136 shaft is rotated clockwise, relative to the non-driving end of conveying tray media holders drive stepper motor 136, the right hand threaded lead screw 77 of fixed media holder assembly #3 80 rotates clockwise pulling media holder assembly #4 81 towards media holder assembly #3 80 linearly relative to the Z-Axis of the prescribed conveying path. When the conveying tray media holders drive stepper motor 136 shaft is rotated clockwise, relative to the non-driving end of conveying tray media holders drive stepper motor 136, the right hand threaded lead screw 77 of media holder assembly #4 81 rotates clockwise pulling media holder assembly #5 82 towards media holder assembly #4 81 linearly relative to the Z-Axis of the prescribed conveying path. When the conveying tray media holders drive stepper motor 136 shaft is rotated clockwise, relative to the non-driving end of conveying tray media holders drive stepper motor 136, the right hand threaded lead screw 77 of media holder assembly #5 82 rotates clockwise pulling media holder assembly #6 83 towards media holder assembly #5 82 linearly relative to the Z-Axis of the prescribed conveying path. When the conveying tray media holders drive stepper motor 136 shaft is rotated counter clockwise, relative to the non-driving end of conveying tray media holders drive stepper motor 136, the right hand threaded lead screw 77 of fixed media holder assembly #1 78 rotates counter clockwise pushing media holder assembly #2 79 away from fixed media holder assembly #1 78 linearly relative to the Z-Axis of the prescribed conveying path. When the conveying tray media holders drive stepper motor 136 shaft is rotated counter clockwise, relative to the non-driving end of conveying tray media holders drive stepper motor 136, the right hand threaded lead screw 77 of media holder assembly #2 79 rotates counter clockwise pushing media holder assembly #3 80 away from fixed media holder assembly #2 79 linearly relative to the Z-Axis of the prescribed conveying path. When the conveying tray media holders drive stepper motor 136 shaft is rotated counter clockwise, relative to the non-driving end of conveying tray media holders drive stepper motor 136, the right hand threaded lead screw 77 of media holder assembly #3 80 rotates counter clockwise pushing media holder assembly #4 81 away from fixed media holder assembly #3 80 linearly relative to the Z-Axis of the prescribed conveying path. When the conveying tray media holders drive stepper motor 136 shaft is rotated counter clockwise, relative to the non-driving end of conveying tray media holders drive stepper motor 136, the right hand threaded lead screw 77 of media holder assembly #4 81 rotates counter clockwise pushing media holder assembly #5 82 away from fixed media holder assembly #4 81 linearly relative to the Z-Axis of the prescribed conveying path. When the conveying tray media holders drive stepper motor 136 shaft is rotated counter clockwise, relative to the non-driving end of conveying tray media holders drive stepper motor 136, the right hand threaded lead screw 77 of media holder assembly #5 82 rotates counter clockwise pushing media holder assembly #6 83 away from fixed media holder assembly #5 82 linearly relative to the Z-Axis of the prescribed conveying path.

In other embodiments the number of media holder components 15 and thus the number of media holder assemblies 130 can be increased or decreased which will change the maximum offset distance between the media holder assemblies 130, if the number of media holder assemblies 130 is one then the media holders position adjustment assembly 129 is not required and a media holder component 15 will be locked at the center of the double skin tray 65 relative to the Z-Axis of the prescribed conveying path.

In another embodiment a plurality of media holder components 15 are pushed and pulled to their desired offset positions pushers connected to actuators the media holders position adjustment assembly 129 is obviated and locks are installed on the plurality of media holder components 15 to hold them in the desired offset positions when the plurality of media holder components 15 are not being moved.

In another embodiment a plurality of media holder components 15 are pushed and pulled to their desired offset positions manually the media holders position adjustment assembly 129 is obviated and locks are installed on the plurality of media holder components 15 to hold them in the desired offset positions when the plurality of media holder components 15 are not being moved.

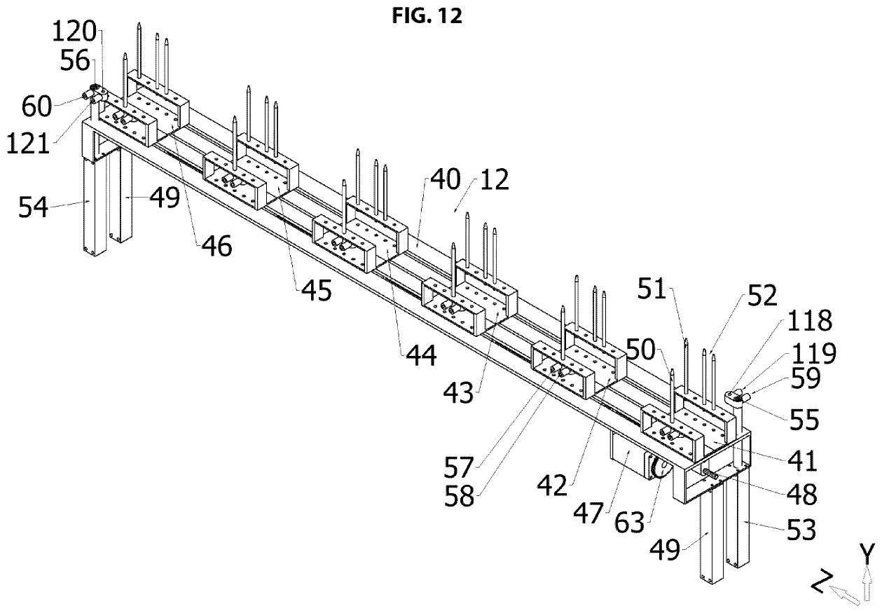

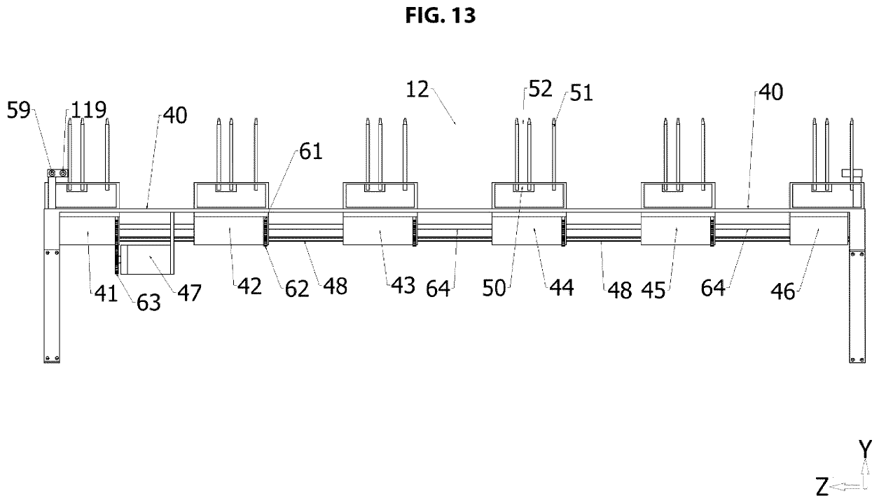

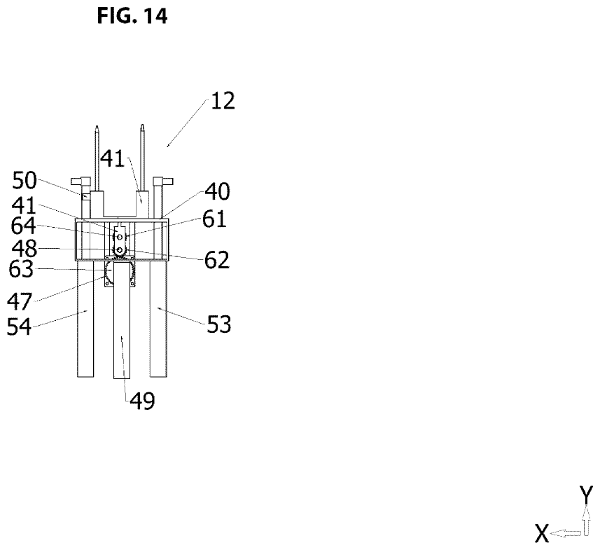

The double skin tray 65 creates a thermal reservoir which is operable to cool or heat through thermal conduction at least one rooting media to the optimal root zone temperature for the species and strain being cultivated. The double skin tray 65 has an inlet glycol coupler with non-return valve 73 see FIG. 8 and FIG. 9 mounted on and ported into the outer skin of the base of the double skin tray 65. The double skin tray 65 has an outlet glycol coupler with non-return valve 74 see FIG. 8 and FIG. 9 mounted on and ported into the outer skin of the base of the double skin tray 65. The inlet glycol coupler with non-return valve 73 is mounted on the base of the double skin tray 65 in a position so that when a conveying tray assembly 2 locked onto the conveyor drive assembly's 128 two conveying chains 26 is recirculated around the prescribed conveying path to the position where the Z-Axis centerline of the plurality of media holders 15 in the conveying tray assembly 2 is directly over the Z-Axis centerline of the watering station 12 see FIG. 12, FIG. 13, and FIG. 14 the inlet glycol coupler with non-return valve 73 is directly above the inlet glycol coupler 55 mounted on the watering station 12. The outlet glycol coupler with non-return valve 74 is mounted on the base of the double skin tray 65 in a position so that when a conveying tray assembly 2 locked onto the conveyor drive assembly's 128 two conveying chains 26 is recirculated around the prescribed conveying path to the position where the Z-Axis centerline of the plurality of media holders 15 in the conveying tray assembly 2 is directly over the Z-Axis centerline of the watering station 12 the outlet glycol coupler with non-return valve 73 is directly above the inlet glycol coupler 55 mounted on the watering station 12. When the inlet glycol coupler with non-return valve 73 is coupled to the watering stations assembly's 12 inlet glycol coupler 55 and when the outlet glycol coupler with non-return valve 74 is coupled to the watering stations assembly's 12 outlet glycol coupler 56, glycol at the optimal root zone temperature for the plant can be injected into the thermal reservoir flushing out the existing glycol in the thermal reservoir.

In another embodiment of a conveying tray assembly 2 a single skin tray replaces the double skin tray 65 and root zone cooling is obviated.

In another embodiment of a conveying tray assembly 2 a single skin tray replaces the double skin tray 65. The media holder component 15 is fabricated with a double skin creating a thermal reservoir which is operable to store glycol to cool or heat through thermal conduction at least one rooting media to the optimal root zone temperature for the species and strain being cultivated. The media holder component 15 is fabricated with inlet and outlet ports which permits the flushing and replacement of glycol whenever necessary to maintain a rooting media installed in the media holder component 15 at the optimal root zone temperature for the species and strain being cultivated.

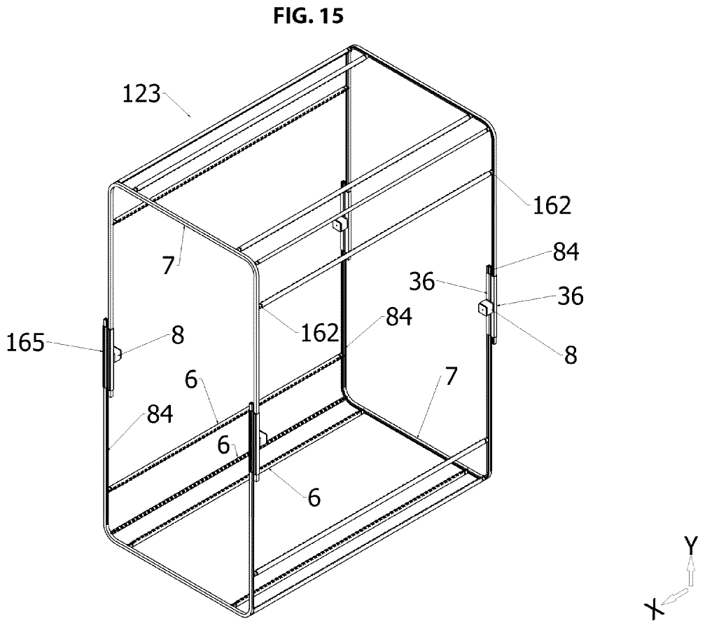

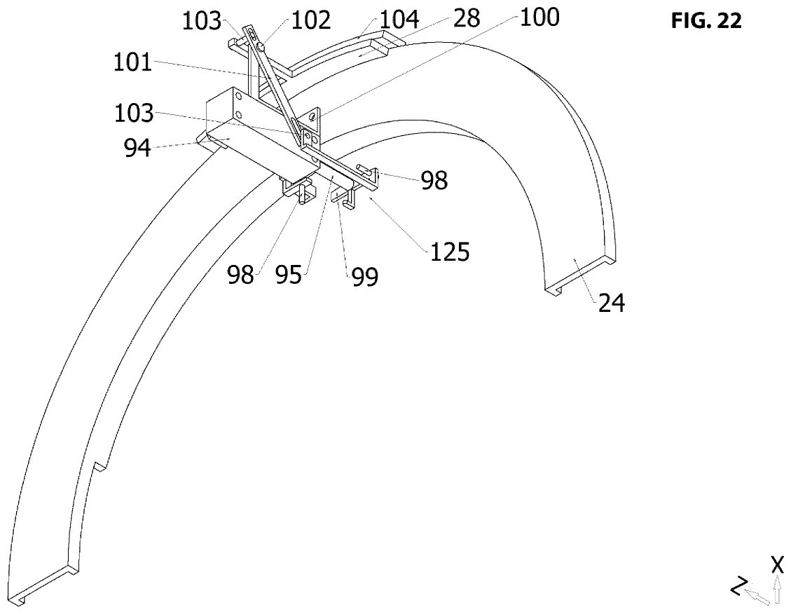

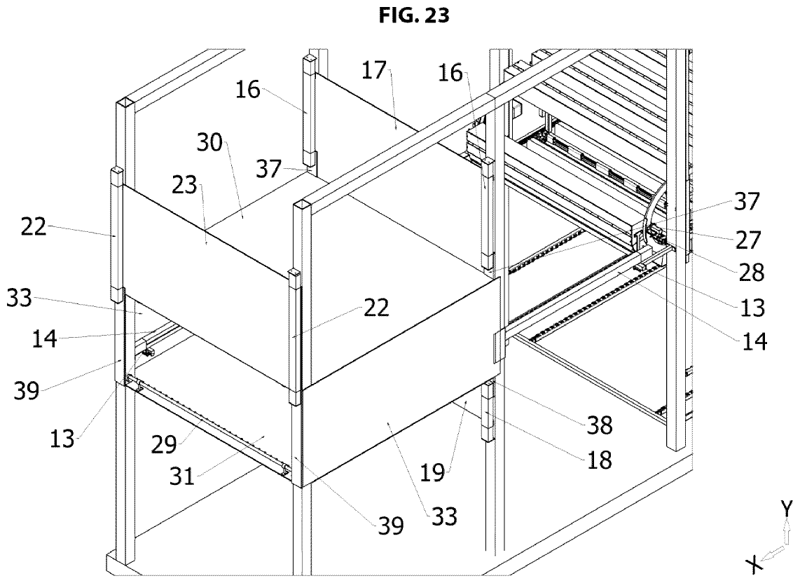

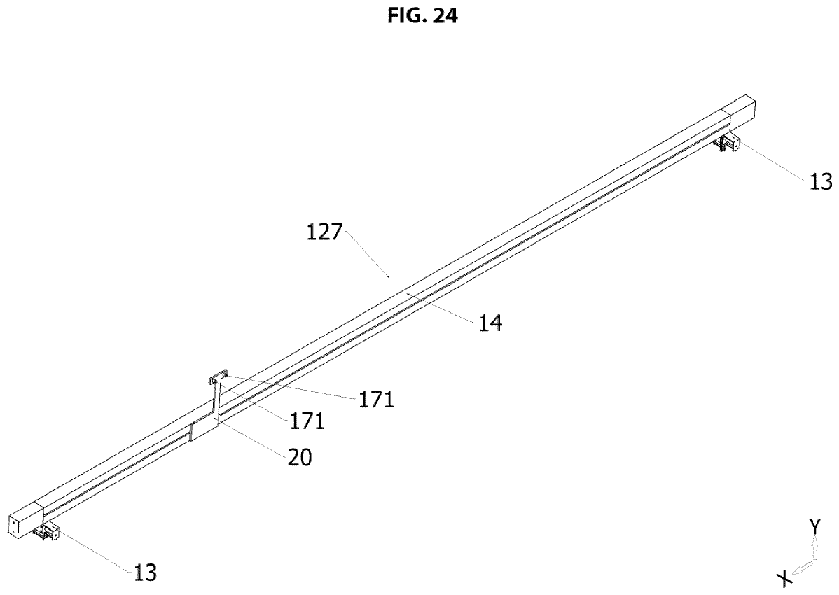

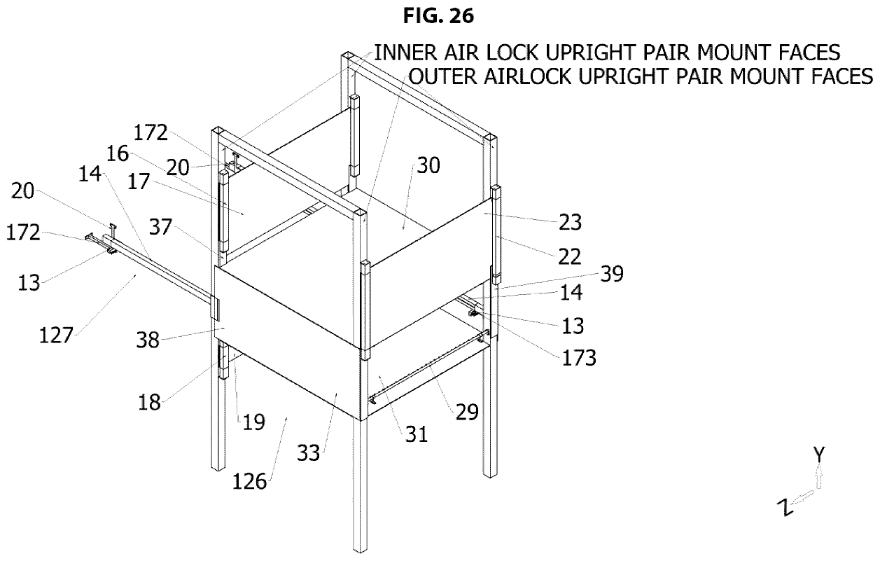

The recirculating plant growing mechanism may have at least one LED light bar cleaning tray assembly 21. If an LED light bar cleaning tray assembly 21 is to be used in the recirculating plant growing mechanism the conveying drive assembly's 128 maximum capacity of conveying tray assemblies 2 is reduced by one to leave space on the conveying chains 26 for the LED light bar cleaning tray assembly 21. In this embodiment the PLC will automatically store the LED light bar cleaning tray assembly 21 in the airlock transfer assembly 126 see FIG. 26 when the LED light bar cleaning tray assembly 21 not in use, and when the airlock transfer assembly 126 is not required for other duties, clamped in the tray clamp carriage 20 see FIG. 1 and FIG. 24 that are mounted on the airlock transfer assembly's 127 see FIG. 1, FIG. 2, FIG. 24 and FIG. 26 air lock transfer actuators 14 see FIG. 1, FIG. 2, FIG. 23, FIG. 24 and FIG. 26, when the airlock transfer assembly 126 is required for other duties or when LED light bar cleaning is desired the PLC will automatically lock the LED light bar cleaning tray assembly 21 onto the conveyor drive assembly's 128 two conveying chains 26 in the location reserved for it in the same manner that has be described above and below for a conveying tray assembly 2. The LED light bar cleaning tray assembly's 21 base has the same type of two conveying tray locking mechanisms as the conveying tray assembly 2 that are mounted in the same manner and relative positions as the two conveying tray assembly's 2 locking mechanisms mounted on either side of a conveying tray assembly's 2 double skin tray 65, the tray chain locks 70 have a push latch mechanism similar to that of a retractable pen not shown herein that keep the tray chain locks 70 in the unlocked position until it is pushed on again at which point the push latch mechanism is released and when the pushing force is removed the tray chain lock 70 is then moved to the locked position by the two tray chain locking springs 71. The LED light bar cleaning tray assembly 21 can therefore be locked onto the conveyor drive assembly's 128 two conveying chains 26 in the same manner as has be described above and below for a conveying tray assembly 2. When an LED light bar cleaning tray assembly 21 is locked on the conveying chains 26 it can be recirculated around the prescribed conveying path in the same manner as has been as has already been described above for a conveying tray assembly 2. The LED light bar cleaning tray assembly 21 has a cleaning tray cleaning solution pressure bladder tank 114 see FIG. 4, FIG. 5, FIG. 6, and FIG. 38 in place of a conveying tray assembly's 2 double skin tray 65. The cleaning tray cleaning solution pressure bladder tank 114 has the same dimensions as a double skin tray 65 relative to the X-Axis and Z-Axis of the prescribed conveying path. The cleaning tray cleaning solution pressure bladder tank 114 has a slightly taller dimension than a double skin tray 65 relative to the Y-Axis prescribed conveying path to provide more cleaning solution capacity. The cleaning tray cleaning solution pressure bladder tank 114 has an inlet cleaning solution coupler with non-return valve 158 see FIG. 5, FIG. 6, and FIG. 38 mounted on and ported into the base of the cleaning tray cleaning solution pressure bladder tank 114. The cleaning tray cleaning solution pressure bladder tank 114 has an outlet cleaning solution coupler with non-return valve 159 see FIG. 5, FIG. 6, and FIG. 38 mounted on and ported into the outer skin of the base of the cleaning tray cleaning'solution pressure bladder tank 114. The inlet cleaning solution coupler with non-return valve 158 is mounted on the base of the base of the cleaning tray cleaning solution pressure bladder, tank 114 in a position so that when a LED light bar cleaning tray assembly 21 locked onto the conveyor drive assembly's 128 two Conveying chains 26 is recirculated around the prescribed conveying path to the position where the Z-Axis centerline of the LED light bar cleaning tray assembly 21 is directly over the Z-Axis centerline of the watering station 12 The inlet cleaning solution coupler with non-return valve 158 is directly above the cleaning solution inlet coupler 118 mounted on the watering station 12. The outlet cleaning solution coupler with non-return valve 159 is mounted on the base of the base of the cleaning tray cleaning solution pressure bladder tank 114 in a position so that when a LED light bar cleaning tray assembly 21 locked onto the conveyor drive assembly's 128 two conveying chains 26 is recirculated around the prescribed conveying path to the position where the Z-Axis centerline of the LED light bar cleaning tray assembly 21 is directly over the Z-Axis centerline of the watering station assembly 12 The outlet cleaning solution coupler with non-return valve 159 is directly above the cleaning solution outlet coupler 118 mounted on the watering station 12. When the inlet cleaning solution coupler with non-return valve 158 is coupled to the watering stations assembly's 12 cleaning solution inlet coupler 118 and when the outlet cleaning solution coupler with non-return valve 159 is coupled to the watering stations assembly's 12 cleaning solution outlet coupler 120, cleaning solution can be injected into cleaning tray cleaning solution pressure bladder tank 114 flushing out the existing cleaning solution in the cleaning tray cleaning solution pressure bladder tank 114. The LED light bar cleaning tray assembly 21 has two cleaning head mechanisms see FIG. 4, FIG. 5, FIG. 6, and FIG. 38 mounted in mirror image of each in recesses see FIG. 4, FIG. 5, and FIG. 38 cut into the cleaning tray cleaning solution pressure bladder tank 114 at either end relative to the Z-Axis of the prescribed conveying path. Two threaded penetrations, the penetrations are not shown herein, are machined into the front face of the recesses FIG. 4 cut into the cleaning tray cleaning solution pressure bladder tank 114 at either end relative to the Z-Axis of the prescribed conveying path. The two cleaning head mechanisms are assembled in the same manner. An LED light bar cleaning sponge 34 is mounted to the front face see FIG. 4 of the cleaning tray mount 110 see FIG. 4, FIG. 5, FIG. 6, and FIG. 38. An LED light bar cleaning squeegee 35 is mounted to the front face of the cleaning tray mount 110 see FIG. 4, FIG. 5, FIG. 6, and FIG. 38. The cleaning tray mount 110 has a penetration machined into the front and rear face of the cleaning tray mount 110, relative to the Z-Axis of the prescribed conveying path the penetration is aligned with the center point of the LED light bar cleaning sponge 34 relative to the X-Axis and Y-Axis of the prescribed conveying path the penetration is not shown herein, that allows the cleaning tray mount cleaning solution delivery tube 15 see FIG. 4, FIG. 5, and FIG. 38 to pass through the cleaning tray mount 110. The cleaning tray mount cleaning solution delivery tube 15 is attached and sealed to the penetration through the front face of the cleaning tray mount 110. A penetration is machined into the front face of the recesses cut into the cleaning tray cleaning solution pressure bladder tank 114 the penetration is not shown herein, an O-ring seal is installed in the penetration that allows the fully retracted position to pass through the O-ring seal and into the cleaning solution pressure bladder tank 114. The cleaning tray mount cleaning solution delivery tube 15 penetrates the cleaning tray cleaning solution pressure bladder tank 114 and couples with a mechanically operable valve not described herein which when closed prevents the pressurized cleaning solution from entering the cleaning tray mount cleaning solution delivery tube 15, the mechanically operable valve is only opened when the cleaning tray mount 110 is in the fully retracted position causing the cleaning tray mount cleaning solution delivery tube 15 to open the mechanically operable valve allowing cleaning solution to flow through the cleaning tray mount cleaning solution delivery tube 15 soaking the LED light bar cleaning sponge 34 with fresh cleaning solution. The cleaning tray mount 110 has two penetrations machined into the rear face of the cleaning tray mount 110, the penetrations are not shown herein, that allow the two cleaning tray mount sliders 112 see FIG. 4, to be insert FIG. 5, FIG. 6, and FIG. 38 relative to the Z-Axis of the prescribed conveying path. The cleaning tray mounts 110 two penetrations are aligned with the two threaded penetrations that are machined into the front face of the recesses cut into the cleaning tray cleaning solution pressure bladder tank 114. The two cleaning tray mount sliders 112 are threaded at both ends. The two cleaning tray mount stops 160 see FIG. 4 have partial threaded penetrations machined in to them. The two cleaning head mechanisms are assembled in the same manner the two cleaning tray mount sliders 112 are threaded and tightened into the penetrations machined into the front face of the recesses FIG. 4 cut into the cleaning tray cleaning solution pressure bladder tank 114, a cleaning tray mount spring 111 see FIG. 4, FIG. 5, and FIG. 38 is inserted over each cleaning tray mount slider 112, the cleaning tray mount 110 is mounted onto two cleaning tray mount sliders, a cleaning tray mount stop 160 is now threaded and tightened onto each cleaning tray mount slider 112 the assembly is now complete. The cleaning tray mount springs are now pushing against the rear face of the cleaning tray mount 110 holding the mount in the fully extended position. When. LED light bar 6 see FIG. 15 cleaning is desired in this embodiment each group of six LED light bars 6 mounted on each groups two LED light bar track assemblies 7 see FIG. 15 mounted in the recirculating plant growing mechanism are driven under PLC control to their home positions. In their home positions three LED light bars 6 in the group are parked next to each other with zero offset distance between them relative to the Y-Axis of the prescribed conveying path on the Y-Axis portion of their groups two supporting LED light bar track assemblies 7 see FIG. 15 on one side of conveyor drive assembly 128 relative to the X-Axis of the prescribed conveying path, the three other LED light bars 6 in the group are parked next to each other with zero offset distance between them relative to the Y-Axis of the prescribed conveying path on the Y-Axis portion of their groups two supporting LED light bar track assemblies 7 see FIG. 15 on the other side of conveyor drive assembly 128 relative to the X-Axis of the prescribed conveying path. Each group of six LED light bars 6 mounted on each groups two LED light bar track assemblies 7 parked at their home positions are within reach of one of the two LED light bar cleaning sponges 34 and one of the two LED light bar cleaning squeegees 35 mounted on the LED light bar cleaning tray assembly 21 relative to the Y-Axis of the prescribed conveying path when the LED light bar cleaning tray assembly 21 recirculates past them relative to the X-Axis of the prescribed conveying path. When LED light bar 6 cleaning is desired and if the LED light bar cleaning tray assembly 21 is not already locked onto the conveyor drive assembly's 128 two conveying chains 26 the PLC will automatically recirculate the drive assembly's 128 two conveying chains 26 the chain links that the LED light bar cleaning tray assembly 21 is to be lock onto is directly in line with the Z-Axis centerline of the two exit gate assemblies 125 see FIG. 1, FIG. 2, and FIG. 22 then lock the LED light bar cleaning tray assembly 21 onto the conveyor drive assembly's 128 two conveying chains 26 in the location reserved for it. The LED light bar cleaning tray assembly 21 is operable as follows when the LED light bar cleaning tray assembly 21 is locked onto the conveyor drive assembly's 128 two conveying chains 26 the conveying chains can only recirculate in the normal direction of travel. The PLC starts the conveyor drive assembly's 128 two conveying chains 26 recirculating. When the LED light bar cleaning tray assembly 21 is positioned at the two exit gate assemblies 125 there are no LED light bars 6 within reach to push back at the either of the two LED light bar cleaning sponges 34 and either of the two LED light bar cleaning squeegees 35 mounted on the LED light bar cleaning tray assembly 21 and so the cleaning tray mount springs pushing against the rear face of the cleaning tray mounts 110 are holding the mounts in their fully extended positions. As the LED light bar cleaning tray assembly 21 recirculates away from the two exit gate assemblies 125 the two cleaning tray mounts 110 upright dodgers 113 see FIG. 4, FIG. 6, and FIG. 38 encounter the first set of conveyor frame 1 uprights located on either side of the conveyor drive assembly 128 relative to the X-Axis of and the dodging sequence begins; the prescribed conveying path and the dodging sequence begins under the motive power of the conveyor drive assembly's 128 two conveying chains 26 the two cleaning tray mounts 110 upright dodgers 113 gradually push back the two cleaning tray mounts 110 to their fully retracted positions so that the two LED light bar cleaning sponges 34 and the two LED light bar cleaning squeegees 35 recirculate past the first set of conveyor frame 1 uprights located on either side of the conveyor drive assembly 128 relative to the X-Axis of the prescribed conveying path unimpeded, at the same time fresh cleaning solution is being applied to the two LED light bar cleaning sponges 34. When the two cleaning tray mounts 110 upright dodgers 113 have recirculate past the first set of conveyor frame 1 uprights located on either side of the conveyor drive assembly 128 relative to the X-Axis of the prescribed conveying path the cleaning tray mounts 110 are released and the two LED light bar cleaning sponges 34 and the two LED light bar cleaning squeegees 35 make contact with the first group of six LED light bars 6 which are parked at their respective home positions ending the dodging sequence. The two LED light bar cleaning sponges 34 and the two LED light bar cleaning squeegees 35 recirculate down the length of the first group of six LED light bars 6 which are parked at their respective home positions cleaning the light bars, the two cleaning tray mounts 110 upright dodgers 113 see FIG. 4, FIG. 6, and FIG. 38 then encounter the second set of conveyor frame 1 uprights located on either side of the conveyor drive assembly 128 relative to the X-Axis of the prescribed conveying path and the dodging sequence is repeated. The same sequence is repeated at every set of conveyor frame 1 uprights located on either side of the conveyor drive assembly 128 relative to the X-Axis of the prescribed conveying path as the LED light bar cleaning tray assembly 21 recirculates around the prescribed conveying path.

In other embodiments the number of light bars will be different based upon the DLI requirements of the species and or strains being cultivated.

In other embodiments other lighting technologies may be employed and the LED light bar cleaning tray assembly 21 will be modified accordingly.

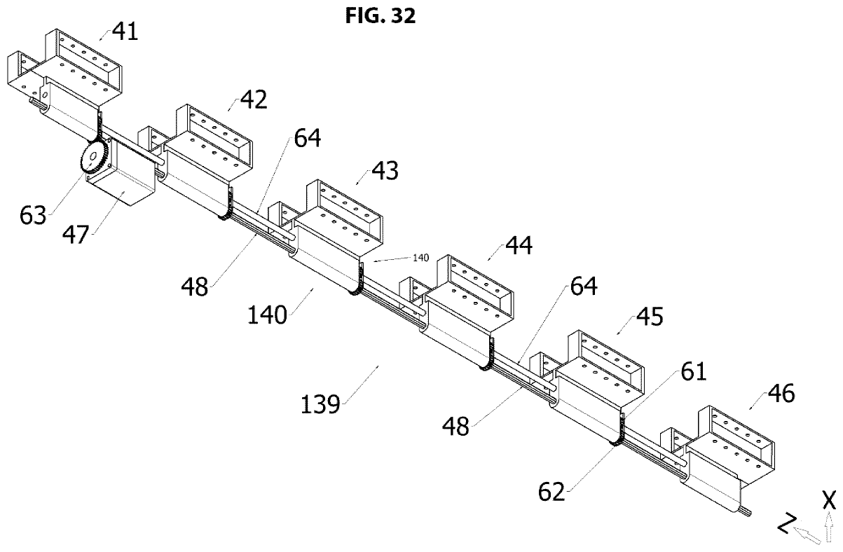

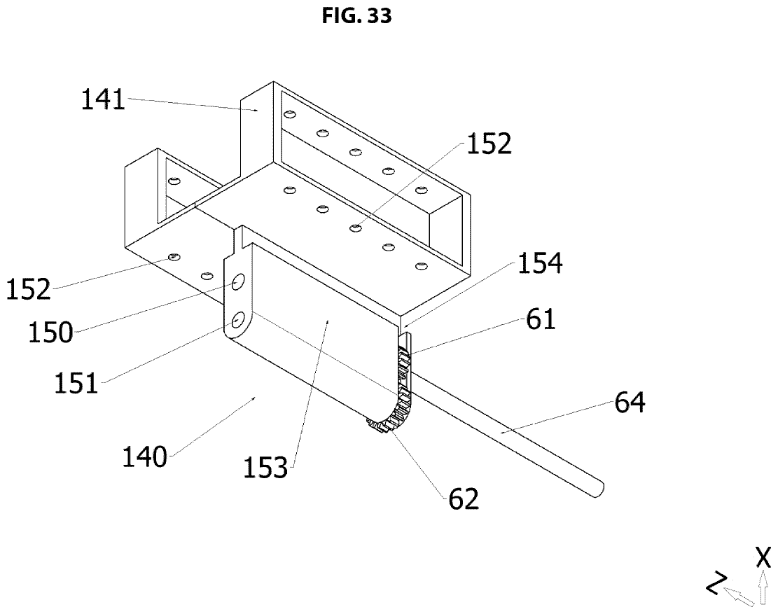

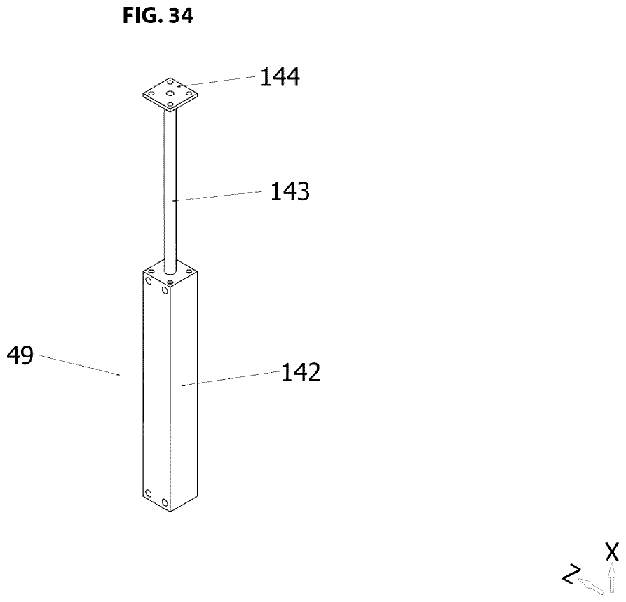

The recirculating plant growing mechanism may have at least one watering station assembly 12 see FIG. 12, FIG. 13, and FIG. 14. In one embodiment the watering station assembly 12 is bolted to the watering station assembly connecting member 138 to the conveyor frame 1 see FIG. 30 and FIG. 31, the watering station assembly 12 is positioned so that its Z-Axis centerline is aligned relative the Z-Axis centerline of the conveyor drive assembly 128 see FIG. 27, the watering station assembly 12 is positioned relative to the Y-Axis of the prescribed conveying path so that one or more plant retaining conveying tray assemblies 2 can recirculate around the watering station assembly 12 when locked onto the conveyor drive assembly's 128 conveying chains 26 unimpeded when the watering station assembly 12 is in its home position relative to the Y-Axis of the prescribed conveying path see FIG. 30 and FIG. 31. The component parts of the watering station assembly 12 are held in place by the by the watering station plinth 40 which is mounted at both ends relative to the Z-Axis of the prescribed conveying path upon two watering station elevating actuator assemblies 49. The two watering station elevating actuator bodies 142 see FIG. 34 are bolted to the watering station assembly station 138. The plurality of probe slider assemblies #1 to #6 41 to 46 are component parts of the probe sliders position adjustment assembly 139 see FIG. 32. The plurality of probe slider assemblies #1 to #6 41 to 46 are constrained in the a machined into the watering station plinth 40 relative to the Z-Axis of the prescribed conveying path. The offset distance between the plurality of probe slider assemblies #1 to #6 41 to 46 can be adjusted relative to the Z-Axis of the prescribed conveying path, the offset distance between probe slider assemblies #1 to #6 41 to 46 can be adjusted from zero to six inches. Probe slider assembly #1 41 is locked to the watering station plinth 40 and the probe slider assemblies #2 to #6 42 to 46 are free to move relative to probe slider assembly #1 41 linearly relative to the Z-Axis of the prescribed conveying path. The probe slider component 141 has a probe slider drive housing 153 machined into its base see FIG. 33 a probe slider drive housing gear slot 154 is machined into probe slider component's 141 drive housing 153, a right lead screw threaded penetration 150 is machined into the probe slider component's drive housing 153, the portion of the lead screw threaded penetration 150 through which the probe slider lead screw 64 is fitted and locked into the probe sliders lead screw gear 61 is drilled out to provide a smooth bore within which the probe slider lead screw 64 can rotate freely, and a probe slider drive shaft probe sliders drive shaft smooth bore penetration 151 is machined into the probe slider component's 141 probe slider drive housing 153 through which the probe sliders splined drive shaft 48 is passed and in which the probe sliders splined drive shaft 48 is free to rotate, the probe sliders splined drive shaft 48 also passes through, but is not locked to the probe sliders splined drive gear 62 which is located in the probe slider drive housing gear slot 154, the probe sliders lead screw gear 61 and the probe sliders splined drive gear 62 are now meshed and rotate together. The probe slider lead screw 64 of probe slider assembly #1 41 is threaded into the lead screw threaded penetration 150 of probe slider #2 42. The probe slider lead screw 64 of probe slider assembly #2 42 is threaded into the lead screw threaded penetration 150 of probe slider #3 43. The probe slider lead screw 64 of probe slider assembly #3 43 is threaded into the lead screw threaded penetration 150 of probe slider assembly #4 44. The probe slider lead screw 64 of probe slider assembly #4 44 is threaded into the lead screw threaded penetration 150 of probe slider assembly #5 45. The probe slider lead screw 64 of probe slider assembly #5 45 is threaded into the lead screw threaded penetration 150 of probe slider assembly #6 45, the plurality of probe slider assemblies 130 are now connected 41 to 46 see FIG. 78. Probe slider #6 45 does not require a probe slider lead screw 64 nor a probe sliders splined drive gear 62 nor a probe sliders lead screw gear 61. The probe sliders splined drive shaft 48 is inserted through the probe sliders drive shaft smooth bore penetration 151 of each probe slider assembly #1 to #6 41 to 46 and through the probe sliders splined drive gear 62 one of which is housed in the probe slider drive housing gear slot 154 of each probe slider assembly #1 to #6 41 to 46. The probe sliders splined drive shaft 48 is locked relative to the Z-Axis of the prescribed conveying path but free to rotate in the probe sliders drive shaft smooth bore penetration 151 machined into each probe slider assembly's #1 to #6 41 to 46 drive housing 153. A probe slider drive stepper motor 47 has a probe slider stepper motor gear 63 fixed to its drive shaft. The probe slider drive stepper motor 47 is bolted to the watering station plinth in a position so that the probe slider stepper motor gear 63 meshes with the probe slider assembly's #1 41 probe sliders lead screw gear 61. Rotating probe slider drive stepper motor 47 drive shaft causes the probe slider drive stepper motor gear 63 to rotate which causes the probe sliders splined drive shaft 48 to rotate within the probe sliders drive shaft smooth bore penetrations 151 machined into the probe slider component's 141 drive housing 153 which causes the plurality of probe slider assemblies #1 to #6 41 to 46 splined drive gears 62 to rotate which causes their meshed counterpart plurality of probe sliders lead screw gears 61 to rotate which causes the plurality of probe slider lead screws 64 to rotate. The probe sliders position adjustment assembly 139 is operable as follows see FIG. 12, FIG. 13, FIG. 32, and FIG. 33 the probe sliders drive stepper motor 47 can be rotated under PLC control. When the probe sliders drive stepper motor's 47 drive shaft is rotated clockwise, relative to the driving end of probe sliders drive stepper motor 47, the right hand threaded lead screw 64 of the fixed probe slider assembly #1 41 rotates clockwise pulling probe slider assembly #2 42 towards the fixed probe slider assembly #1 41 linearly relative to the Z-Axis of the prescribed conveying path. When the probe sliders drive stepper motor 47 shaft is rotated clockwise, relative to the driving end of probe sliders drive stepper motor 47, the right hand threaded lead screw 64 of probe slider assembly #2 42 rotates clockwise pulling probe slider assembly #3 43 towards probe slider assembly #2 42 linearly relative to the Z-Axis of the prescribed conveying path. When the probe sliders drive stepper motor 47 shaft is rotated clockwise, relative to the driving end of probe sliders drive stepper motor 47, the right hand threaded lead screw 64 of fixed probe slider assembly #3 43 rotates clockwise pulling probe slider assembly #4 44 towards probe slider assembly #3 43 linearly relative to the Z-Axis of the prescribed conveying path. When the probe sliders drive stepper motor 47 shaft is rotated clockwise, relative to the driving end of probe sliders drive stepper motor 47, the right hand threaded lead screw 64 of probe slider assembly #4 44 rotates clockwise pulling probe slider assembly #5 45 towards probe slider assembly #4 44 linearly relative to the Z-Axis of the prescribed conveying path. When the probe sliders drive stepper motor 47 shaft is rotated clockwise, relative to the driving end of probe sliders drive stepper motor 47, the right hand threaded lead screw 64 of probe slider assembly #5 45 rotates clockwise pulling probe slider assembly #6 46 towards probe slider assembly #5 45 linearly relative to the Z-Axis of the prescribed conveying path. When the probe sliders drive stepper motor 47 shaft is rotated counter clockwise, relative to the driving end of probe sliders drive stepper motor 47, the right hand threaded lead screw 64 of fixed probe slider assembly #1 41 rotates counter clockwise pushing probe slider assembly #2 42 away from fixed probe slider assembly #1 41 linearly relative to the Z-Axis of the prescribed conveying path. When the probe sliders drive stepper motor 47 shaft is rotated counter clockwise, relative to the driving end of probe sliders drive stepper motor 47, the right hand threaded lead screw 64 of probe slider assembly #2 42 rotates counter clockwise pushing probe slider assembly #3 43 away from fixed probe slider assembly #2 42 linearly relative to the Z-Axis of the prescribed conveying path. When the probe sliders drive stepper motor 47 shaft is rotated counter clockwise, relative to the driving end of probe sliders drive stepper motor 47, the right hand threaded lead screw 64 of probe slider assembly #3 43 rotates counter clockwise pushing probe slider assembly #4 44 away from fixed probe slider assembly #3 43 linearly relative to the Z-Axis of the prescribed conveying path. When the probe sliders drive stepper motor 47 shaft is rotated counter clockwise, relative to the driving end of probe sliders drive stepper motor 47, the right hand threaded lead screw 64 of probe slider assembly #4 44 rotates counter clockwise pushing probe slider assembly #5 45 away from fixed probe slider assembly #4 44 linearly relative to the Z-Axis of the prescribed conveying path. When the probe sliders drive stepper motor 47 shaft is rotated counter clockwise, relative to the driving end of probe sliders drive stepper motor 47, the right hand threaded lead screw 64 of probe slider assembly #5 45 rotates counter clockwise pushing probe slider assembly #6 46 away from fixed probe slider assembly #5 45 linearly relative to the Z-Axis of the prescribed conveying path. In other embodiments the number of probe slider components 141 and thus the number of probe slider assemblies 140 can be increased or decreased which will change the maximum offset distance between the probe slider assemblies 140, if the number of probe slider assemblies 140 is one then the probe sliders position adjustment assembly 129 is not required and a probe slider component 141 will be locked at the center of the watering station plinth 40 relative to the Z-Axis of the prescribed conveying path. In another embodiment the plurality of probe slider components are pushed and pulled to their desired offset positions by pusher plates connected to actuators the probe sliders position adjustment assembly 129 is not required and locks are installed on the plurality of probe sliders components 141 to hold them in the desired offset positions when the plurality of probe sliders components 141 are not being moved. In another embodiment a plurality of probe slider components are pushed and pulled to their desired offset positions manually the probe sliders position adjustment assembly 129 is not required and locks are installed on the plurality of probe sliders components 141 to hold them in the desired offset positions when the plurality of probe sliders components 141 are not being moved. The plurality of probe slider assemblies #1 to #6 41 to 46 may constrain any combination and number of fertigation injection probes 50 water content sensors 52, electrical conductivity sensors 52, temperature sensors 51, o2 sensors, pH sensors, any other injection probe type necessary to inject liquids or powders into the rooting media, and any other sensor type necessary to monitor the rooting media. In one embodiment the probes and sensors are inserted into a plurality of probe slider fertigation injection probe or sensor penetrations 152 machined into the plurality of probe slider components 141 horizontal surfaces spaced relative to the Z-Axis of the prescribed conveying path. The plurality of fertigation injection probes 50 and sensors 51 and 52 are inserted and fixed in place into the plurality of probe slider fertigation injection probe or sensor penetrations 152 with their penetrating needle tips pointing upwards relative to the Y-Axis of the prescribed conveying path. The plurality of fertigation injection probes 50 are hollow to allow fertigation liquids and or water to be injected into the rooting media two flexible hose connection ports are provided and will be connected via a plurality of flexible hoses not defined herein to a fertigation and water delivery system not defined herein. The plurality of sensors 51 and 52 will be connected via flexible wiring harness to the PLC. When the watering station 12 is in its home position relative to the Y-Axis of the prescribed conveying path see FIGS. 30 and 31 the penetrating needle tips of the plurality of fertigation injection probes 50 and sensors 51 and 52 sit justbelow the base of one or more plant retaining conveying tray assemblies 2 recirculating around the prescribed conveying path when locked onto the conveyor drive assembly's 128 conveying chains 26. The offset distance between the plurality of probe slider assemblies #1 to #6 41 to 46 can be adjusted relative to the Z-Axis of the prescribed conveying path, and the offset distance between the plurality of media holder assemblies #1 to #6 78 to 83 in the conveying tray assemblies 2 can be adjusted relative to the Z-Axis of the prescribed conveying path. Fertigation and rooting media sampling is fully automated the scheduled frequency for the specific crop day in the crops life cycle is stored in the specific plant and strain recipe database of the PLC, and based upon real time rooting media sampling, and through laser range finder data input into statistical algorithms the optimal allocated surface area ft2 for the crop as it grows. Based upon this data the PLC will automatically control for the following:
Recipe Scheduled rooting media fertigation and sampling of all plants locked onto the conveying chains 26;
Unscheduled operator requested rooting media fertigation and sampling of all plants locked onto the conveying chains 26;
Absolute position control and indexing of the conveying chains 26 and thereby the absolute position of the at least one conveying tray assembly 2 locked onto the conveying chains 26;
Offset distance between the plurality of media holders 15 in the at least one conveying tray assembly 2 locked onto the conveying chains 26 relative to the Z-Axis of the prescribed conveying path;
Offset distance between a plurality of media conveying tray assemblies 2 locked onto the conveying chains 26 relative to the X-Axis of the prescribed conveying path;
Offset distance of between the plurality of probe sliders 141;
Watering station fertigation sequence;
Watering station glycol flushing sequence;
Watering station cleaning solution flushing sequence;
Nutrient ratios and dosing volume for each plant locked onto the conveying chains 26;
Absolute position of the plurality of LED light bars 5, relative to plant canopy requirements, around the plurality light bar track assemblies 7;
Absolute height of the light bar track assemblies 7 above the plant canopy relative to the Y-Axis of the prescribed conveying path.

Before the watering station 12 can be moved, by the two watering station elevating actuator assemblies 49, from its home position relative to the Y-Axis of the prescribed conveying path the following conditions must be met:
1. The offset distance of between the plurality of probe sliders 141 and the offset distance between the plurality of media holders 15 in the conveying tray assembly 2 whose rooting medias are to be sampled and or fertigated must be equal;
2. The Z-Axis centerline of the plurality of media holders 15 in the conveying tray assembly 2 whose rooting medias are to be sampled and or fertigated must be directly over the Z-Axis centerline of the watering station 12;
3. The conveying chains 26 must be stopped and not restarted until the watering station assembly 12 is returned to its home position home position relative to the Y-Axis of the prescribed conveying path;
4. The inlet glycol coupler 55 see FIG. 12 and FIG. 13 must be in its home position relative to the Y-Axis of the prescribed conveying path;
5. The outlet glycol coupler 56 see FIG. 12 and FIG. 13 must be in its home position relative to the Y-Axis of the prescribed conveying path.

Meeting the following conditions is made possible by the PLC which controls the positions of the all actuators and receives the absolute position encoder feedback from all the actuators for the following tasks:
Record keeping of the offset distance, relative to the Z-Axis of the prescribed conveying path, between the plurality of media holders 15 in all the conveying tray assemblies 2 locked onto the conveying chains 26;
Record keeping of the absolute position on the conveying chains 26 of all the conveying tray assemblies 2 locked onto the conveying chains 26 relative to the X-Axis of the prescribed conveying path;
Realtime absolute position of the conveying chains 26 as they recirculate around the prescribed conveying path;
Realtime absolute position of the plurality probe sliders 141 relative to the Z-Axis of the prescribed conveying path.

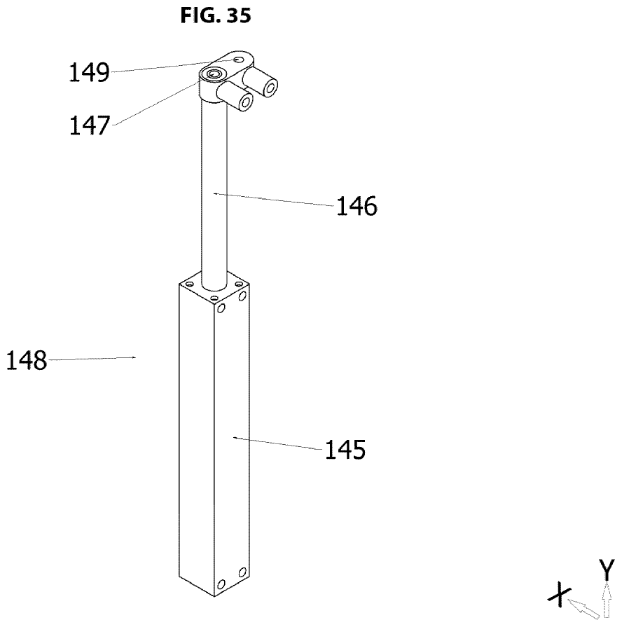

Once conditions 1, 2, 3, 4 and 5 are met the two watering station elevating actuator assemblies 49 under PLC control moves the watering station plinth 40 in an upward direction relative to the Y-Axis of the prescribed conveying path so that the attached plurality of fertigation injection probes 50 and sensors 51 and 52 move towards the conveyor tray assembly 2 located directly above the watering station and pass through slots cut in the base of the its double skin tray 65 and pass through a plurality of media holder fertigation injection probe or sensor penetrations 133 see FIG. 29 machined into the bases of the plurality of media holder components 15 to penetrate the plurality of rooting medias to an optimal distance for fertigation and or water injection and or rooting media variable sampling, the watering station plinth 40 is now in its sample position relative to the Y-Axis of the prescribed conveying path. The watering station assembly 12 is now operable to perform fertigation and or water injection and or rooting media variable sampling tasks. The watering station plinth also acts as a glycol injection station, the two glycol coupler actuator assemblies 53 and 54 see FIG. 12 and FIG. 13 glycol coupling actuator bodies 145 see FIG. 35 are bolted to the watering station plinth 40 two penetrations are machined into the watering station plinth 40 allowing the glycol coupler actuator shafts 146 see FIG. 35 to move in an upward direction under PLC control relative to the Y-Axis of the prescribed conveying path. Glycol coupler actuator assembly 53 is the inlet glycol coupler assembly 53, and glycol coupler actuator assembly 54 is the outlet glycol coupler assembly 54. Mounted and fixed to the end of the inlet glycol coupler assembly's 53 glycol coupler actuator shaft 146 is the inlet glycol coupler 55 see FIG. 12, FIG. 13 and FIG. 35. The inlet glycol coupler 55 shares its body with the cleaning solution inlet coupler 118 see FIG. 12, FIG. 13 and FIG. 35. Mounted and fixed to the end of the outlet glycol coupler assembly's 54 glycol coupler actuator shaft 146 is the outlet glycol coupler 56 see FIG. 12, FIG. 13 and FIG. 35. The outlet glycol coupler 56 shares its body with the cleaning solution outlet coupler 120 see FIG. 12, FIG. 13 and FIG. 35. A flexible hose connection glycol inlet port 59 is provided see FIG. 12 and FIG. 13 and will be connected via a flexible hose to the glycol heat exchanging system not defined herein. A flexible hose connection cleaning solution inlet port 119 is provided see FIG. 12 and FIG. 13 and will be connected via a flexible hose to the cleaning solution supply system not defined herein. A flexible hose connection glycol outlet port 60 is provided see FIG. 12 and will be connected via a flexible hose to the glycol heat exchanging system not defined herein. A flexible hose connection cleaning solution outlet port 121 is provided see FIG. 12 and will be connected via a flexible hose to the cleaning solution return system not defined herein. The watering station plinth 40 is still in its sample position relative to the Y-Axis of the prescribed conveying path and the inlet glycol coupler 55 is coupled to the inlet glycol coupler with non-return valve 73 mounted on the base of the double skin tray 65 of the conveying tray assembly 2 being sampled, the act of coupling causes the inlet glycol coupler's non-return valve to open 73, and the outlet glycol coupler 56 is now coupled to the outlet glycol coupler with non-return valve 74 which is mounted on the base of the double skin tray 65 of the conveying tray assembly 2 being sampled, the act of coupling causes the outlet glycol coupler's non-return valve to open 74. Glycol at the optimal root zone temperature for the plant species can now be injected into the thermal reservoir of the double skin tray 65 flushing out the existing glycol in the thermal reservoir of the double skin tray 65. Upon completion of the fertigation and or water injection and or rooting media variable sampling and glycol injection flushing tasks, the two watering station elevating actuator assemblies 49 under PLC control move the watering station plinth 40 in an downward direction relative to the Y-Axis of the prescribed conveying path so that the attached plurality of fertigation injection probes 50 and sensors 51 and 52 move away from the conveyor tray assembly 2 being sampled and move out of the plurality of rooting medias and move out of the plurality of media holder fertigation injection probe or sensor penetrations 133 and move out of the slots cut in the base of the its double skin tray 65 and the watering station assembly 12 is returned to its home position The inlet glycol coupler 55 is now de-coupled from the inlet glycol coupler with non-return valve 73 and the non-return valve is closed. The outlet glycol coupler 56 is now de-coupled from the outlet glycol coupler with non-return valve 74 and the non-return valve is closed. The conveying chains 26 can now be restarted. There exists another method of operation of the watering station assembly's 12 glycol injection station that allows it to operate independently of the watering station elevating actuator assemblies 49. If the above conditions 1, 2, and 3 are met and the watering station assembly 12 is in its home position, the inlet glycol coupling actuator assembly 53 under PLC control moves the inlet glycol coupler 55 in an upward direction relative to the Y-Axis of the prescribed conveying path until it couples with the inlet glycol coupler with non-return valve 73 mounted on the base of the double skin tray 65 of the conveying tray assembly 2 being sampled, the act of coupling causes the inlet glycol coupler's non-return valve to open 73, and the outlet glycol coupling actuator assembly 54 under PLC control moves the outlet glycol coupler 56 in an upward direction relative to the Y-Axis of the prescribed conveying path until it couples with the outlet glycol coupler with non-return valve 74 mounted on the base of the double skin tray 65 of the conveying tray assembly 2 being sampled, the act of coupling causes the outlet glycol coupler's non-return valve to open 74. Glycol at the optimal root zone temperature for the plant can now be injected into the thermal reservoir of the double skin tray 65 flushing out the existing glycol in the thermal reservoir of the double skin tray 65. Once the glycol in the thermal reservoir of the double skin tray 65 has been exchanged, the inlet glycol coupling actuator assembly 53 under PLC control moves the inlet glycol coupler 55 in a downward direction relative to the Y-Axis of the prescribed conveying path so that it de-couples from the inlet glycol coupler with non-return valve 73, the act of de-coupling causes the inlet glycol coupler's non-return valve to close 73 and the inlet glycol coupler 55 is returned to its home position relative to the Y-Axis of the prescribed conveying path. Once the glycol in the thermal reservoir of the double skin tray 65 has been exchanged, the outlet glycol coupling actuator assembly 54 under PLC control moves the outlet glycol coupler 56 in a downward direction relative to the Y-Axis of the prescribed conveying path so that it de-couples from the outlet glycol coupler with non-return valve 74, the act of de-coupling causes the inlet glycol coupler's non-return valve to close 74 and the outlet glycol coupler 56 is returned to its home position relative to the Y-Axis of the prescribed conveying path. The conveyor chains can now be restarted. The watering station plinth 40 also acts as a cleaning solution injection station, the inlet glycol coupler 55 shares its body with the cleaning solution inlet coupler 118. The outlet glycol coupler 56 shares its body with the cleaning solution outlet coupler 120.

Before the cleaning solution injection station can be operated, the following conditions must be met:
6. the Z-Axis centerline of the LED light bar cleaning tray assembly 21 must be directly over the Z-Axis centerline of the watering station assembly 12;
7. The watering station assembly 12 must be in the home position;
8. The conveying chains 26 must be stopped and not restarted until cleaning solution inlet coupler 118 is returned to its home position home position relative to the Y-Axis of the prescribed conveying path;
9. The conveying chains 26 must be stopped and not restarted until cleaning solution outlet coupler 120 is returned to its home position home position relative to the Y-Axis of the prescribed conveying path.

Meeting the following conditions is made possible by the PLC which controls the positions of the all actuators and receives the absolute position encoder feedback from all the actuators for the following tasks:
Record keeping of the absolute position on the conveying chains 26 of the LED light bar cleaning tray assembly 21 locked onto the conveying chains 26 relative to the X-Axis of the prescribed conveying path;
Realtime absolute position of the conveying chains 26 as they recirculate around the prescribed conveying path.

The cleaning solution injection station operates independently of the watering station elevating actuator assemblies 49. If the above conditions 6, 7, 8, and 9 are met the inlet glycol coupling actuator assembly 53 under PLC control moves the cleaning solution inlet coupler 118 in an upward direction relative to the Y-Axis of the prescribed conveying path until it couples with inlet cleaning solution coupler with non-return valve 158 mounted on the base of the cleaning tray cleaning solution pressure bladder tank 114 of the LED light bar cleaning tray assembly 21, the act of coupling causes the inlet cleaning solution coupler's non-return valve 158 to open, and the outlet glycol coupling actuator assembly 54 under PLC control moves the cleaning solution outlet coupler 120 in an upward direction relative to the Y-Axis of the prescribed conveying path until it couples with the outlet cleaning solution coupler with non-return valve 159 mounted on the base of the cleaning tray cleaning solution pressure bladder tank 114 of the LED light bar cleaning tray assembly 21, the act of coupling causes the outlet cleaning solution coupler's non-return valve 159 to open. cleaning solution can now be injected into the cleaning tray cleaning solution pressure bladder tank 114 flushing out the existing cleaning solution in the cleaning tray cleaning solution pressure bladder tank 114. Once the cleaning solution in the cleaning tray cleaning solution pressure bladder tank 114 has been exchanged, the inlet glycol coupling actuator assembly 53 under PLC control moves the cleaning solution inlet coupler 118 in a downward direction relative to the Y-Axis of the prescribed conveying path so that it de-couples from the inlet cleaning solution coupler with non-return valve 158, the act of de-coupling causes the inlet cleaning solution coupler's non-return valve 158 to close and the cleaning solution inlet coupler 118 is returned to its home position relative to the Y-Axis of the prescribed conveying path. Once the cleaning solution in the cleaning tray cleaning solution pressure bladder tank 114 has been exchanged, the outlet glycol coupling actuator assembly 54 under PLC control moves the cleaning solution outlet coupler 120 in a downward direction relative to the Y-Axis of the prescribed conveying path so that it de-couples from the outlet cleaning solution coupler with non-return valve 159, the act of de-coupling causes the outlet cleaning solution coupler's non-return valve 159 to close and the cleaning solution outlet coupler 120 is returned to its home position relative to the Y-Axis of the prescribed conveying path. The conveyor chains can now be restarted.

In another embodiment not detailed herein the watering station assembly 20 is mounted on slider mounts that slide on slider bars. One slider bar is bolted between two uprights on one side of the conveying frame 1 relative to the X-Axis of the prescribed conveying path, and one slider bar is bolted between two uprights on opposite side of the conveying frame 1 relative to the X-Axis of the prescribed conveying path. The watering station assembly stations 138 are removed from both sides of the conveyor. The sliders mounts are bolted to and support the watering station elevating actuator bodies 142 relative to the X-Axis of the prescribed conveying path. The watering station assembly 12 is positioned so that its Z-Axis centerline is aligned relative the Z-Axis centerline of the conveyor drive assembly 128, the watering station assembly 12 is positioned relative to the Y-Axis of the prescribed conveying path so that one or more plant retaining conveying tray assemblies 2 can recirculate around the watering station assembly 12 when locked onto the conveyor drive assembly's 128 conveying chains 26 unimpeded when the watering station assembly 12 is in its home position relative to the Y-Axis of the prescribed conveying path. The watering station assembly 12 is now free to slide on the slider bars relative to the X-Axis of the prescribed conveying path. Springs are mounted on the slider bars that cause the watering station 12 to return to its home position relative to the X-Axis of the prescribed conveying path if the watering station 12 is not being pulled away from its home position by a motive force. In this embodiment the watering station plinth 40 has three defined positions relative to the Y-Axis of the prescribed conveying path those being; the home position, the capture position, and the sample position. A capture bar is bolted to the watering station plinth 40 pointing toward the upper tier of conveying trays assemblies relative to the Y-Axis of the prescribed conveying path. The capture bar extends to an optimal height just above the plurality of probe slider fertigation injection probes 50 and the plurality of sensor needle tips 51 and 52 that point upwards relative to the Y-Axis of the prescribed conveying path. The base of the double skin tray 65 is modified, a capture bar penetration is machined into the base of the double skin tray 65 relative to the Y-Axis of the prescribed conveying path. The capture bar penetration is machined in a position in the base of the double skin tray 65 and is of sufficient diameter so that the capture bar can penetrate and move upwards trough the double skin tray 65, a half round capture node of sufficient strength is projected downwards from the machined penetration to sufficient depth to facilitate the capture of the capture bar, the half round node is aligned relative to the Z-Axis of the prescribed conveying path. The watering station assembly 12 is now operable to be captured by and to move when captured by a conveying tray assembly 2 locked on the conveying chains 26 and recirculating above and past the watering station 12 in the normal direction of travel. The base of the cleaning tray cleaning solution pressure bladder tank 114 is modified, a capture bar penetration is machined into the base of the cleaning tray cleaning solution pressure bladder tank 114 relative to the Y-Axis of the prescribed conveying path. The capture bar penetration is machined in a position in the cleaning tray cleaning solution pressure bladder tank 114 and is of sufficient diameter so that the capture bar can penetrate and move upwards trough the cleaning tray cleaning solution pressure bladder tank 114, a half round capture node of sufficient strength is projected downwards from the machined penetration to sufficient depth to facilitate the capture of the capture bar, the half round node is aligned relative to the Z-Axis of the prescribed conveying path. The watering station assembly 12 is now operable to be captured by and to move when captured by a conveying tray assembly 2 locked on the conveying chains 26 and recirculating above and past the watering station 12 in the normal direction of travel. The watering station assembly 12 is now operable to be captured by and to move when captured by a LED light bar cleaning tray assembly 21 locked on the conveying chains 26 and recirculating above and past the watering station 12 in the normal direction of travel. All other functionality of the watering station assembly 12 remains unchanged operating in the same manner as the fully described embodiment above. When fertigation injection and or rooting media sampling and or glycol flushing, or cleaning solution flushing is desired the watering station plinth 40 is moved upward relative to the Y-Axis of the prescribed conveying path to the capture position at a time just before a recirculating conveying tray assembly's 2 X-Axis centerline of the plurality of media holders 15 in the conveying tray assembly 2 arrives over the X-Axis centerline of the watering station assembly 12 the capture node then captures the capture bar when the X-Axis centerline of the plurality of media holders 15 in the conveying tray assembly 2 that is to capture the watering station assembly 12 is directly over the X-Axis centerline of the watering station assembly 12, or just before a recirculating LED light bar cleaning tray assembly's 21 X-Axis centerline arrives over the X-Axis centerline of the watering station assembly 12 the capture node then captures the capture bar when the X-Axis LED light bar cleaning tray assembly's 21 X-Axis centerline that is to capture the watering station assembly 12 is directly over the X-Axis centerline of the watering station assembly 12. At this point the watering station begins to move relative to the capturing conveying tray assembly 2 or relative to the capturing LED light bar cleaning tray assembly 21 under the motive power provided by the conveying chains 26 such that the X-Axis centerline of the plurality of media holders 15 in the capturing conveying tray assembly 2, or such that the X-Axis centerline of the capturing LED light bar cleaning tray assembly 21 remains directly over the X-Axis centerline of the watering station 12. The PLC the speed of the conveyor chains 26 can be reduced to a speed that the PLC calculates allows for completion of the tasks to be performed before the watering station assembly reaches the end of travel limit along the conveying bars relative to the X-Axis of the prescribed conveying path. Once the watering station assembly 12 has moved away from its slider home position relative to the X-Axis of the prescribed conveying path the PLC based upon the tasks to be performed can either raise as long as the above conditions 1, 2, 3, 4 and 5 are met and a conveying tray assembly 2 has captured the watering station assembly 2 the two watering station elevating actuator assemblies 49 under PLC control move the watering station plinth 40 in an upward direction relative to the Y-Axis of the prescribed conveying path to the sample position where fertigation, rooting media sampling, and glycol flushing can be performed, or keep the water station plinth at the capture position and as long as the above conditions 1, 2, and 3 are met raise the inlet glycol coupler 55 and raise the outlet glycol coupler 56 to perform independent glycol flushing if a conveying tray assembly 2 has captured the watering station assembly, or as long as the above conditions 3, 6, 7, 8, and 9 are met raise the cleaning solution inlet coupler 118 and cleaning solution outlet coupler 120 to perform independent cleaning solution flushing if a LED light bar cleaning tray assembly 21 has captured the watering station assembly 2. When the assigned tasks have been performed and before the watering station assembly reaches the travel limit along the conveying bars relative to the X-Axis of the prescribed conveying path. The PLC will lower the watering station plinth 40 to its home position and if necessary lower the inlet glycol coupler 55 and the to its home position and lower the outlet glycol coupler 56 to its home position and if necessary lower the cleaning solution inlet coupler 118 and the to its home position and lower the cleaning solution outlet coupler 120 to its home position. When the watering station plinth 40 moves away from the capture position towards the move position the capture bar is released and the watering station assembly 12 is driven to the home position relative to the X-Axis of the conveyor path by the springs mounted on the slider bars. The watering station assembly 12 is now ready to service another conveying tray assembly 2 or LED light bar cleaning tray assembly 21 if desired.

In another embodiment not detailed herein the watering station assembly 20 will be mounted on a dedicated mechanical drive system with absolute position feedback operable to move the watering station assembly 20, from a first position “Home”, where the watering station assembly 20 is parked at one end of at least one stationary conveyor drive assembly generally designated 128 relative to the x-axis of the conveying path and aligned with relative to the X-Axis and Z-Axis a conveying tray assembly generally designated 2 which is coupled to the said at least one stationary conveyor drive assembly generally designated 128 and remote from the said conveying tray assembly generally designated 2 relative to the Y-Axis, said conveying tray assembly generally designated 2 a plurality of conveying tray assemblies generally designated 2 are also connected to the said at least one stationary conveyor drive assembly generally designated 128 said plurality of conveying tray assemblies generally designated 2 are positioned offset from one another along and coupled to the the said at least one stationary conveyor drive assembly generally designated 128 relative to the x-axis of the conveying path, the position of the plurality of conveying tray assemblies generally designated 2 is known to the PLC, to a second position “End of Travel” where the watering station assembly 20 is parked at the other end of the said at least one stationary conveyor drive assembly generally designated 128 relative to the x-axis of the conveying path and aligned with relative to the X-Axis and Z-Axis the last relative to the “Home” position of the said the plurality of conveying tray assemblies generally designated 2 that are positioned offset from one another along and coupled to the the said at least one stationary conveyor drive assembly generally designated 128 conveying path relative to the x-axis of the conveying tray assembly generally designated 2 which is coupled to the said at least one stationary conveyor drive assembly, the two watering station elevating actuator assemblies 49 under PLC control can now move the watering station plinth 40 in an upward direction relative to the Y-Axis of the prescribed conveying path to the sample position where fertigation, rooting media sampling, and glycol flushing can be performed, or keep the water station plinth at the capture position and as long as the above conditions 1, 2, and 3 are met raise the inlet glycol coupler 55 and raise the outlet glycol coupler 56 to perform independent glycol flushing if a conveying tray assembly 2 has captured the watering station assembly. When the assigned tasks have been performed the PLC will lower the watering station plinth 40 to its home position and if necessary lower the inlet glycol coupler 55 and the to its home position and lower the outlet glycol coupler 56 to its home. The watering station assembly 20 mounted on the said dedicated mechanical drive system with absolute position feedback is now operable to move the watering station assembly 20, from the said second position “End of Travel”, where the watering station assembly 20 is parked at the other end of the said at least one stationary conveyor drive assembly generally designated 128 relative to the x-axis of the conveying path and aligned with relative to the X-Axis and Z-Axis the last relative to the “Home” position, of the said the plurality of conveying tray assemblies generally designated 2 that are positioned offset from one another along and coupled to the the said at least one stationary conveyor drive assembly generally designated 128 conveying path relative to the x-axis of the conveying tray assembly generally designated 2 to a indefinite position “Index1” underneath another of the said the plurality of conveying tray assemblies generally designated 2 that are positioned offset from one another along and coupled to the the said at least one stationary conveyor drive assembly generally designated 128 conveying path relative to the x-axis of the conveying tray assembly generally designated 2 where the watering station assembly 20 is parked when aligned with relative to the X-Axis and Z-Axis the said another of the said the plurality of conveying tray assemblies generally designated 2 and the two watering station elevating actuator assemblies 49 under PLC control can now move the watering station plinth 40 in an upward direction relative to the Y-Axis of the prescribed conveying path to repeat the fertigation, rooting media sampling, and glycol flushing sequences when the assigned tasks have been performed the PLC will lower the watering station plinth 40 to its home position and if necessary lower the inlet glycol coupler 55 and the to its home position and lower the outlet glycol coupler 56 to its home. The watering station assembly 20 mounted on the said dedicated mechanical drive system with absolute position feedback is now operable to move the watering station assembly 20, from the said indefinite position “Index1”, to another position indefinite position “Index2” underneath another of the said the plurality of conveying tray assemblies generally designated 2 that are positioned offset from one another along and coupled to the the said at least one stationary conveyor drive assembly generally designated 128 conveying path relative to the x-axis of the conveying tray assembly generally designated 2 where the watering station assembly 20 is parked when aligned with relative to the X-Axis and Z-Axis another of the said the plurality of conveying tray assemblies generally designated 2, or return the watering station assembly 20, from the said indefinite position “Index1”, to the said first position “Home” position underneath another of the said the plurality of conveying tray assemblies generally designated 2 that are positioned offset from one another along and coupled to the the said at least one stationary conveyor drive assembly generally designated 128 conveying path relative to the x-axis of the conveying tray assembly generally designated 2 where the watering station assembly 20 is parked when aligned with relative to the X-Axis and Z-Axis another of the said the plurality of conveying tray assemblies generally designated 2 where the watering station assembly 20 is parked at one end of at least one stationary conveyor drive assembly generally designated 128 relative to the x-axis of the conveying path. In another embodiment which is like the one described above except that the said at least one stationary conveyor drive assembly generally designated 128 is obviated and the said plurality of conveying tray assemblies generally designated 2 are positioned offset from one another along the and supported by and bolted to the conveying frame 1. The watering station assembly 20 will be mounted on a dedicated mechanical drive system with absolute position feedback and all functionality remains as described above.

In other embodiments of the watering station assembly 20 the number of probe slider assemblies 140 will be changed to match the number of media holders 15 contained in the conveying tray assembly 2 at least one stationary conveyor drive assembly generally designated 128 is obviated and the

In one embodiment the watering station assembly 20 the plurality of probe slider assemblies 140 relative to the X-Axis and Z-Axis will be decoupled from the plurality of fertigation injection probes 50 and sensors 51 and 52, a floating plinth relative to the X-Axis and Z-Axis of the prescribed conveying path will be installed on the top surface relative to the Y-Axis of the prescribed conveying path the plurality of probe slider assemblies 140 and the plurality of fertigation injection probes 50 and sensors 51 and 52 will be attached to the floating plinth to allow for a less precise alignment relative to the X-Axis and Z-Axis of the plurality of fertigation injection probes 50 and sensors 51 and 52 when the plurality of fertigation injection probes 50 and sensors 51 and 52 move towards the conveyor tray assembly 2 located directly above the watering station and pass through slots cut in the base of the its double skin tray 65 and pass through a plurality of media holder fertigation injection probe or sensor penetrations 133.

In one embodiment the watering station assembly 20 the plurality of probe slider assemblies 140 are decoupled from the plurality of fertigation injection probes 50 and sensors 51 and 52, said plurality of fertigation injection probes 50 and sensors 51 and 52 will be permanently installed into each media holder 15 contained in the conveying tray assembly 2 and operable so that when a rooting media is installed into a media holder 15 the plurality of fertigation injection probes 50 and sensors 51 and 52 are contained within the rooting media, the plurality of fertigation injection probes 50 and sensors 51 and 52 may now be manually or automatically coupled with and decoupled from the watering station 12 the plurality of fertigation injection probes 50 and sensors 51 and 52 will then be operable to perform their tasks as herein defined.

In one embodiment the watering station assembly 20 the plurality of probe slider assemblies 140 with be moved manually to the desired offset positions, manual locks will be provided to keep the plurality of probe slider assemblies 140 in the desired offset positions when the plurality of probe slider assemblies 140 are not being moved.

In one embodiment a plurality of watering station assemblies 12 will be mounted at different locations around the prescribed conveying path.

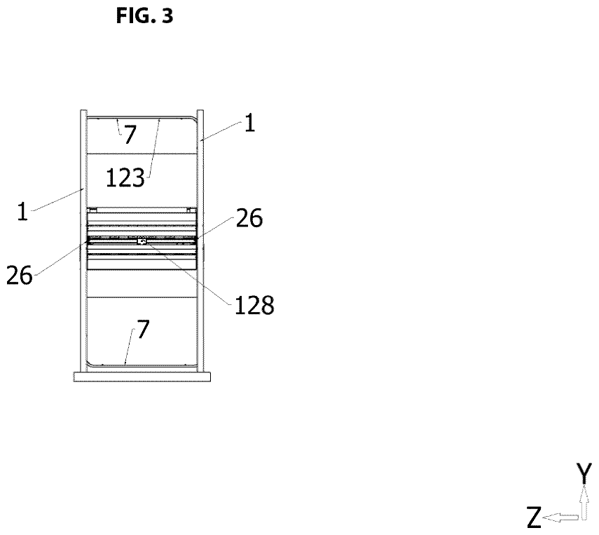

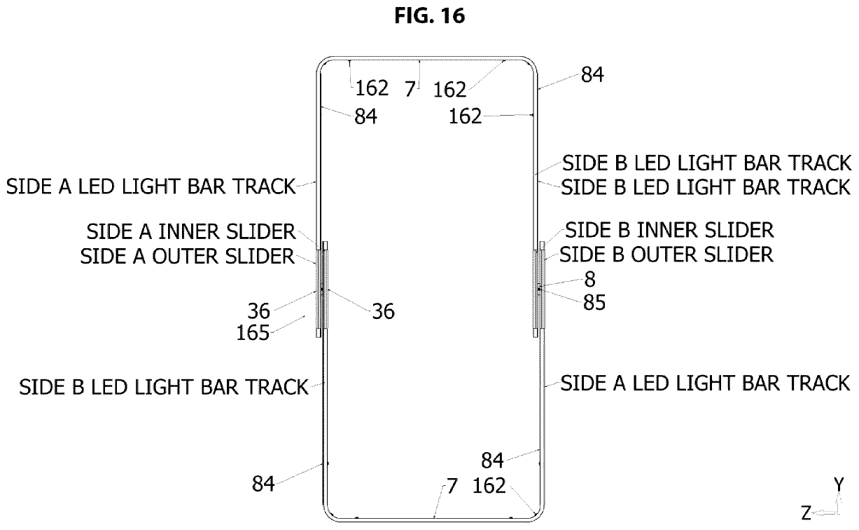

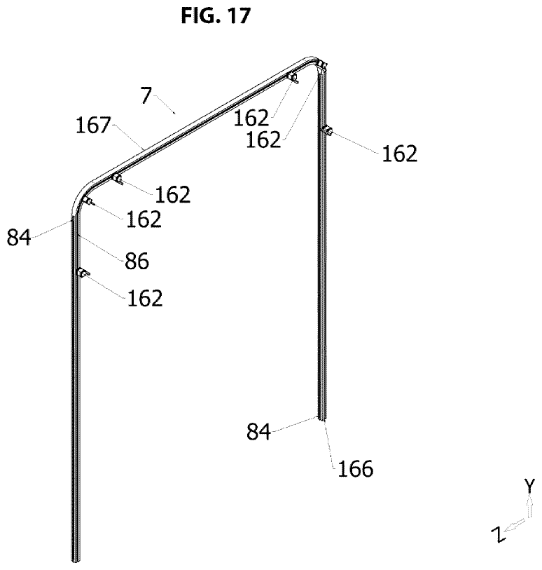

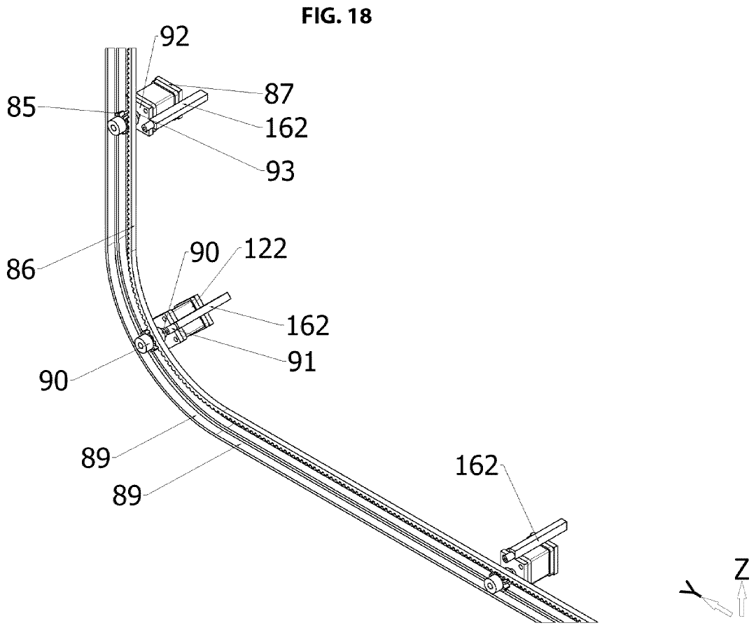

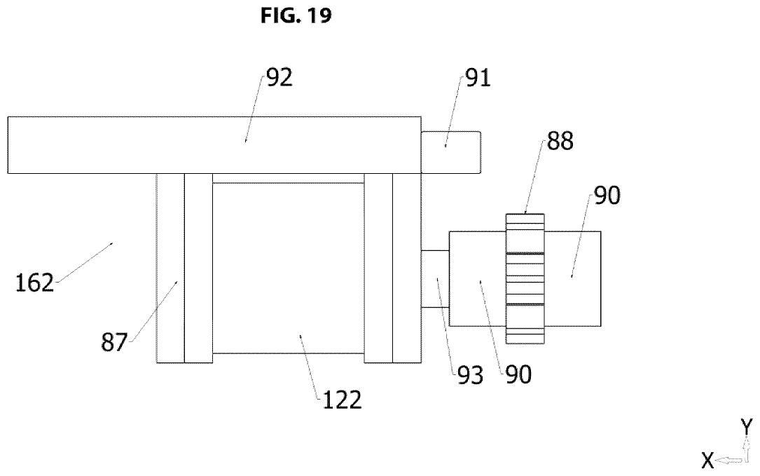

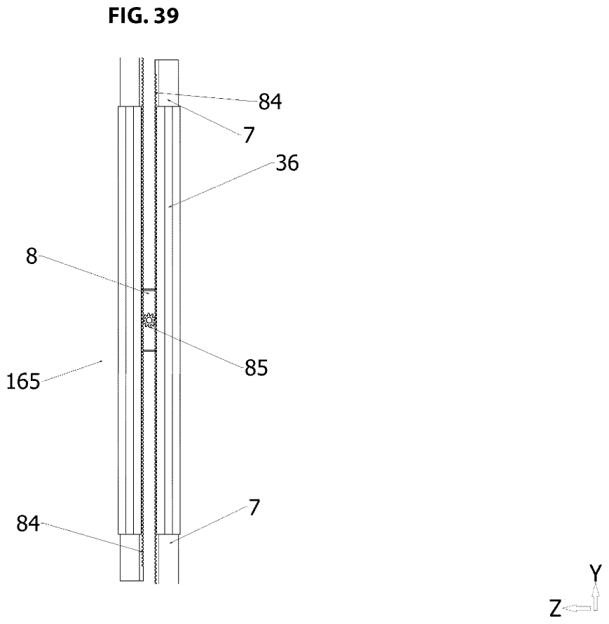

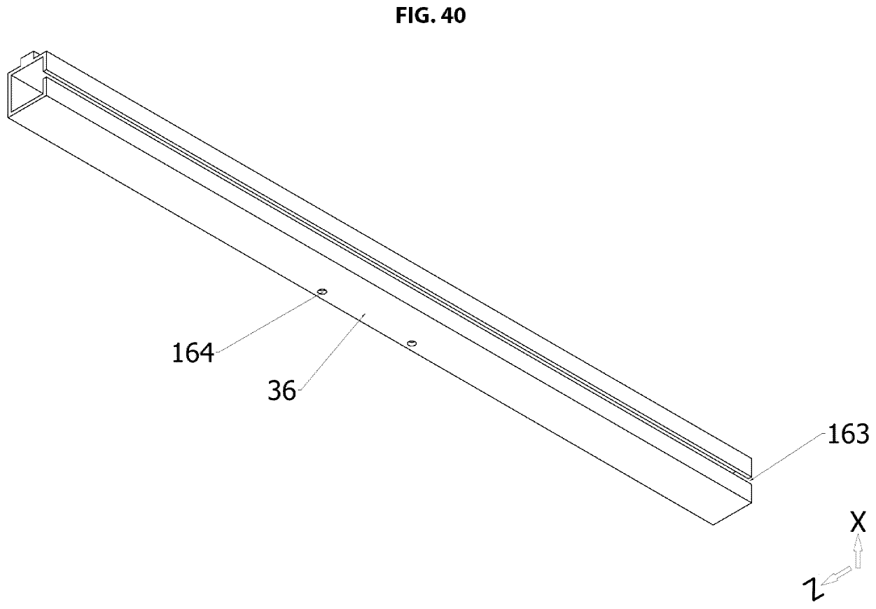

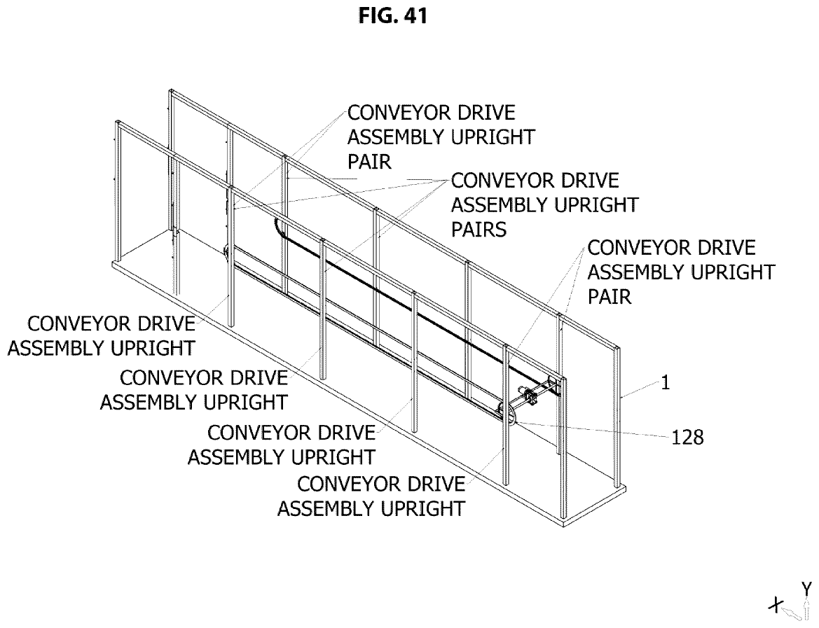

The recirculating plant growing mechanism may have at least one LED light bar assembly 123 see FIG. 1, FIG. 2, FIG. 3, FIG. 15, and FIG. 39. The LED light bar assembly 123 constrains a plurality of LED light bars 6 see FIG. 1, see FIG. 2, and FIG. 15 between a plurality of LED light bar height adjustment assemblies 165 see FIG. 1, FIG. 2, FIG. 15, and FIG. 39. The plurality of LED light bars 6 are mounted on a plurality of LED light bar stepper motor assemblies 162 see FIG. 15, FIG. 17, FIG. 18, and FIG. 19. The plurality of light bar stepper motor assemblies 162 are mounted on the plurality of LED light bar track assemblies 7 see FIG. 17. The plurality of LED light bar track assemblies 7 are constrained by a plurality of LED light bar track sliders 35 see FIG. 1, FIG. 2, FIG. 15, and FIG. 39. The plurality of LED light bar track sliders 35 are mounted on the Z-Axis faces of conveying drive assembly uprights see FIG. 41 that are members of consecutive conveyor drive assembly upright pairs see FIG. 41. In the embodiment herein described a LED light bar height adjustment assembly 165 see FIG. 15, FIG. 16, and FIG. 39 is assembled in the following manner, with reference to FIG. 16 and FIG. 41; “Side A” Outer Slider” LED light bar track slider 36 and “Side A Inner Slider” LED light bar track slider 36 are mounted on and bolted to the Z-Axis faces of one of the “Conveying Drive Assembly Upright Pairs”, “Side B” Outer Slider” LED light bar track slider 36 and “Side B Inner Slider” LED light bar track slider 36 are mounted on and bolted to the Z-Axis faces of the other “Conveying Drive Assembly Upright Pairs”, “Side A” Outer Slider” LED light bar track slider 36, “Side A Inner Slider” LED light bar track slider 36, “Side B” Outer Slider” LED light bar track slider 36 and “Side B Inner Slider” LED light bar track slider 36 are mounted on and bolted to the Z-Axis faces of the “Conveying Drive Assembly Upright Pairs” so that their Y-Axis centerlines are aligned with the Y-Axis centerline of the conveyor drive assembly 128, “Side A” Outer Slider” LED light bar track slider 36 and “Side A Inner Slider” LED light bar track slider 36 are mounted so that their LED light bar track slider light bar track rack slots 163 see FIG. 40, face each other relative to the Z-Axis of the prescribed conveying path see FIG. 15, FIG. 16, and FIG. 39, “Side B” Outer Slider” LED light bar track slider 36 and “Side B Inner Slider” LED light bar track slider 36 are mounted so that their LED light bar track slider light bar track rack slots 163 see FIG. 40, face each other relative to the Z-Axis of the prescribed conveying path see FIG. 15, FIG. 16, and FIG. 39, a LED light bar track stepper motor 8 see FIG. 1, FIG. 2, FIG. 15, FIG. 16, and FIG. 39 with an attached LED light bar track stepper motor pinion gear 85 see FIG. 16, and FIG. 39 is mounted on and bolted to the LED light bar track slider light bar track stepper motor threaded penetrations 164 see FIG. 40 machined into the “Side A” Outer Slider” LED light bar track slider 36 and the “Side A Inner Slider” LED light bar track slider 36, a LED light bar track stepper motor 8 with an attached LED light bar track stepper motor pinion gear is mounted on and bolted to the LED light bar track slider light bar track stepper motor threaded penetrations 164 machined into the “Side B” Outer Slider” LED light bar track slider 36 and the “Side A Inner Slider” LED light bar track slider 36. “Side A” of a LED light bar track assembly 7 with its attached LED light bar track rack 84 see FIG. 15, FIG. 16, and FIG. 39 is inserted into the top of the “Side A Outer Slider” LED light bar track slider 36 relative to the Y-Axis of the prescribed conveying path, “Side A” of the LED light bar track assembly's 7 attached LED light bar track rack 84 now protrudes from the “Side A Outer Slider” LED light bar track slider's 36 LED light bar track slider light bar track rack slot see FIG. 40, “Side A” of the LED light bar track assembly's 7 attached LED light bar track rack 84 is then meshed with the LED light bar track stepper motor pinion gear 85, “Side B” of the LED light bar track assembly 7 with its attached LED light bar track rack 84 is inserted into the top of the “Side B inner Slider” LED light bar track slider 36 relative to the Y-Axis of the prescribed conveying path, “Side B” of the LED light bar track assembly's 7 attached LED light bar track rack 84 now protrudes from the “Side B inner Slider” LED light bar track slider's 36 LED light bar track slider light bar track rack slot, “Side B” of the LED light bar track assembly's 7 attached LED light bar track rack 84 is then meshed with the LED light bar track stepper motor pinion gear 85. “Side B” of a LED light bar track assembly 7 with its attached LED light bar track rack 84 is inserted into the bottom of the “Side A inner Slider” LED light bar track slider 36 relative to the Y-Axis of the prescribed conveying path, “Side B” of the LED light bar track assembly's 7 attached LED light bar track rack 84 now protrudes from the “Side A inner Slider” LED light bar track slider's 36 LED light bar track slider light bar track rack slot, “Side B” of the LED light bar track assembly's 7 attached LED light bar track rack 84 is then meshed with the LED light bar track stepper motor pinion gear 85, “Side A” of a LED light bar track assembly 7 with its attached LED light bar track rack 84 is inserted into the bottom of the “Side B outer Slider” LED light bar track slider 36 relative to the Y-Axis of the prescribed conveying path, “Side A” of the LED light bar track assembly's 7 attached LED light bar track rack 84 now protrudes from the “Side B outer Slider” LED light bar track slider's 36 LED light bar track slider light bar track rack slot, “Side A” of the LED light bar track assembly's 7 attached LED light bar track rack 84 is then meshed with the LED light bar track stepper motor pinion gear 85, the LED light bar height adjustment assembly 165 is now complete. The companion LED light bar height adjustment assembly 165 that will be attached to the other “Conveyor Drive Assembly Upright Pair” of the “Consecutive Conveyor Drive Assembly Upright Pair” is the mirror of the LED light bar height adjustment assembly 165 relative to the Z-Axis centerline of the “Conveyor Drive Assembly Upright Pair”. The LED light bar track assembly 7 provides the support for at least one LED light bar stepper motor assembly 162 see FIG. 1, FIG. 2, FIG. 15, FIG. 16, FIG. 17, FIG. 18, and FIG. 19. The LED light bar track 167 see FIG. 17 provides a u-shaped path about which the at least one LED light bar stepper motor assembly 162 travels relative to the Z-Axis and Y-Axis of the prescribed conveying path. The LED light bar track 167 is hollow see FIG. 17. FIG. 18 depicts the inner components of the LED light bar track assembly 7. The LED light bar stepper motor rack 86 see FIG. 18 and FIG. 19 is are attached and fixed to the LED light bar track's 167 hollow inner wall. The LED light bar stepper motor rack 86 prescribes the same relative path as that prescribed by the LED light bar track 167. The two LED light bar stepper motor support tracks 89 see FIG. 18 are attached and fixed to the LED light bar track's 167 hollow inner wall, sufficient spacing is provided between the two LED light bar stepper motor support tracks 89 relative to the X-Axis of the prescribed conveying path to allow the LED light bar stepper motor pinion gear 88 see FIG. 18 and FIG. 19 to rotate between the two LED light bar stepper motor support tracks 89. The two LED light bar stepper motor support tracks 89 prescribe the same relative path as that prescribed by the LED light bar track 167. The LED light bar stepper motor pinion gear 88 is attached and fixed to LED light bar stepper motor's 122 see FIG. 18, and FIG. 19 drive shaft. The LED light bar stepper motor's 122 drive shaft penetrates the LED light bar track 167 through the LED light bar track slot 166 see FIG. 17 machined into one of the Z-Axis faces of LED light bar track 167. The two LED light bar stepper motor support bearings 90 see FIG. 18 are attached and fixed to the LED light bar stepper motor's 122 drive shaft on either side of the LED light bar stepper motor pinion gear 88 relative to the X-Axis of the prescribed conveying path, the LED light bar stepper motor support bearing 90 mounted between the LED light bar stepper motor and the LED light bar stepper motor pinion gear 88 is termed the “Inner Bearing”. The LED light bar stepper motor pinion gear 88 is meshed to the LED light bar stepper motor rack 86 in the following manner; the two LED light bar stepper motor support bearings 90 push against the two LED light bar stepper motor support tracks 89 relative to the Z-Axis supporting the LED light bar stepper motor assembly 162 meshing the LED light bar stepper motor pinion gear 88 with the LED light bar stepper motor rack 86 as the LED light bar stepper motor assembly 162 travels around the path prescribed by the LED light bar track 167. The LED light bar stepper motor assembly 162 is supported and held perpendicular to the Y-Axis of the prescribed conveying path by the mechanical interaction between two LED light bar stepper motor support bearings 90 and the LED light bar stepper motor pinion gear 88. The LED light bar stepper motor assembly 162 is fixed in place inside the LED light bar track 167 by the interaction between the “Inner Bearing” whose diameter is greater than the width of the LED light bar track slot 166. A LED light bar stepper motor Mount 92 see FIG. 18, and FIG. 19 mounted on and bolted to the drive shaft end Z-Axis face of the LED light bar stepper Motor 122 see FIG. 18, and FIG. 19. The LED light bar stepper motor mount 92 has a stub axle machined on its Z-Axis face. A LED light bar stepper track following bearing 91 see′ FIG. 18, and FIG. 19 is mounted on and fixed to the LED light bar stepper motor mount's 92 stub axle. The LED light bar stepper track following bearing 91 is mounted in a position whereby when the LED light bar stepper motor assembly 162 is installed on the LED light bar track 167 it pinches the inner outside face of the LED light bar track 167. The LED light bar stepper track following bearing 91 causes the LED light bar 6 when mounted on and bolted to LED light bar stepper motor assembly 162 to always point the LED light bar 6 LEDs at directly at the plant canopy irrespective of the LED light bar stepper motor assembly's 162 position on the LED light bar track 167 relative to the X-Axis and Y-Axis of the conveying. In the embodiment described herein the number of LED light bar stepper motor assembly's 162 operating within each of the two LED light bar track assemblies 7 that are mounted in each of two LED light bar height adjustment assemblies 165 that are mounted in the LED light bar assembly 123 is six. The number of LED light bars 6 mounted in the LED light bar assembly 123 is twelve. An LED light bar 6 is mounted on and bolted to one of the LED light bar stepper motor assemblies 162 at one end of the “Consecutive Conveyor Drive Assembly Upright Pairs” the opposite end of the of the same LED light bar 6 is mounted on and bolted to the corresponding and mirrored relative to the X-Axis centerline between the “Consecutive Conveyor Drive Assembly Upright Pairs” LED light bar stepper motor assemblies 162. The twelve LED light bars 6 are operable to travel around the u-shaped path prescribed by the twelve LED light bar's 6 associated pair of LED light bar tracks 167 relative the Z-Axis and Y-Axis of the prescribed conveying path under PLC control. Each LED light bar stepper motor assemblies 162 provides the PLC with absolute position feedback relative the Z-Axis and Y-Axis of the prescribed conveying path so precise positioning of LED light bar's 6 around the plant canopy is possible. The two LED light bar stepper motor assembly's 162 connected at either end of each LED light bar 6 are always moved contemporaneously and at the same speed by the PLC around the u-shaped path prescribed by the associated pair of LED light bar tracks 167 relative the Z-Axis and Y-Axis of the prescribed conveying path thus the two LED light bar stepper motor assemblies 162 are always in the same relative, but mirrored relative to the X-Axis centerline, positions on the associated pair of LED light bar tracks 167 relative the Z-Axis and Y-Axis of the prescribed conveying path. The two LED light bar height adjustment assembly's 165 are operable under the motive power of the four LED light bar track stepper motors 8 to vary the horizontal component distance from the X-Axis centerline of the conveyor drive assembly 128 of the four LED light bar track assemblies 7 relative the Y-Axis of the prescribed conveying path that are mounted in the LED light bar assembly 123. The four LED light bar track stepper motors 8 are always moved contemporaneously and at the same speed by the PLC so that the horizontal component distance from the X-Axis centerline of the conveyor drive assembly 128 to each of the four LED light bar track assemblies 7 relative the Y-Axis is always equal. Each of the four LED light bar track stepper motors 8 provide the PLC with absolute position feedback of the horizontal component distance from the X-Axis centerline of the conveyor drive assembly 128 to each of the four LED light bar track assemblies 7 relative the Y-Axis. The LED light bars 6 energy output PPFD can be varied under PLC control combining this feature with LED light bars 6 height and position adjustment relative to the plant canopy, and X-Axis Z Axis plant spacing capabilities described herein offers significant electrical energy savings over typical cultivation techniques.

In another embodiment one light bar height adjustment assembly 165 will be mounted at the X-Axis centerline between the “Consecutive Conveyor Drive Assembly Upright Pairs”. The at least one light bar height adjustment assembly 165 LED will contain at least one light bar track assembly 7 between the “Conveyor Drive Assembly Upright Pairs” and at least one LED light bar stepper motor assembly 162 will be mounted on the at least one light bar track assembly 7. At least one LED light bar 6 will be mounted on the at least one LED light bar stepper motor assembly 162.

In another embodiment the LED light bar track's a u-shaped path will be modified to any chosen path shape that more adequately fits the crop's canopy profile.

In another embodiment the LED light bars 6 are substituted for other lighting technologies and or other LED light bars and the LED light bar assembly 123 is redesigned accordingly.

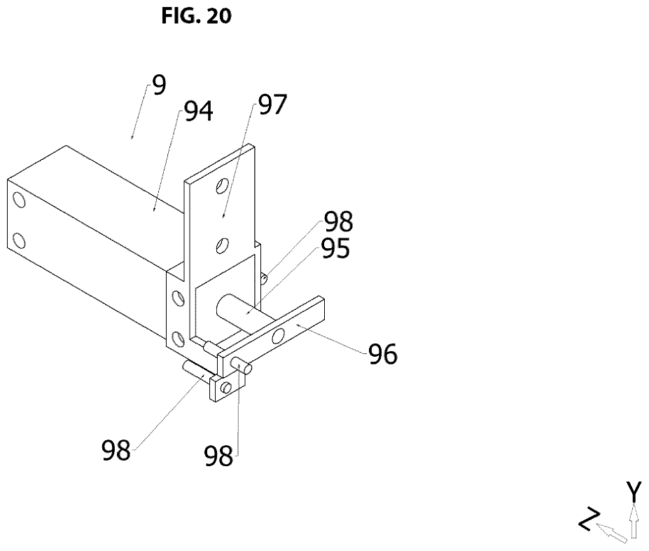

The recirculating plant growing mechanism may have at least one conveying tray de-coupling assembly 9 see FIG. 1, FIG. 2, FIG. 11, and FIG. 20. In the embodiment describe herein two tray de-coupling assemblies 9 are mounted on and bolted to the sides of the upper horizontal conveying chain guide rails 25 see FIG. 1, FIG. 2, FIG. 11, and FIG. 20 of the conveyor drive assembly 128 one on each side of the conveyor drive assembly 128. The two tray de-coupling assemblies 9 Y-Axis centerlines are aligned with each across the conveyor drive assembly 128 relative to the X-Axis of the prescribed conveying path. The two tray de-coupling assemblies 9 tray de-coupler unlocking plates 96 see FIG. 20 face each other cross the conveyor drive assembly 128 relative to the X-Axis of the prescribed conveying path. Each tray de-coupler unlocking plate 96 is mounted on its associated 2-inch actuator shaft 95 see FIG. 20, Each 2-inch actuator body 94 see FIG. 20 is operable to move under PLC control its associated 2-inch actuator shaft 95 and thus its tray de-coupler unlocking plate 96 from a fully retracted position relative to the Z-Axis of the prescribed conveying path wherein the tray de-coupler unlocking plate 96 is positioned against the shaft end of the 2-inch actuator body 94 relative to the Z-Axis of the prescribed conveying path to a fully extended position relative to the Z-Axis of the prescribed conveying path. The two tray de-coupling assemblies 9 are mounted on the upper horizontal guide rails 25 of the conveyor drive assembly relative to the Y-Axis of the prescribed conveying path so that their tray de-coupler unlocking plates 96 pass just under the bottom of the upper horizontal guide rails 25 when the tray de-coupler unlocking plates 96 are retracted or extended. The conveyor drive assembly's 128 conveying chains 26 can only be recirculated when the when the tray de-coupler unlocking plates 96 are fully retracted or if the tray de-coupler unlocking plates 96 are fully extended and have “Captured”, see below, a conveying tray assembly 2. The two tray de-coupling assemblies 9 are operable as follows; The tray de-coupler unlocking plates 96 are aligned relative to the X-Axis and Y-Axis of the prescribed conveying path when a conveying tray assembly 2 that is locked onto the conveyor drive assembly's 128 conveying chains 26 and recirculated along the top tier of the conveyor drive assembly's 128 conveying chains 26 until the X-Axis centerline of a conveying tray is aligned with the X-Axis centerlines of the two tray de-coupling assemblies 9 if the conveyor drive assembly's 128 conveying chains 26 are then stopped by the PLC and then the two tray de-coupling assemblies, 9 tray de-coupler unlocking plates 96 are moved by the PLC to their fully extended positions relative to the Z-Axis of the prescribed conveying path causing both of the tray chain locks 70 to move to their unlocked positions, the conveying tray assembly 2 is now unlocked from the conveyor drive assembly's 128 conveying chains 26 and the conveying tray assembly 2 is “Captured” by the two tray de-coupling assemblies 9 tray de-coupler unlocking plates 96. The conveyor drive assembly's 128 conveying chains 26 may now be recirculated until the chosen chain links upon which the conveying tray assembly 2 is to be locked X-Axis centerlines are aligned with the X-Axis centerlines of the two tray de-coupling assemblies 9 the PLC now stops the conveyor drive assembly's 128 conveying chains 26 and the PLC now the two tray de-coupling assemblies 9 tray de-coupler unlocking plates 96 are moved by the PLC to their fully retracted positions relative to the Z-Axis of the prescribed conveying path causing both of the tray chain locks 70 to move to their locked positions, the conveying tray assembly 2 is now locked on the conveyor drive assembly's 128 conveying chains 26 and the conveyor drive assembly's 128 conveying chains 26 can be restarted.

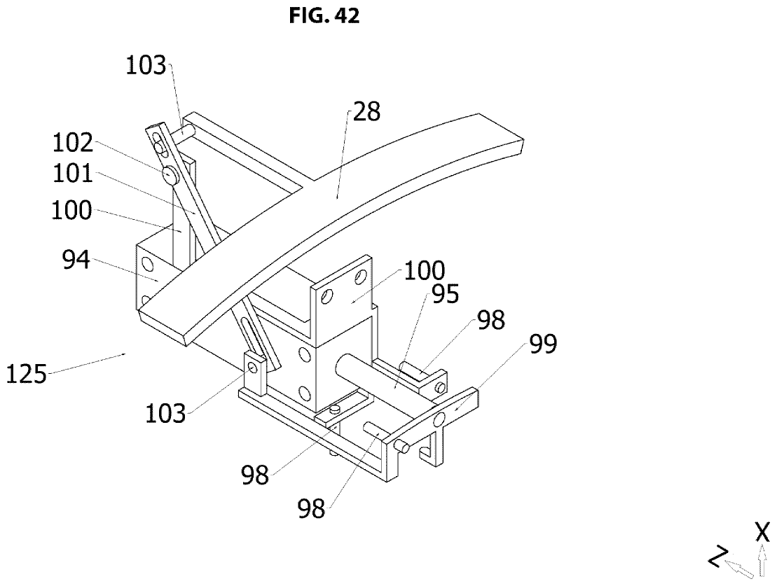

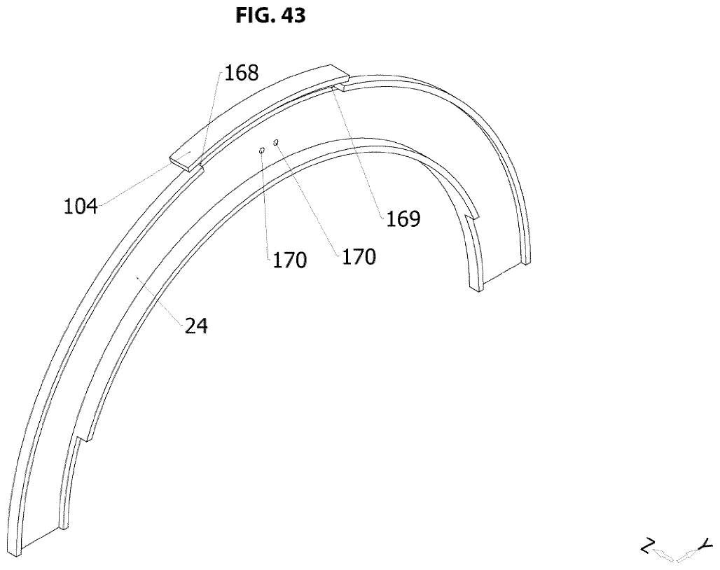

The recirculating plant growing mechanism may have at least one exit gate mechanism comprised of an at least one exit gate assembly 125 see FIG. 1, FIG. 2, FIG. 11, FIG. 22, and FIG. 42 mounted on and bolted to the side of the at least one modified 180 degree conveying chain guide rail 24 see FIG. 1, FIG. 2, FIG. 11, FIG. 22, FIG. 42, and FIG. 43. In the embodiment describe herein the two exit gate assemblies 125 are mounted on and bolted to the sides of two modified 180 degree conveying chain guide rails 24 of the conveyor drive assembly 128 one on each side of the conveyor drive assembly 128 relative to the Z-Axis of the prescribed conveying path. The two exit gate assemblies' 125 exit gate tray de-coupler unlocking plates 99 see FIG. 11, FIG. 22, and FIG. 42 are shown in the fully extended position. The two exit gate assemblies 125 X-Axis centerlines are aligned with each across the conveyor drive assembly 128 relative to the Z-Axis of the prescribed conveying path. The two exit gate assemblies' 125 exit gate tray de-coupler unlocking plates 99 see FIG. 11, FIG. 22, and FIG. 42 face each other cross the conveyor drive assembly 128 relative to the Z-Axis of the prescribed conveying path. Each exit gate tray de-coupler unlocking plate 99 is mounted on its associated 2-inch actuator shaft 95 see FIG. 22, and FIG. 42. Each 2-inch actuator body 94 see FIG. 11, FIG. 22, and FIG. 42 is operable to move under PLC control its associated 2-inch actuator shaft 95 see FIG. 22, and FIG. 42 and thus its exit gate tray de-coupler unlocking plate 99 from a fully retracted position relative to the X-Axis of the prescribed conveying path wherein the exit gate tray de-coupler unlocking plate 99 is positioned against the shaft end of the 2-inch actuator body 94 relative to the Z-Axis of the prescribed conveying path to a fully extended position relative to the Z-Axis of the prescribed conveying path. The two exit gate assemblies 125 are mounted on the two modified 180 degree conveying chain guide rails 24 of the conveyor drive assembly relative to the Z-Axis of the prescribed conveying path so that their exit gate tray de-coupler unlocking plates 99 pass just under the inner side relative to the Z-Axis of the prescribed conveying path of the two modified 180 degree conveying chain guide rails 24 when the tray de-coupler unlocking plates 96 are retracted or extended. Both exit gate assemblies 125 are assembled in the following manner; an exit gate lever arm 101 see FIG. 22, and FIG. 42 is connected at one end to the exit gate tray de-coupler unlocking plate 99 relative to the Z-Axis of the prescribed conveying path by an exit gate lever arm pin 103 see FIG. 22, and FIG. 42, the exit gate lever arm 101 is connected at its other end to the conveying tray exit gate 28 see FIG. 11, FIG. 22, and FIG. 42 relative to the Z-Axis of the prescribed conveying path by an exit gate lever arm pin 103 see FIG. 22, and FIG. 42. The exit gate lever arm 101 is mounted under the exit gate slide plate 104 see FIG. 22, FIG. 42, and FIG. 43 relative to the Z-Axis of the prescribed conveying path and in the exit gate opening for the conveying tray exit gate 169 see FIG. 43 machined through the outer face and inner face of the modified 180 degree conveying chain guide rail 24 the relative to the X-Axis of the prescribed conveying path. The exit gate lever arm 101 rotates relative to the Z-Axis of the prescribed conveying path around the exit gate lever arm fulcrum pin 102 see FIG. 22, and FIG. 42 when the exit gate tray de-coupler unlocking plate 99 is extended or retracted. When the exit gate tray de-coupler unlocking plate 99 is fully extended the conveying tray exit gate 28 is fully retracted relative to the Z-Axis of the prescribed conveying path and the exit gate opening for conveying tray assembly removal 168 see FIG. 43 machined into the outer face of the modified 180 degree conveying chain guide rail 24 the relative to the Z-Axis of the prescribed conveying path is open allowing for the removal from the conveyor drive assembly's 128 conveying chains 26 of a conveying tray assembly or a 2 or a LED light bar cleaning tray assembly 21 or the insertion of a conveying tray assembly 2 or a LED light bar cleaning tray assembly 21. When the exit gate tray de-coupler unlocking plate 99 is fully retracted the conveying the tray exit gate 28 is fully extended relative to the Z-Axis of the prescribed conveying path and the exit gate opening for conveying tray assembly removal 168 see FIG. 43 machined into the outer face of the modified 180 degree conveying chain guide rail 24 the relative to the Z-Axis of the prescribed conveying path is closed, and operable to support the conveying tray assemblies 2 guide rail bearings 67 see FIG. 7, FIG. 8, and FIG. 9 which assist in supporting conveying tray assemblies 2 that a are locked onto the conveyor drive assembly's 128 two conveying chains 26, and are recirculating along the bottom tier see FIG. 27 of the conveyor drive assembly's 128 two conveying chains 26, and are operable to support a LED light bar cleaning tray assembly's 21 guide rail bearings 67 see FIG. 4, FIG. 6, and FIG. 38 which assist in supporting a LED light bar cleaning tray assembly's 21 that is locked onto the conveyor drive assembly's 128 two conveying chains 26 and is recirculating along the bottom tier see FIG. 27 of the conveyor drive assembly's 128 two conveying chains 26.

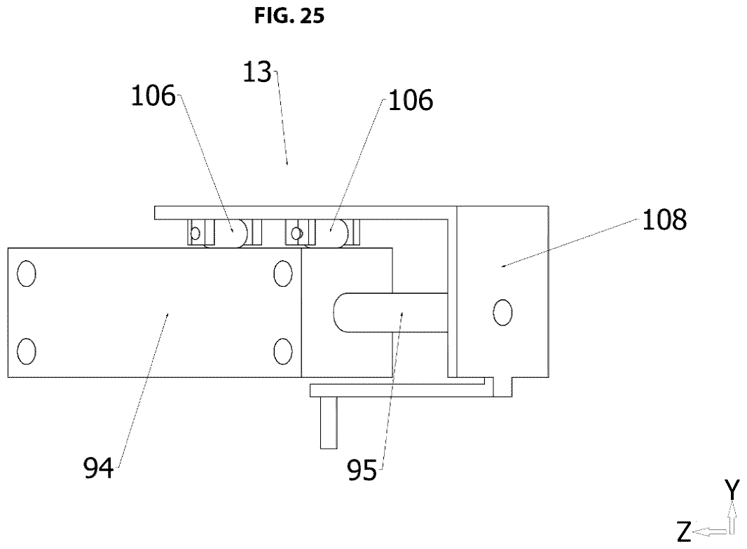

The recirculating plant growing mechanism may have at least one air lock transfer assembly 127 see FIG. 1, FIG. 2, and FIG. 26 comprising of at least one air lock transfer actuator assembly 127 see FIG. 1, FIG. 2, FIG. 23, FIG. 24, FIG. 25, and FIG. 26 and at least one outer air lock door 23 see FIG. 1, FIG. 23, and FIG. 26 is operable under PLC control, in conjunction with at least one exit gate assembly 125, to unlock from the at least one conveyor drive assembly's 128 at least one conveying chain 26 the said at least one conveying tray assembly 2 and the said at least one LED light bar cleaning tray assembly 21 and transfer utilizing the said at least one air lock transfer actuator assembly 127 the said at least one conveying tray assembly 2 and the said at least one LED light bar cleaning tray assembly 21 relative to the X-Axis of the prescribed conveying path the said least one conveying tray assembly 2 and the said least one LED light bar cleaning tray assembly 21 through the at least one fully open said outer air lock door 23 to the entrance of recirculating plant growing mechanism 109 and there transferring the said at least one conveying tray assembly 2 and the said at least one LED light bar cleaning tray assembly 21 to the herein undefined tray transfer mechanism. The herein undefined tray transfer mechanism is operable to receive from the said at least one air lock transfer actuator assembly's 127 tray clamp carriage 20 see FIG. 1, FIG. 2, and FIG. 24 the said least one conveying tray assembly 2 and the said least one LED light bar cleaning tray assembly 21 and to place the said least one conveying tray assembly 2 and the said least one LED light bar cleaning tray assembly 21 onto the herein undefined plant wide tray conveying system, and under PLC control, in conjunction with the said least one exit gate assembly 125, transfer from the herein undefined tray transfer mechanism to the said at least one air lock transfer actuator assemblies' 127 tray clamp carriage 20 at the entrance of recirculating plant growing mechanism 109 the said at least one conveying tray assembly 2 and the said at least one LED light bar cleaning tray assembly 21 and transfer utilizing the said at least one air lock transfer actuator assembly 127 the said at least one conveying tray assembly 2 and the said at least one LED light bar cleaning tray assembly 21 relative to the X-Axis of the prescribed conveying path the said least one conveying tray assembly 2 and the said least one LED light bar cleaning tray assembly 21 through the at least one fully open said outer air lock door 23 to the said least one exit gate assembly 125 where said least one conveying tray assembly 2 and the said least one LED light bar cleaning tray assembly 21 are locked onto the at least one conveyor drive assembly's 128 at least one conveying chain 26

In the embodiment describe herein an airlock transfer assembly 126 is comprised of a top airlock panel 30 see FIG. 1, FIG. 2, FIG. 23, and FIG. 26 that is mounted and bolted on the conveyor frame 1 relative to the X-Axis and Z-Axis of the prescribed conveying path, a bottom airlock panel 31 see FIG. 1, FIG. 2, FIG. 23, and FIG. 26 that is mounted and bolted on the conveyor frame 1 relative to the X-Axis and Z-Axis of the prescribed conveying path, a side airlock panel 33 see FIG. 1, FIG. 2, and FIG. 26 that is mounted and bolted on the outside conveyor frame 1 relative to the X-Axis and Y-Axis on one side of the conveyor frame relative X-Axis of the prescribed conveying path, another side airlock panel 33 see FIG. 1, FIG. 2, and FIG. 26 that is mounted and bolted on the outside of the conveyor frame 1 relative to the X-Axis and Y-Axis on the other side of the conveyor frame relative X-Axis of the prescribed conveying path, the airlock panels 30, 31, 33 are hermetically sealed to each other, the airlock panels 30, 31, 33 form an air lock chamber open at each end relative X-Axis of the prescribed conveying path, an inner top air lock door slider 37 see FIG. 2, FIG. 23, and FIG. 26 is mounted and bolted on one of the inner airlock upright pair mount face see FIG. 26 conveying frame 1 upright, another is mounted and bolted on the other of the inner airlock upright pair mount face see FIG. 26 conveying frame 1 upright, the two inner top air lock door sliders 37 have slots machined into one their Z-Axis' faces the slots run the complete length of their Y-Axis′, the two inner top air lock door sliders' 37 slots face each other across the conveying frame 1, the inner top air lock door 17 see FIG. 1, FIG. 23, and FIG. 26 is constrained in the two inner top air lock door sliders 37 slots, see FIG. 2, FIG. 23, and FIG. 26 relative to the X-Axis and Z-Axis of the prescribed conveying path, the inner top air lock door 17 is free to slide in the two inner top air lock door sliders 37 relative Y-Axis of the prescribed conveying path, one inner top air lock door actuator 16 see FIG. 1, FIG. 2, FIG. 23, and FIG. 26 is mounted and bolted on one of the inner airlock upright pair mount face see FIG. 1, FIG. 2, FIG. 23, and FIG. 26 conveying frame 1 upright, the other inner top air lock door actuator 16 is mounted and bolted on the other inner airlock upright pair mount face conveying frame 1 upright, the two inner top air lock door actuators' 16 slide plates are fixed to the inner top air lock door 17, the inner top air lock door 17 has a “cut outs” machined through the Z-axis face on both sides of the top air lock door's 17 Y-Axis centerline, the “cut outs” are positioned and sized so that when the inner top air lock door 17 is in its fully closed position relative to the Y-Axis of the prescribed conveying path and when the two air lock transfer actuator assemblies' 127 tray clamping actuator assemblies 13 are in their fully retracted positions see below relative to Z-Axis of the prescribed conveying path the two inner top air lock door's 17 two “cut outs” form a hermetic seals between the inner top air lock door 17 and the two air lock transfer actuator assemblies' 127 top and inward facing sides relative to the Y-Axis and Z-Axis of the prescribed conveying path, when the inner top air lock door 17 is in its fully closed position relative to the Y-Axis of the prescribed conveying path the inner top air lock door 17 forms a hermetic seal with the two inner top air lock door sliders 37 relative Y-Axis and Z-Axis of the prescribed conveying path, when the two air lock transfer actuator assemblies' 127 tray clamping actuator assemblies 13 are in their fully retracted positions see below relative to Z-Axis of the prescribed conveying path the two air lock transfer actuator assemblies' 127 top, bottom, and outer face's form a hermetic seal with the “parking recess” that is machined into the inner Z-Axis face of each of the inner air lock upright pair uprights relative to the Y-Axis and Z-Axis of the prescribed conveying path, an inner bottom air lock door slider 38 see FIG. 2, FIG. 23, and FIG. 26 is mounted and bolted on one of the inner airlock upright pair mount faces see FIG. 26 conveying frame 1 uprights, another inner bottom air lock door slider 38 is mounted and bolted on the other of the inner airlock upright pair mount faces see FIG. 26 conveying frame 1 uprights, the two inner bottom air lock door sliders 38 have slots machined into one their Z-Axis' faces the slots run the complete length of their Y-Axis′, the two bottom top air lock door sliders' 38 slots face each other across the conveying frame 1, the inner bottom air lock door 19 see FIG. 1, FIG. 23, and FIG. 26 is constrained in the two inner bottom air lock door sliders 38 slots, see FIG. 2, FIG. 23, and FIG. 26 relative to the X-Axis and Z-Axis of the prescribed conveying path, the inner bottom air lock door 19 is free to slide in the two inner bottom air lock door sliders 38 relative Y-Axis of the prescribed conveying path, one inner top air lock door actuator 16 see FIG. 1, FIG. 2, FIG. 23, and FIG. 26 is mounted and bolted on one of the inner airlock upright pair mount face see FIG. 1, FIG. 2, FIG. 23, and FIG. 26 conveying frame 1 uprights, the other inner top air lock door actuator 16 is mounted and bolted on the other inner airlock upright pair mount face conveying frame 1 uprights, the two inner top air lock door actuators' 16 slide plates are fixed to the inner bottom air lock door 19, the inner bottom air lock door 19 has a “cut outs” machined through the Z-axis face on both sides of the top air lock door's 17 Y-Axis centerline, the “cut outs” are positioned and sized so that when the inner bottom air lock door 19 is in its fully closed position relative to the Y-Axis of the prescribed conveying path and when the two air lock transfer actuator assemblies' 127 tray clamping actuator assemblies 13 are in their fully retracted positions see below relative to Z-Axis of the prescribed conveying path the two inner top air lock door's 17 two “cut outs” form a hermetic seals between the inner bottom air lock door 19 and the two air lock transfer actuator assemblies' 127 top and inward facing sides relative to the Y-Axis and Z-Axis of the prescribed conveying path, when the inner bottom air lock door 19 is in its fully closed position relative to the Y-Axis of the prescribed conveying path the inner bottom air lock door 19 forms a hermetic seal with the two inner top air lock door sliders 37 relative Y-Axis and Z-Axis of the prescribed conveying path, when the two air lock transfer actuator assemblies' 127 tray clamping actuator assemblies 13 are in their fully retracted positions see below relative to Z-Axis of the prescribed conveying path the two air lock transfer actuator assemblies' 127 top, bottom, and outer faces form a hermetic seal with the “parking recess” that is machined into the inner Z-Axis face of each of the inner air lock upright pair uprights relative to the Y-Axis and Z-Axis of the prescribed conveying path, an inner bottom air lock doorslider 38 see FIG. 2, FIG. 23, and FIG. 26 is mounted and bolted on one of the inner airlock upright pair mount face see FIG. 26 conveying frame 1 uprights, another inner bottom air lock door slider 38 is mounted and bolted on the other of the inner airlock upright pair mount face see FIG. 26 conveying frame 1 upright, the two inner bottom air lock door sliders 38 have slots machined into one their Z-Axis' faces the slots run the complete length of their Y-Axis′, the two inner bottom air lock door sliders' 38 slots face each other across the conveying frame 1, the inner bottom air lock door 19 see FIG. 1, FIG. 23, and FIG. 26 is constrained in the two inner bottom air lock door sliders 38 slots, see FIG. 2, FIG. 23, and FIG. 26 relative to the X-Axis and Z-Axis of the prescribed conveying path, the inner bottom air lock door 19 is free to slide in the two inner bottom air lock door sliders 38 relative Y-Axis of the prescribed conveying path, one inner bottom air lock door actuator 18 see FIG. 1, FIG. 2, FIG. 23, and FIG. 26 is mounted and bolted on one of the inner airlock upright pair mount face see FIG. 1, FIG. 2, FIG. 23, and FIG. 26 conveying frame 1 upright, the other inner bottom air lock door actuator 18 is mounted and bolted on the other inner airlock upright pair mount face conveying frame 1 upright, the two inner bottom air lock door actuators' 18 slide plates are fixed to the inner bottom air lock door 19, when the inner bottom air lock door 19 is in its fully closed position relative to the Y-Axis of the prescribed conveying path and when the two air lock transfer actuator assemblies' 127 tray clamping actuator assemblies 13 are in their fully retracted positions see below relative to Z-Axis of the prescribed conveying path the inner bottom air lock door 19 forms a hermetic seal between the inner bottom air lock door 19 and the two air lock transfer actuator assemblies' 127 bottom faces relative to the Y-Axis of the prescribed conveying path, when the inner bottom air lock door 19 is in its fully closed position relative to the Y-Axis of the prescribed conveying path the inner bottom air lock door 19 forms a hermetic seal with the two inner bottom air lock door sliders 38 relative Y-Axis and Z-Axis of the prescribed conveying path, when the inner bottom air lock door 19 is in its fully closed position relative to the Y-Axis of the prescribed conveying path and when the inner bottom air lock door 19 is in its fully closed position relative to the Y-Axis of the prescribed conveying path the inner bottom air lock door 19 and inner bottom air lock door 19 form a hermetic seal between each other relative to the Z-Axis of the prescribed conveying path, when the inner bottom air lock door 19 is in its fully closed position relative to the Y-Axis of the prescribed conveying path and when the inner bottom air lock door 19 is in its fully closed position relative to the Y-Axis of the prescribed conveying path the inner bottom air lock door 19 and inner bottom air lock door 19 form a hermetic seal relative to the X-Axis of the prescribed conveying path with the top airlock panel 30 and the two side air lock panels 33 and the bottom air lock panel 31 sealing the inner opening of the air lock chamber relative X-Axis of the prescribed conveying path, an outside air lock door slider 39 see FIG. 2, FIG. 23, and FIG. 26 is mounted and bolted on one of the outer airlock upright pair mount face see FIG. 26 conveying frame 1 uprights, another outer air lock door slider 39 is mounted and bolted on the other of the outer airlock upright pair mount face see FIG. 26 conveying frame 1 uprights, the two outer air lock door sliders 39 have slots machined into one their Z-Axis' faces the slots run the complete length of their Y-Axis′, the two outer air lock door sliders' 39 slots face each other across the conveying frame 1, the outer air lock door 23 see FIG. 1, FIG. 23, and FIG. 26 is constrained in the two outer air lock door sliders 39 slots, see FIG. 2, FIG. 23, and FIG. 26 relative to the X-Axis and Z-Axis of the prescribed conveying path, the outer air lock door 23 is free to slide in the two outer air lock door sliders 39 relative Y-Axis of the prescribed conveying path, one outer air lock door actuator 22 see FIG. 1, FIG. 2, FIG. 23, and FIG. 26 is mounted and bolted on one of the outer airlock upright pair mount faces see FIG. 1, FIG. 2, FIG. 23, and FIG. 26 conveying frame 1 upright, the Other outer air lock door actuator 22 is mounted and bolted on the other outer airlock upright pair mount face conveying frame 1 upright, the outer air lock door actuators' 22 slide plates are fixed to the outer air lock door 23, when the outer air lock door 23 is in its fully closed position relative to the Y-Axis of the prescribed conveying path and when the two air lock transfer actuator assemblies' 127 tray clamping actuator assemblies 13 are in their fully retracted positions see below relative to Z-Axis of the prescribed conveying path the outer air lock door 23 forms a hermetic seal between the outer air lock door 23 and the two air lock transfer actuator assemblies 127 bottom faces relative to the Y-Axis of the prescribed conveying path, when the outer air lock door 23 is in its fully closed position relative to the Y-Axis of the prescribed conveying path the outer air lock door 23 forms a hermetic seal with the two outer air lock door sliders 39 relative Y-Axis and Z-Axis of the prescribed conveying path, when the outer air lock door 23 is in its fully closed position relative to the Y-Axis of the prescribed conveying path when the outer air lock door 23 is in its fully closed position relative to the Y-Axis of the prescribed conveying path the outer air lock door 23 forms a hermetic seal relative to the X-Axis of the prescribed conveying path with the top airlock panel 30 and the two side air lock panels 33 and the bottom air lock panel 31 sealing the outer opening of the air lock chamber relative X-Axis of the prescribed conveying path, the two air lock transfer actuator assemblies' 127 are mounted between the inner airlock upright pair uprights and the outer airlock upright pair uprights relative to the X-Axis of the prescribed conveying path. The airlock transfer assembly 126 contains six spray bars 29 see FIG. 1, FIG. 2, FIG. 23, and, FIG. 26, three spray bars 29 are mounted longitudinally relative to the Z-Axis of the prescribed conveying path on the top air lock panel 30 inside the air lock chamber, three spray bars 29 are mounted longitudinally relative to the Z-Axis of the prescribed conveying path on the bottom air lock panel 31 inside the air lock chamber, the spray bars 29 are operable to spray liquids and powders onto the plants that are in the air lock chamber, a manifold and valve and pumping mechanism not detailed herein is connected by pipes to the spray bars 29 whereby a variety of liquids and powders can be sprayed onto the plant canopy.

In another embodiment airlock transfer assembly 126 is removed from the recirculating plant growing mechanism 109.

In the embodiment describe herein the two airlock transfer actuator assemblies 127 are comprised of one air lock transfer actuator 14 see FIG. 1, FIG. 2, FIG. 23, FIG. 24, and, FIG. 26, two tray clamping actuator assemblies 13 see FIG. 1, FIG. 2, FIG. 23, FIG. 24, FIG. 25, and, FIG. 26, the air lock transfer actuators 14 have modified carriages 20 see FIG. 1, FIG. 2, FIG. 23, FIG. 24, and, FIG. 26, the air lock transfer actuators 14 carriages have been modified so that they can lock onto the tray clamp pins mounted on the conveying tray assembly 2 and LED light bar cleaning tray assembly 21, the air lock transfer actuators 14 carriages are named tray clamp carriages 20 in this document, each of the two tray clamping actuator assemblies 13 are comprised of a two inch actuator body 94 see FIG. 24, a two inch actuator shaft 95 see FIG. 25, a tray clamping actuator slide plate 108 see FIG. 25 and two two inch actuator slide plate bearings 106 see FIG. 25, each of the two tray clamping actuator assemblies 13 are operable under PLC control to move their two inch actuator shafts 95 and their attached tray clamping actuator slide plates 108 from a fully retracted position wherein the rear face of the tray clamping actuator slide plates 108 relative Z-Axis of the prescribed conveying path are against the front shaft end face of their two inch actuator bodies 94 relative Z-Axis of the prescribed conveying path to a fully extended position wherein the rear face of the tray clamping actuator slide plates 108 relative Z-Axis of the prescribed conveying path are to inches in front of the front shaft end face of their two inch actuator bodies 94, the two two inch actuator slide plate bearings 106 pinned to the tray clamping actuator slide plates 108 and are operable to transfer loads applied to the tray clamping actuator slide plates 108 relative Y-Axis of the prescribed conveying path to the two inch actuator bodies 94, the two clamping actuator slide plates 108 are of each air lock transfer actuator assemblies 127 are bolted to the airlock transfer actuator assemblies 127 one clamping actuator slide plate 108 at each end of the airlock transfer actuator assembly 127 relative X-Axis of the prescribed conveying path. Each airlock transfer actuator assembly 127 is mounted on and bolted by their two inch actuator bodies 94 to air lock transfer actuator assembly mounts 172 and 173 see FIG. 1, FIG. 2, FIG. 23, FIG. 24, and, FIG. 26. One airlock transfer actuator assembly 127 by its assembly mounts 172 and 173 is mounted on bolted one of the inner air lock upright pair conveying frame 129 uprights and one of the outer air lock upright pair uprights conveying frame 1 uprights on one side of the conveying frame relative X-Axis of the prescribed conveying path. The other airlock transfer actuator assembly 127 by its assembly mounts 172 and 173 is mounted on bolted the other inner air lock upright pair conveying frame 1 uprights and the other outer air lock upright pair uprights conveying frame 1 uprights on the other side of the conveying frame relative X-Axis of the prescribed conveying path. The airlock transfer actuator assemblies 127 are assembled so that they mirror each other across the conveying frame 1 and such that their tray clamp carriages 20 face towards each other across the conveying frame relative X-Axis of the prescribed conveying path 1. The two airlock transfer actuator assemblies 127 are operable to move under PLC control from a fully retracted unclamped position to a fully extended clamped position relative Z-Axis of the prescribed conveying path and to move under PLC control from a fully extended clamped position to a fully retracted unclamped position relative Z-Axis of the prescribed conveying path. The two airlock transfer actuator assemblies 127 are operable to move under PLC control their tray clamp carriages 20 from the entrance position in the recirculating plant growing mechanism 109 to the exit gate position in the recirculating plant growing mechanism 109 and to any other point in that linear path and to move under PLC control their tray clamp carriages 20 from the exit gate position in the recirculating plant growing mechanism 109 to the entrance position in the recirculating plant growing mechanism 109 or to any other point in that linear path.

In another embodiment the two airlock transfer actuator assemblies 127 are removed and the at least one conveying tray assembly 2 and the at least one LED light bar cleaning tray assembly 21 are locked onto the at least one conveyor drive assembly's 128 at least one conveying chain 26

The conveyor drive assembly's 128 conveying chains 26 can only be recirculated when the exit gate tray de-coupler unlocking plates 99 are fully retracted. The two exit gate assemblies 125 are operable in conjunction with the airlock transfer assembly 126 and in conjunction with the airlock transfer actuator assembly 127 as follows; Initial positions and states of the two exit gate assemblies 125 the airlock transfer assembly 126 and the airlock transfer actuator assembly 127, all under PLC control are:
Air lock transfer actuator assemblies' 127 tray clamp carriages 20 are empty;
Air lock transfer actuator assemblies' 127 tray clamp carriages 20 are positioned just outside the inner air lock doors 17 and 19 relative to X-Axis of the prescribed conveying path;
Air lock transfer actuator assemblies' 127 tray clamping actuator assemblies 13 are in their fully retracted positions relative to Z-Axis of the prescribed conveying path;
Inner air lock doors 17 and 19 are fully closed;
Outer air lock door 23 is fully closed;
Exit gate tray de-coupler unlocking plates 99 are fully retracted.

If the exit gate tray de-coupler unlocking plates 99 are aligned relative to the X-Axis and Y-Axis of the prescribed conveying path when a conveying tray assembly 2 that is locked onto the conveyor drive assembly's 128 conveying chains 26 and recirculated around the modified 180 degree conveying chain guide rail 24 by the conveyor drive assembly's 128 conveying chains 26 until the X-Axis centerline of the conveying tray assembly 2 is aligned with the Y-Axis centerlines of the two exit gate assemblies 125 and the conveyor drive assembly's 128 conveying chains 26 are then stopped by the PLC, and then the air lock transfer actuator assemblies' 127 tray clamp carriages 20 are moved by the PLC to their exit gate positions, whereby the Tray clamp pin penetrations 171 see FIG. 24 machined into the Z-Axis faces of the air lock transfer actuator assemblies' 127 tray clamp carriages 20 are aligned with the tray clamp pins 68 see FIG. 6, FIG. 7, FIG. 8, and FIG. 9 mounted on the Z-Axis sides of the conveying tray assembly's 2 double skin tray 65 relative to the X-Axis and Y-Axis of the prescribed conveying path, or if the exit gate tray de-coupler unlocking plates 99 are aligned relative to the X-Axis and Y-Axis of the prescribed conveying path when a LED light bar cleaning tray assembly 21 that is locked onto the conveyor drive assembly's 128 conveying chains 26 recirculated around the modified 180 degree conveying chain guide rail 24 by the conveyor drive assembly's 128 conveying chains 26 until the X-Axis centerline of the LED light bar cleaning tray assembly 21 is aligned with the Y-Axis centerlines of the two exit gate assemblies 125 and the conveyor drive assembly's 128 conveying chains 26 are then stopped by the PLC, and then the air lock transfer actuator assemblies' 127 tray clamp carriages 20 are moved by the PLC to their exit gate positions, whereby the tray clamp pin penetrations 171 see FIG. 24 machined into the Z-Axis faces of the air lock transfer actuator assemblies' 127 tray clamp carriages 20 are aligned with the tray clamp pins 68 see FIG. 4, FIG. 5 and FIG. 38 mounted on the Z-Axis sides of the LED light bar cleaning tray assembly's 21 cleaning solution pressure bladder tank 114 relative to the X-Axis and Y-Axis of the prescribed conveying path, then if the tray air lock transfer actuator assemblies' 127 tray clamping actuator assemblies 13 are moved by the PLC to their fully extended positions whereby the Tray clamp pin penetrations 171 see FIG. 24 machined into the Z-Axis faces of the air lock transfer actuator assemblies' 127 tray clamp carriages 20 are “Locked” over the tray clamp pins 68 mounted on the Z-Axis sides of the conveying tray assembly's 2 double skin tray 65 relative to the X-Axis, Z-Axis, and Y-Axis of the prescribed conveying path, or whereby the Tray clamp pin penetrations 171 see FIG. 24 machined into the Z-Axis faces of the air lock transfer actuator assemblies' 127 tray clamp carriages 20 are “Locked” over the tray clamp pins 68 mounted on the Z-Axis sides of the LED light bar cleaning tray assembly's 21 cleaning solution pressure bladder tank 114 relative to the X-Axis Z-Axis, and Y-Axis of the prescribed conveying path, the exit gate tray de-coupler unlocking plates 99 are now fully retracted, the inner air lock doors 17 and 19 are now fully opened by the PLC and then the air lock transfer actuator assemblies' 127 tray clamp carriages 20 are moved by the PLC so that the “Locked” on conveying tray assembly 2 or the “Locked” on LED light bar cleaning tray assembly 21 is moved to a position just inside the inner air lock doors 17 and 19 relative to the X-Axis of the prescribed conveying path, the conveyor drive assembly's 128 conveying chains 26 may now be recirculated, the inner air lock doors 17 and 19 are now fully closed by the PLC, utilizing the spray bars 29 a variety of liquids and powders can be sprayed onto the plant canopy at this time, the outer air lock door 23 is now fully opened by the PLC and then the air lock transfer actuator assemblies' 127 tray clamp carriages 20 are moved by the PLC so that the “Locked” on conveying tray assembly 2 or the “Locked” on LED light bar cleaning tray assembly 21 is moved relative to the X-Axis of the prescribed conveying path to the entrance of recirculating plant growing mechanism 109, the herein undefined tray transfer mechanism then captures the Locked” on conveying tray assembly 2 or the “Locked” on LED light bar cleaning tray assembly 21, the PLC the moves the air lock transfer actuator assemblies' 127 tray clamping actuator assemblies 13 to their fully retracted positions relative to Z-Axis of the prescribed conveying path releasing the Locked” on conveying tray assembly 2 or the “Locked” on LED light bar cleaning tray assembly 2, the herein undefined tray transfer mechanism then places the conveying tray assembly 2 or the LED light bar cleaning tray assembly 21 onto the herein undefined plant wide tray conveying system. When a conveying tray assembly 2 with its tray chain locks 70 latched in their unlocked positions or a LED light bar cleaning tray assembly 21 with its tray chain locks 70 latched in their unlocked positions is presented by the herein undefined tray transfer mechanism at the entrance of the recirculating plant growing mechanism 109 to be locked onto the conveyor drive assembly's 128 conveying chains 26 the PLC initiates the following locking sequence; Initial positions and states of the two exit gate assemblies 125 the airlock transfer assembly 126 and the airlock transfer actuator assembly 127, all under PLC control are:
Air lock transfer actuator assemblies' 127 tray clamp carriages 20 are empty;
Air lock transfer actuator assemblies' 127 tray clamp carriages 20 are positioned at the entrance of recirculating plant growing mechanism 109 relative to X-Axis of the prescribed conveying path;
Air lock transfer actuator assemblies' 127 tray clamping actuator assemblies 13 are in their fully retracted positions relative to Z-Axis of the prescribed conveying path;
Inner air lock doors 17 and 19 are fully closed;
Outer air lock door 23 is fully opened;
Exit gate tray de-coupler unlocking plates 99 are fully retracted.

The PLC selects an empty slot on the conveyor drive assembly's 128 conveying chains 26 and recirculates the conveyor drive assembly's 128 conveying chains 26 until the chain links upon which the conveying tray assembly 2 or the LED light bar cleaning tray assembly 21 is to be locked X-Axis centerlines are aligned with the X-Axis centerlines of the two tray de-coupling assemblies 9 the PLC now stops the conveyor drive assembly's 128 conveying chains 26, the PLC then moves the exit gate tray de-coupler unlocking plates 99 to their fully extended positions opening the exit gate opening so that the conveying tray assembly 2 or the LED light bar cleaning tray assembly 21 can be inserted, the PLC then moves air lock transfer actuator assemblies' 127 tray clamping actuator assemblies 13 to their fully extended positions relative to Z-Axis of the prescribed conveying path locking on to the conveying tray assembly 2 or the LED light bar cleaning tray assembly 21, the herein undefined tray transfer mechanism then releases the conveying tray assembly 2 or the LED light bar cleaning tray assembly 21, the “Locked” on conveying tray assembly 2 or the “Locked” on LED light bar cleaning tray assembly 21 is then moved to a position just inside the inner air lock doors 17 and 19 relative to the X-Axis of the prescribed conveying path, the PLC then fully closes the outer air lock door 23, utilizing the spray bars 29 a variety of liquids and powders can be sprayed onto the plant canopy at this time, the PLC then fully opens the inner air lock doors 17 and 19, the PLC then moves the air lock transfer actuator assemblies' 127 tray clamp carriages 20 to their exit gate positions, the exit gate tray de-coupler unlocking plates 99 are now pushing against the conveying tray assemblies 2 tray chain locks 70 unlatching their latches or a LED light bar cleaning tray assemblies 21 tray chain locks 70 unlatching their latches, the PLC then fully retract exit gate tray de-coupler unlocking plates 99 the conveying tray assembly 2 or the LED light bar cleaning tray assembly 21 is now locked on to the conveyor drive assembly's 128 conveying chains 26, the PLC then moves air lock transfer actuator assemblies' 127 tray clamping actuator assemblies 13 to their fully retracted positions relative to Z-Axis of the prescribed conveying path releasing the conveying tray assembly 2 or the LED light bar cleaning tray assembly 21, the sequence is now complete and the conveyor drive assembly's 128 conveying chains 26 may now be recirculated.

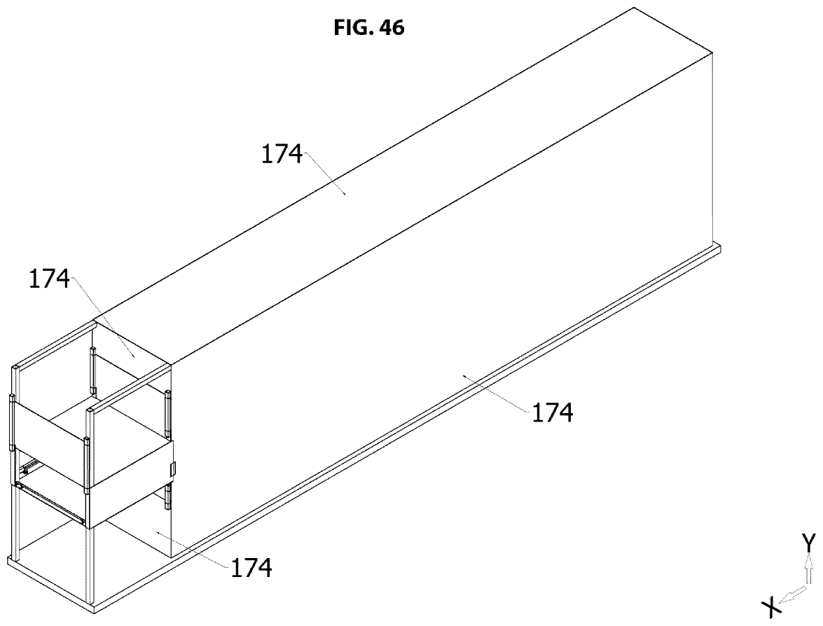

In the embodiment describe herein the outside of conveying frame 1 is clad and sealed in a suitable hermetic cladding 174 material see FIG. 46 that separates the recirculating plant growing mechanism 109 environment from the ambient environment. An opening in the cladding is provided where the air lock chamber is attached and hermetically sealed to the cladding relative to Z-Axis and Y-Axis of the prescribed conveying path.

In another embodiment the cladding is removed from the conveyor frame 1 and no barrier exists between the recirculating plant growing mechanism 109 and the ambient environment exists.

It should be appreciated that in the above description of exemplary embodiments of the invention, various features of the invention are sometimes grouped together in a single embodiment. Figure, or description thereof for the purpose of streamlining the disclosure and aiding in the understanding of one or more of the various inventive aspects. This method of disclosure, however, is not to be interpreted as reflecting an intention that the claimed invention requires more features than are expressly recited in each claim Rather, as the following claims reflect, inventive aspects lie in less than all features of a single foregoing disclosed embodiment, Thus, the claims following the Detailed Description are hereby expressly incorporated into this Detailed Description, with each claim standing on its own as a separate embodiment of this invention.

Furthermore, while some embodiments described herein include some, but not other features included in other embodiments, combinations of features of different embodiments are meant to be within the scope of the invention, and form different embodiments, as would be understood by those skilled in the art. For example, in the following claims, any of the claimed embodiments can be used in any combination.

In the description provided herein numerous specific details are set forth. However, it is understood that embodiments of the invention may be practiced without these specific details. In other instances, well-known methods, structures and techniques have not been shown in detail in order not to obscure an understanding of this description.

Similarly, it is to be noticed that the term “coupled” or “connected”, when used in the description and claims, should not be interpreted as being limited to direct connections only. The terms “coupled” and “connected.” along with their derivatives, may be used. It should be understood, for example, that the terms “coupled” and “directly coupled” are not intended as synonyms for each other. By way of example, the terms “mounted to” or “fixed to” should not be limited to devices wherein a first element is mounted directly to or fixed directly to a second element. Rather, it means that there exists a mounting of fixing between the two that can, but does not have to, include intermediate elements.

Thus, while there has been described what are believed to be the preferred embodiments of the invention, those skilled in the art will recognize that other and further modifications may be made thereto without departing from the spirit of the invention, and it is intended to claim all such changes and modifications as falling within the scope of the invention. Steps may be added or deleted to methods described within the scope of the present invention.

1-15. (canceled)

16. A recirculating plant conveying mechanism comprising:
(a) at least one conveying frame operable to support components of the recirculating plant conveying mechanism;
(b) at least one conveying tray assembly operable to support and constrain a plurality of rooting medias;
(c) at least one conveyor drive assembly operable to support and recirculate said at least one conveying tray assembly around a prescribed conveying path;
(d) at least one a media holder drive assembly operable to vary a linear offset distance between said plurality of said rooting medias constrained in said at least one conveying tray assembly.

17. The recirculating plant conveying mechanism as claimed in claim 16 wherein said at least one media holder drive assembly is operable to adjust the linear offset distance between the said plurality of rooting medias in the said at least one conveying tray assembly.

18. The recirculating plant conveying mechanism as claimed in claim 16 wherein said at least one media holder drive assembly is operable to couple with at least one media holders position adjustment assembly when said at least one conveying tray is aligned with said at least one media holder drive assembly relative to the prescribed conveying path, and wherein said at least one media holder drive assembly is operable to uncouple from said at least one media holders position adjustment assembly when said at least one conveying tray is aligned with said at least one media holder drive assembly relative to said prescribed conveying path.

19. The recirculating plant conveying mechanism as claimed in claim 16 wherein said at least one media holder drive assembly is operable, when coupled with at least one media holders position adjustment assembly to adjust the linear offset distance between the said plurality of rooting medias in the said at least one conveying tray assembly.

20-25. (canceled)

26. A recirculating plant conveying mechanism comprising:
(a) at least one conveying frame clad in a hermetic material operable to isolate said recirculating plant conveying mechanism from ambient outside air and operable to support components of the recirculating plant conveying mechanism;
(b) at least one conveying tray assembly operable to support and constrain rooting media of at least one plant;
(c) at least one conveyor drive assembly operable to support and recirculate said at least one conveying tray assembly around a prescribed conveying path;
(d) at least one exit gate assembly operable to lock and unlock said at least one conveying tray assembly to said at least one conveyor drive assembly, and operable to open and close said at least one conveyor drive assembly;
(e) at least one air lock transfer assembly operable, in conjunction with said at least one conveying frame clad in a hermetic material, to isolate said recirculating plant conveying mechanism from ambient outside air;
(f) at least one tray clamping actuator assembly operable to clamp said at least one conveying tray assembly;
(g) at least one air lock transfer actuator assembly operable to clamp and to transport said at least one conveying tray assembly from an entrance of said recirculating plant conveying mechanism to said at least one exit gate assembly, said at least one an air lock transfer actuator assembly is operable to clamp and to transport said at least one conveying tray assembly from said entrance of the recirculating plant conveying mechanism to said at least one exit gate assembly.

27. The recirculating plant conveying mechanism as claimed in claim 26 wherein said at least one air lock transfer assembly comprises at least one outer air lock door mechanism.

28. The recirculating plant conveying mechanism as claimed in claim 27 wherein said at least one outer air lock door mechanism further comprises a sensor in communication with a Programmable Logic Controller (PLC) to provide signals indicative of a position of said at least one outer air lock door mechanism.

29. The recirculating plant conveying mechanism as claimed in claim 28 wherein said at least one outer air lock door mechanism further comprises a drive mechanism under PLC control allowing for control of the position of said at least one outer air lock door mechanism.

30. The recirculating plant conveying mechanism as claimed in claim 29 wherein said at least one an air lock transfer assembly further comprises at least one inner air lock door mechanism.

31. The recirculating plant conveying mechanism as claimed in claim 30 wherein said at least one inner air lock door mechanism further comprises a sensor in communication with the PLC to provide signals indicative of a position of said at least one inner air lock door mechanism.

32. The recirculating plant conveying mechanism as claimed in claim 31 wherein said at least one inner air lock door mechanism further comprises an actuator mechanism under PLC control allowing for control of the position of said at least one inner air lock door mechanism.

33. A recirculating plant conveying mechanism comprising:
(a) at least one conveying frame operable to support components of the recirculating plant conveying mechanism;
(b) at least one conveying tray assembly operable to support and constrain rooting media of at least one plant;
(c) at least one conveyor drive assembly operable to support and recirculate said at least one conveying tray assembly around a prescribed conveying path;
(d) at least one watering station assembly operable to fertigate and/or water said rooting media of said at least one plant constrained in said at least one conveying tray recirculating around said prescribed conveying path and when said at least one conveying tray is aligned with said at least one a watering station assembly relative to said prescribed conveying path;
(e) at least one fertigation injection probe movable, when said at least one conveying tray assembly recirculating around said prescribed conveying path is aligned with said at least one watering station assembly between a first position, wherein said at least one fertigation injection probe is remote from said at least one conveying tray, and a second position, wherein said at least one fertigation injection probe is within said rooting media of said at least one plant constrained in said at least one conveying tray.

34. (canceled)

35. The recirculating plant conveying mechanism as claimed in claim 33 wherein said at least one fertigation injection probe is operable to inject liquids and/or fluidized powders into said rooting media of said at least one plant constrained in said at least one conveying tray recirculating around said prescribed conveying path and when said at least one conveying tray is aligned with said at least one watering station assembly.

36. The recirculating plant conveying mechanism as claimed in claim 35 further comprising a plurality of probe slider assemblies, where a plurality of fertigation injection probes are mounted on each probe slider assembly among the plurality of probe slider assemblies.

37. The recirculating plant conveying mechanism as claimed in claim 36 wherein said probe slider assembly is operable to adjust a linear offset distance between said plurality of fertigation injection probes so that said plurality of probe slider assemblies are aligned with associated rooting medias.

38. The recirculating plant conveying mechanism as claimed in claim 37 wherein said at one least probe slider assembly further comprises a sensor in communication with a Programmable Logic Controller (PLC) to provide signals indicative of positions of said plurality of fertigation injection probes.

39. The recirculating plant conveying mechanism as claimed in claim 38 wherein said at least one probe slider assembly further comprises an actuating mechanism under PLC control allowing for control of the positions of said plurality of fertigation injection probes.

40. The recirculating plant conveying mechanism as claimed in claim 37 wherein each of said plurality of fertigation injection probes is movable when said at least one conveying tray assembly recirculating around said prescribed conveying path is aligned with said at least one a watering station assembly between a first position, wherein said plurality of fertigation injection probes are remote from said at least one conveying tray, and a second position, wherein each of said plurality of fertigation injection probes are within associated rooting media.

41. The recirculating plant conveying mechanism as claimed in claim 38 wherein said watering station assembly further comprises a sensor in communication with the PLC to provide signals indicative of a position of said watering station assembly.

42. The recirculating plant conveying mechanism as claimed in claim 38 wherein said watering station assembly further comprises an actuating mechanism under PLC control allowing for control of a position of said watering station assembly.

43-69. (canceled)
